(19) United States
(12) Patent Application Publication
(10) Pub. No.: US 2025/0263324 A1
(43) Pub. Date: Aug. 21, 2025

(54) REINFORCED GLASS PLATE, METHOD FOR MANUFACTURING REINFORCED GLASS PLATE, AND GLASS PLATE TO BE REINFORCED

(71) Applicant: NIPPON ELECTRIC GLASS CO., LTD., Shiga (JP)

(72) Inventors: Ken YUKI, Shiga (JP); Kiyotaka KINOSHITA, Shiga (JP); Kazumi MAEDA, Shiga (JP); Kosei OSADA, Shiga (JP); Yusuke SHIMIZU, Shiga (JP)

(21) Appl. No.: 18/859,300

(22) PCT Filed: Apr. 20, 2023
(86) PCT No.: PCT/JP2023/015813

§ 371 Date: Oct. 23, 2024

(30) Foreign Application Priority Data
Apr. 27, 2022 (JP) 2022-073331
Jun. 10, 2022 (JP) 2022-094458
Jul. 11, 2022 (JP) 2022-111091
Aug. 24, 2022 (JP) 2022-133306
Nov. 28, 2022 (JP) 2022-188945

(51) Int. Cl. C03C 3/091; C03C 21/00

(52) U.S. Cl. CPC C03C 3/091; C03C 21/002; C03C 2201/54

(57) ABSTRACT

The present invention provides a tempered glass sheet including as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of SrO, 0% to 10% of BaO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

### TECHNICAL FIELD

The present invention relates to a tempered glass sheet and a method of manufacturing the same, and more particularly, to a tempered glass sheet suitable as a cover glass for a touch panel display of a cellular phone, a digital camera, a personal digital assistant (PDA), or the like, a method of manufacturing a tempered glass sheet, and a glass sheet to be tempered.

### BACKGROUND ART

In applications, such as a cellular phone (in particular, a smartphone), a digital camera, and a personal digital assistant (PDA), a tempered glass sheet obtained through ion exchange treatment is used as a cover glass for a touch panel display (see Patent Literature 1).

Incidentally, when a smartphone is dropped onto a road surface or the like by mistake, the smartphone becomes unusable in some cases owing to breakage of a cover glass. Accordingly, in order to avoid such situation, it is important to increase the strength of the tempered glass sheet.

An effective method of increasing the strength of the tempered glass sheet is to increase a depth of compression. Specifically, when the cover glass collides with the road surface at the time of dropping of the smartphone, protrusions or sand grains on the road surface penetrate into the cover glass to reach a tensile stress layer, which leads to the breakage of the cover glass. In view of the foregoing, when the depth of compression of a compressive stress layer is increased, the protrusions or the sand grains on the road surface are less liable to reach the tensile stress layer, and thus the breakage probability of the cover glass can be reduced (see Patent Literature 2).

### CITATION LIST

Patent Literature 1: JP 2006-83045 A
Patent Literature 2: JP 2017-527513 A

### SUMMARY OF INVENTION

### Technical Problem

According to investigations made by the inventors of the present invention, it is conceived that an increase in compressive stress value at a depth corresponding to the size of an intrusion such as sand grains responsible for the breakage (e.g., at a depth of 30 μm from the outermost surface) is effective in further increasing the strength of the tempered glass sheet. With the above-mentioned configuration, fracture of the tempered glass sheet from an inside thereof caused by the intrusion is easily suppressed. However, with the related-art glass (glass composition), even when ion exchange conditions are changed in order to increase the compressive stress value at the predetermined depth, it has been difficult to increase the compressive stress value at the predetermined depth. In addition, when the compressive stress value at the predetermined depth is increased, it has been difficult to concurrently achieve a high surface compressive stress or a large depth of compression.

The present invention has been made in view of the above-mentioned circumstances, and a technical object of the present invention is to provide a tempered glass sheet, which is less liable to be broken than related-art alkali aluminosilicate glass, and a method of manufacturing the same.

### Solution to Problem

(Invention 1) According to one embodiment of the present invention, there is provided a tempered glass sheet having a compressive stress layer in a surface thereof, the tempered glass sheet comprising as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of SrO, 0% to 10% of BaO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0. Herein, the “[B₂O₃]” refers to the content of B₂O₃ in terms of mol %. The “[MgO]” refers to the content of MgO in terms of mol %. The “[CaO]” refers to the content of CaO in terms of mol %. The “[Li₂O]” refers to the content of Li₂O in terms of mol %. The “[Na₂O]” refers to the content of Na₂O in terms of mol %. The “[K₂O]” refers to the content of K₂O in terms of mol %. The “[Al₂O₃]” refers to the content of Al₂O₃ in terms of mol %. The “[B₂O₃]+[MgO]+[CaO]” refers to the total content of B₂O₃, MgO, and CaO. The “([Li₂O]+[Na₂O]+[K₂O])/[Al₂O₃]” refers to a value obtained by dividing the total content of Li₂O, Na₂O, and K₂O by the content of Al₂O₃.

(Invention 1-2) In addition, it is preferred that the tempered glass sheet according to the one embodiment of the present invention have a Z value calculated by the following equation of 18.0 or more.

$$Z = 0.13 \times [ Si {O}_{2} ] + 2.36 \times [ {Al}_{2} {O}_{3} ] - 0.14 \times [ {B}_{2} {O}_{3} ] + 4.90 \times [ L {i}_{2} O ] - 5.53 \times [ {Na}_{2} O ] - 2 \text{.14} \times [ MgO ] - 2 \text{.34} \times [ CaO ]$$

Herein, the “[SiO₂]” refers to the content of SiO₂ in terms of mol %.

With the above-mentioned configuration, the efficiency of ion exchange between a Li ion in glass and a Na ion in a molten salt, and the efficiency of ion exchange between a Na ion in the glass and a K ion in the molten salt can be balanced.

(Invention 1-3) In addition, it is preferred that the tempered glass sheet according to the one embodiment of the present invention have a Z value calculated by the following equation of 20.0 or more.

$$Z = 0.13 \times [ Si {O}_{2} ] + 2.36 \times [ {Al}_{2} {O}_{3} ] - 0.14 \times [ {B}_{2} {O}_{3} ] + 4.90 \times [ L {i}_{2} O ] - 5.53 \times [ {Na}_{2} O ] - 2 \text{.14} \times [ MgO ] - 2 \text{.34} \times [ CaO ]$$

(Invention 1-4) In addition, it is preferred that the tempered glass sheet according to the one embodiment of the present invention have a molar ratio [Na₂O]/[Li₂O] of 1.0 or less.

With the above-mentioned configuration, the efficiency of ion exchange between a Li ion in the glass and a Na ion in the molten salt can be improved.

(Invention 1-5) In addition, it is preferred that the tempered glass sheet according to the one embodiment of the present invention have a Y value calculated by the following equation of 5.0 or more.

$$Y = 3 + 0.21 \times [ {SiO}_{2} ] + 0.25 \times [ {Al}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ MgO ] - 1.46 \times [ CaO ]$$

Herein, the “[SiO₂]” refers to the content of SiO₂ in terms of mol %.

With the above-mentioned configuration, the efficiency of ion exchange between a Na ion in the glass and a K ion in the molten salt can be improved.

(Invention 1-6) In addition, it is preferred that the tempered glass sheet according to the one embodiment of the present invention have a Y value calculated by the following equation of from 6.0 to 30.

$$Y = 3 + 0.21 \times [ {SiO}_{2} ] + 0.25 \times [ {Al}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ MgO ] - 1.46 \times [ CaO ]$$

With the above-mentioned configuration, the efficiency of ion exchange between a Na ion in the glass and a K ion in the molten salt can be further improved.

(Invention 1-7) In addition, it is preferred that the tempered glass sheet according to the one embodiment of the present invention have an X value calculated by the following equation of 300 or more.

$$X = - 1.49 \times [ {SiO}_{2} ] + 2 6.98 \times [ {Al}_{2} {O}_{3} ] - 3.23 \times [ {B}_{2} {O}_{3} ] + 48.56 \times [ L {i}_{2} O ] - 24.31 \times [ N {a}_{2} O ] - 0.28 \times [ MgO ] + 2.74 \times [ CaO ]$$

With the above-mentioned configuration, the efficiency of ion exchange between a Li ion in the glass and a Na ion in the molten salt can be improved.

(Invention 1-8) In addition, it is preferred that the tempered glass sheet according to the one embodiment of the present invention have a W value calculated by the following equation of 340 or more.

$$W = 0. 07 \times [ {SiO}_{2} ] + 18.17 \times [ {Al}_{2} {O}_{3} ] - 4.42 \times [ {B}_{2} {O}_{3} ] + 41.43 \times [ L {i}_{2} O ] - 29.3 \times [ N {a}_{2} O ] + 1.43 \times [ MgO ] - 10.43 \times [ CaO ]$$

With the above-mentioned configuration, the Young's modulus of the tempered glass sheet can be increased.

(Invention 1-9) In addition, it is preferred that the tempered glass sheet according to the one embodiment of the present invention have a value of [Al₂O₃]+[Li₂O]+[Na₂O]+[K₂O] of 10.5% or more.

With the above-mentioned configuration, the ion exchange performance of the tempered glass sheet can be improved.

(Invention 1-10) In addition, it is preferred that the tempered glass sheet according to the one embodiment of the present invention have a molar ratio [Li₂O]/[Al₂O₃] of 0.1 or more.

With the above-mentioned configuration, the ion exchange performance of the tempered glass sheet can be further improved.

(Invention 1-11) In addition, it is preferred that the tempered glass sheet according to the one embodiment of the present invention have a U value calculated by the following equation of 700 or more.

$$U = 87.39 \times [ {SiO}_{2} ] + 180.12 \times [ {Al}_{2} {O}_{3} ] + 93.63 \times [ {B}_{2} {O}_{3} ] + 1 13.78 \times ( [ MgO ] + [ CaO ] + [ BaO ] + [ SrO ] ) - 46.2 \times [ L {i}_{2} O ] - 71.1 \times [ {Na}_{2} O ] - 58.6 \times [ {K}_{2} O ] - 40.0 \times [ {P}_{2} {O}_{5} ]$$

With the above-mentioned configuration, the fracture toughness Kc of the tempered glass sheet can be increased.

(Invention 1-12) In addition, it is preferred that the tempered glass sheet according to the one embodiment of the present invention have a Q value calculated by the following equation of −30% or more.

$$Q = [ {SiO}_{2} ] + 1.2 \times [ {P}_{2} {O}_{5} ] - 3 \times [ {Al}_{2} {O}_{3} ] - [ {B}_{2} {O}_{3} ] - 2 \times [ L {i}_{2} O ] - 1.5 \times [ {Na}_{2} O ] - [ {K}_{2} O ]$$

With the above-mentioned configuration, the acid resistance of the tempered glass sheet can be increased.

(Invention 1-13) In addition, it is preferred that the tempered glass sheet according to the one embodiment of the present invention comprise Cl as the glass composition and have a content of Cl of 0.02 mol % or more.

With the above-mentioned configuration, a bubble diameter in molten glass is easily expanded, and a high fining effect is obtained.

(Invention 1-14) In addition, it is preferred that the tempered glass sheet according to the one embodiment of the present invention comprise MoO₃ as the glass composition and have a content of MoO₃ of 0.0001 mol % or more.

With the above-mentioned configuration, the tempered glass sheet easily absorbs UV light, and deterioration of an element in a device caused by UV light can be suppressed.

(Invention 1-15) In addition, it is preferred that the tempered glass sheet according to the one embodiment of the present invention have a softening point (Ts) of 920° C. or less. Herein, the “softening point” refers to a value measured based on a method of ASTM C338.

With the above-mentioned configuration, the manufacturing cost of the tempered glass sheet at the time of bending processing is easily reduced.

(Invention 1-16) In addition, it is preferred that the tempered glass sheet according to the one embodiment of the present invention have a compressive stress value CS of the compressive stress layer on an outermost surface of from 200 MPa to 1,200 MPa, and a depth of compression DOC of the compressive stress layer of from 3 μm to 200 μm. Herein, the terms “compressive stress value on an outermost surface” and “depth of compression” each refer to, for example, a value measured with FSM-6000 (manufactured by Orihara Industrial Co., Ltd.) in the case where the compressive stress is attributed to a potassium ion introduced through ion exchange, or a value measured from a retardation distribution curve observed with a scattered light photoelastic stress meter SLP-2000 (manufactured by Orihara Industrial Co., Ltd.) in the case where the compressive stress is attributed to a Na ion introduced through ion exchange. Moreover, the term “depth of compression” refers to a depth at which the stress value becomes zero. In calculation of the stress characteristics of each sample, a refractive index and a photoelastic constant were used. A value measured by a V-block method was used as the refractive index. A value measured by optical heterodyne interferometry was used as the photoelastic constant.

With the above-mentioned configuration, a tempered glass sheet having high strength is obtained.

(Invention 1-17) In addition, it is preferred that the tempered glass sheet according to the one embodiment of the present invention have a depth of compression DOC of the compressive stress layer of from 50 μm to 200 μm, and a compressive stress value CS30 of the compressive stress layer at a depth of 30 μm from an outermost surface of from 35 MPa to 400 MPa.

With the above-mentioned configuration, a tempered glass sheet that is less liable to be broken at the time of dropping is obtained.

(Invention 1-18) In addition, in the tempered glass sheet according to the one embodiment of the present invention, it is preferred that a compressive stress value CS30 of the compressive stress layer at a depth of 30 μm from the surface be 120 MPa or more, and a compressive stress value CS of the compressive stress layer on the outermost surface be 400 MPa or more.

With the above-mentioned configuration, a higher internal stress is obtained, and the drop strength of a cover glass for a smartphone can be increased.

(Invention 1-19) In addition, it is preferred that the tempered glass sheet according to the one embodiment of the present invention have a temperature at a viscosity at high temperature of 10^{2.5} dPa·s of 1,680° C. or less. Herein, the “temperature at a viscosity at high temperature of 10^{2.5} dPa·s” may be measured, for example, by a platinum sphere pull up method.

With the above-mentioned configuration, the molten glass is easily formed into a sheet shape.

(Invention 1-20) In addition, it is preferred that the tempered glass sheet according to the one embodiment of the present invention have an overflow-merged surface in a middle portion thereof in a thickness direction. Herein, the “overflow down-draw method” is a method involving causing molten glass to overflow from both sides of forming body refractory, and subjecting the overflowing molten glasses to down-draw downward while the molten glasses are merged at the lower end of the forming body refractory, to thereby manufacture a glass sheet.

With the above-mentioned configuration, a tempered surface glass sheet having satisfactory quality can be inexpensively manufactured without polishing.

(Invention 1-21) In addition, it is preferred that a stress profile of the tempered glass sheet according to the one embodiment of the present invention in a thickness direction have an inflection point.

With the above-mentioned configuration, a tempered glass sheet having a high compressive stress on the surface and having a large depth of compression is obtained.

(Invention 1-22) In addition, it is preferred that the tempered glass sheet according to the one embodiment of the present invention have a Na ion (substantially, Na ion-Li ion) mutual diffusion coefficient D_{Na} at 380° C. in a deep region of from 1×10⁻¹⁴ m² sec⁻¹ to 1×10⁻¹¹ m² sec⁻¹ and have a K ion (substantially, K ion-Na ion) mutual diffusion coefficient D_{K} at the same temperature in a shallow region of from 1×10⁻¹⁷ m² sec⁻¹ to 1×10⁻¹⁴ m² sec⁻¹, and besides, have a ratio D_{K}/D_{Na} therebetween of 0.0001 or more.

(Invention 1-23) In addition, it is preferred that the tempered glass sheet according to the one embodiment of the present invention have a Na ion mutual diffusion coefficient D_{Na} of from 1×10⁻¹⁴ m² sec⁻¹ to 1×10⁻¹¹ m² sec⁻¹ when subjected to ion exchange with NaNO₃ at 380° C. and have a K ion mutual diffusion coefficient D_{K} of from 1×10⁻¹⁷ m² sec⁻¹ to 1×10⁻¹⁴ m² sec⁻¹ when subjected to ion exchange with KNO₃ at 380° C., and besides, have a ratio D_{K}/D_{Na} therebetween of 0.0001 or more.

(Invention 2) According to one embodiment of the present invention, there is provided a tempered glass sheet, comprising as a glass composition, in terms of mol %, 50% to 80% of SiO₂, 7% to 25% of Al₂O₃, 1% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 4% of P₂O₅, 0.001% to 0.1% of TiO₂, 0% to 10% of ZrO₂, 0.001% to 0.1% of Fe₂O₃, and 0.001% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

(Invention 3) In addition, according to one embodiment of the present invention, there is provided a method of manufacturing a tempered glass sheet, comprising: a preparation step of preparing a glass sheet to be tempered including as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0; and an ion exchange step of subjecting the glass sheet to be tempered to ion exchange treatment a plurality of times to provide a tempered glass sheet having a compressive stress layer in a surface thereof.

(Invention 4) In addition, according to one embodiment of the present invention, there is provided a glass sheet to be tempered, comprising as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

(Invention 4-1) In addition, it is preferred that the glass sheet to be tempered according to the one embodiment of the present invention have a Na ion mutual diffusion coefficient D_{Na} Of from 1×10⁻¹⁴ m² sec⁻¹ to 1×10⁻¹¹ m² sec⁻¹ when subjected to ion exchange with NaNO₃ at 380° C. and have a K ion mutual diffusion coefficient D_{K} of from 1×10⁻¹⁷ m² sec⁻¹ to 1×10⁻¹⁴ m² sec⁻¹ when subjected to ion exchange with KNO₃ at 380° C., and besides, have a ratio D_{K}/D_{Na} therebetween of 0.001 or more.

With the above-mentioned configuration, when a compressive stress value at a predetermined depth (e.g., at a depth of 30 μm from the outermost surface) is increased, a high surface compressive stress or a large depth of compression can be concurrently achieved.

(Invention 4-2) In addition, it is preferred that the glass sheet to be tempered according to the one embodiment of the present invention have a Z value calculated by the following equation of 18.0 or more.

$$Z = 0.13 \times [ {SiO}_{2} ] + 2.36 \times [ {Al}_{2} {O}_{3} ] - 0.14 \times [ {B}_{2} {O}_{3} ] + 4.90 \times [ L {i}_{2} O ] - 5.53 \times [ {Na}_{2} O ] - 2.14 \times [ MgO ] - 2.34 \times [ CaO ]$$

(Invention 4-3) In addition, it is preferred that the glass sheet to be tempered according to the one embodiment of the present invention have a Z value calculated by the following equation of 20.0 or more.

$$Z = 0. 13 \times [ {SiO}_{2} ] + 2.36 \times [ {Al}_{2} {O}_{3} ] - 0.14 \times [ {B}_{2} {O}_{3} ] + 4.90 \times [ L {i}_{2} O ] - 5.53 \times [ {Na}_{2} O ] - 2.14 \times [ MgO ] - 2.34 \times [ CaO ]$$

(Invention 4-4) In addition, it is preferred that the glass sheet to be tempered according to the one embodiment of the present invention have a molar ratio [Na₂O]/[Li₂O] of 1.0 or less.

(Invention 4-5) In addition, it is preferred that the glass sheet to be tempered according to the one embodiment of the present invention have a Y value calculated by the following equation of 5.0 or more.

$$Y = 3 + 0.21 \times [ {SiO}_{2} ] + 0.25 \times [ {Al}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ MgO ] - 1.46 \times [ CaO ]$$

(Invention 4-6) In addition, it is preferred that the glass sheet to be tempered according to the one embodiment of the present invention have a Y value calculated by the following equation of from 6.0 to 30.

$$Y = 3 + 0.21 \times [ {SiO}_{2} ] + 0.25 \times [ {Al}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ MgO ] - 1.46 \times [ CaO ]$$

(Invention 4-7) In addition, it is preferred that the glass sheet to be tempered according to the one embodiment of the present invention have an X value calculated by the following equation of 300 or more.

$$X = - 1.49 \times [ {SiO}_{2} ] + 2 6.98 \times [ {Al}_{2} {O}_{3} ] - 3.23 \times [ {B}_{2} {O}_{3} ] + 48.56 \times [ L {i}_{2} O ] - 24.31 \times [ N {a}_{2} O ] - 0.28 \times [ MgO ] + 2.74 \times [ CaO ]$$

(Invention 4-8) In addition, it is preferred that the glass sheet to be tempered according to the one embodiment of the present invention have a W value calculated by the following equation of 340 or more.

$$W = 0. 7 \times [ {SiO}_{2} ] + 18.17 \times [ {Al}_{2} {O}_{3} ] - 4.42 \times [ {B}_{2} {O}_{3} ] + 41.43 \times [ L {i}_{2} O ] - 29.3 \times [ N {a}_{2} O ] + 1.43 \times [ MgO ] - 10.43 \times [ CaO ]$$

(Invention 4-9) In addition, it is preferred that the glass sheet to be tempered according to the one embodiment of the present invention have a value of [Al₂O₃]+[Li₂O]+[Na₂O]+[K₂O] of 10.5% or more.

(Invention 4-10) In addition, it is preferred that the glass sheet to be tempered according to the one embodiment of the present invention have a molar ratio [Li₂O]/[Al₂O₃] of 0.1 or more.

(Invention 4-11) In addition, it is preferred that the glass sheet to be tempered according to the one embodiment of the present invention have a U value calculated by the following equation of 7,000 or more.

$$U = 87.39 \times [ {SiO}_{2} ] + 180.12 \times [ {Al}_{2} {O}_{3} ] + 93.63 \times [ {B}_{2} {O}_{3} ] + 1 13.78 \times ( [ MgO ] + [ CaO ] + [ BaO ] + [ SrO ] ) - 46.2 \times [ L {i}_{2} O ] - 71.1 \times [ {Na}_{2} O ] - 58.6 \times [ {K}_{2} O ] - 40.0 \times [ {P}_{2} {O}_{5} ]$$

(Invention 4-12) In addition, it is preferred that the glass sheet to be tempered according to the one embodiment of the present invention have a Q value calculated by the following equation of −30% or more.

$$Q = [ {SiO}_{2} ] + 1.2 \times [ {P}_{2} {O}_{5} ] - 3 \times [ {Al}_{2} {O}_{3} ] - [ {B}_{2} {O}_{3} ] - 2 \times [ L {i}_{2} O ] - 1.5 \times [ {Na}_{2} O ] - [ {K}_{2} O ]$$

(Invention 4-13) In addition, it is preferred that the glass sheet to be tempered according to the one embodiment of the present invention comprise Cl as the glass composition and have a content of Cl of 0.02 mol % or more.

(Invention 4-14) In addition, it is preferred that the glass sheet to be tempered according to the one embodiment of the present invention comprise MoO₃ as the glass composition and have a content of MoO₃ of 0.0001 mol % or more.

(Invention 4-15) In addition, it is preferred that the glass sheet to be tempered according to the one embodiment of the present invention have a softening point (Ts) of 920° C. or less. Herein, the “softening point” refers to a value measured based on a method of ASTM C338.

(Invention 5) In addition, according to one embodiment of the present invention, there is provided a method of manufacturing a tempered glass sheet, comprising a preparation step of preparing a glass sheet to be tempered having a Na ion mutual diffusion coefficient D_{Na} Of from 1×10⁻¹⁴ m² sec⁻¹ to 1×10⁻¹¹ m² sec⁻¹ when subjected to ion exchange with NaNO₃ at 380° C. and having a K ion mutual diffusion coefficient D_{K} of from 1×10⁻¹⁷ m² sec⁻¹ to 1×10⁻¹⁴ m² sec⁻¹ when subjected to ion exchange with KNO₃ at 380° C., and besides, having a ratio D_{K}/D_{Na} therebetween of 0.001 or more; an ion exchange step of subjecting the glass sheet to be tempered to ion exchange treatment a plurality of times to provide a tempered glass sheet having a compressive stress layer in a surface thereof.

### Advantageous Effects of Invention

According to the present invention, the tempered glass sheet, which is less liable to be broken at the time of dropping than related-art alkali aluminosilicate glass, and the method of manufacturing the same can be provided.

### BRIEF DESCRIPTION OF DRAWINGS

FIG. 1 is an explanatory view for illustrating an example of a stress profile having a first peak “a”, a first bottom “b”, a second peak “c”, and a second bottom “d”.

FIG. 2 is an explanatory view for illustrating a low compressive stress region in the stress profile of FIG. 1 in an enlarged manner.

FIG. 3 is an explanatory view for illustrating an example of a stress profile having an inflection point “e”.

FIG. 4 is a graph showing stress profiles of Examples 2-1 to 2-3.

FIG. 5 is a graph showing low compressive stress regions in the stress profiles of Examples 2-1 to 2-3 of FIG. 4 in an enlarged manner.

FIG. 6 is a graph showing stress profiles of Examples 3-1 and 3-2.

FIG. 7 is a graph showing low compressive stress regions in the stress profiles of Examples 3-1 and 3-2 of FIG. 6 in an enlarged manner.

FIG. 8 is a graph showing stress profiles of Examples 4-1 to 4-4.

FIG. 9 is a graph showing low compressive stress regions in the stress profiles of Examples 4-1 to 4-4 of FIG. 8 in an enlarged manner.

FIG. 10 is an explanatory view for illustrating an example of a Na ion concentration profile measured with an EPMA.

### DESCRIPTION OF EMBODIMENTS

In the present invention, the term “tempered glass sheet” refers to a glass sheet having been subjected to ion exchange treatment and having a compressive stress layer in a surface thereof. The term “glass sheet to be tempered” refers to a glass sheet not having been subjected to the ion exchange treatment (before the ion exchange treatment).

A tempered glass sheet (glass sheet to be tempered) of the present invention comprises as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, has a value of [B₂O₃]+[MgO]+[CaO] of from 0.1% to 30%, and has a value of ([Li₂O]+[Na₂O]+[K₂O])/[Al₂O₃] of from 0.5 to 2.0. Reasons why the content ranges of the components are restricted are described below. In the description of the content range of each component, the expression “%” means “mol %” unless otherwise specified.

SiO₂ is a component that forms a glass network. When the content of SiO₂ is too small, vitrification does not occur easily, and a thermal expansion coefficient becomes too high, with the result that thermal shock resistance is liable to be reduced. Accordingly, a suitable lower limit range of the content of SiO₂ is 50% or more, 52% or more, 55% or more, 57% or more, 58% or more, 58.5% or more, 59% or more, 60% or more, 61% or more, 62% or more, 62.5% or more, or 63% or more, particularly 63.5% or more. Meanwhile, when the content of SiO₂ is too large, meltability and formability are liable to be reduced, and the thermal expansion coefficient is excessively reduced, with the result that it becomes difficult to match the thermal expansion coefficient with those of peripheral materials. Accordingly, a suitable upper limit range of the content of SiO₂ is 80% or less, 75% or less, 73% or less, 72% or less, 71% or less, 70.5% or less, 70% or less, 69.5% or less, 69% or less, 68.5% or less, 68% or less, 67.8% or less, 67.5% or less, or 67.2% or less, particularly 67% or less.

Al₂O₃ is a component improves ion exchange performance, and is also a component that increases a strain point, a Young's modulus, fracture toughness, and a Vickers hardness. Accordingly, a suitable lower limit range of the content of Al₂O₃ is 7% or more, 7.2% or more, 7.5% or more, 7.8% or more, 8% or more, 8.2% or more, 8.5% or more, 9% or more, 9.2% or more, 9.4% or more, 9.5% or more, 9.8% or more, 10.0% or more, 10.3% or more, 10.5% or more, 10.8% or more, 11% or more, 11.2% or more, 11.4% or more, or 11.6% or more, particularly 11.8% or more. Meanwhile, when the content of Al₂O₃ is too large, a viscosity at high temperature is increased, with the result that the meltability and the formability are liable to be reduced. In addition, a devitrified crystal is liable to be precipitated in glass, and it becomes difficult to form the glass into a sheet shape by an overflow down-draw method or the like. Particularly when the glass is formed into a sheet shape by an overflow down-draw method involving using alumina-based refractory as forming body refractory, a devitrified crystal of spinel is liable to be precipitated at an interface with the alumina-based refractory. Further, acid resistance is reduced, with the result that it becomes difficult to subject the glass to an acid treatment step. Accordingly, a suitable upper limit range of the content of Al₂O₃ is 25% or less, 23% or less, 21% or less, 20.5% or less, 20% or less, 19.8% or less, 19.5% or less, 19.0% or less, 18.5% or less, 18% or less, 17.5% or less, 17% or less, 16.5% or less, 15.5% or less, 15.2% or less, 15% or less, 14.9% or less, 14.7% or less, 14.5% or less, 14.3% or less, 14% or less, or 13.5% or less, particularly 13% or less. When the content of Al₂O₃, which has a large influence on the ion exchange performance, is set to fall within the suitable ranges, it becomes easy to form a profile having a first peak “a”, a first bottom “b”, a second peak “c”, and a second bottom “d”.

B₂O₃ is a component that reduces the viscosity at high temperature and a density, and stabilizes the glass to cause less precipitation of a crystal, to thereby reduce a liquidus temperature. In addition, B₂O₃ is a component that increases fracture toughness K1c and fracture energy γ. Further, B₂O₃ is a component that increases oxygen electron constraint force exhibited by a cation to reduce the basicity of the glass. When the content of B₂O₃ is too small, a depth of compression (DOC_{Na}) obtained through ion exchange between a Li ion in the glass and a Na ion in a molten salt is excessively increased, with the result that a compressive stress value at a predetermined depth (from 5 μm to 50 μm) from the outermost surface is liable to be reduced. In addition, the glass may become unstable, and devitrification resistance may be reduced. In addition, the basicity of the glass is excessively increased, and the release amount of O₂ through a reaction of a fining agent is reduced to reduce a bubble forming property, with the result that bubbles may remain in the glass when the glass is formed into a sheet shape. Accordingly, a suitable lower limit range of the content of B₂O₃ is 0% or more, 0.10% or more, 0.15% or more, 0.20% or more, 0.30% or more, 0.4% or more, 0.5% or more, 0.6% or more, 0.7% or more, 0.8% or more, 0.9% or more, 1% or more, 1.5% or more, 2% or more, 2.5% or more, 3% or more, 3.5% or more, or 4% or more, particularly 4.5% or more. Meanwhile, when the content of B₂O₃ is too large, a depth of compression may be reduced. In particular, the efficiency of ion exchange between a Na ion in the glass and a K ion in the molten salt is liable to be reduced, and the diffusion of the K ion is liable to be reduced. Accordingly, a suitable upper limit range of the content of B₂O₃ is 15% or less, 14.5% or less, 14% or less, 13.5% or less, 13% or less, 12.5% or less, 12% or less, 11.5% or less, 11% or less, 10.5% or less, 10% or less, 9.5% or less, 9% or less, 8.5% or less, 8% or less, 7.5% or less, 7% or less, 6.5% or less, or 6% or less, particularly 5.5% or less. When the content of B₂O₃ is set to fall within the suitable ranges, it becomes easy to form the profile having the first peak “a”, the first bottom “b”, the second peak “c”, and the second bottom “d”.

Li₂O is an ion exchange component, and is particularly an essential component for obtaining a large depth of compression through ion exchange between a Li ion in the glass and a Na ion in the molten salt. In addition, Li₂O is a component that reduces the viscosity at high temperature to improve the meltability and the formability, and is also a component that increases the Young's modulus. Accordingly, a suitable lower limit range of the content of Li₂O is 0% or more, 0.1% or more, 0.5% or more, 1% or more, 1.5% or more, 2% or more, 2.5% or more, 3% or more, 3.5% or more, 4% or more, 4.3% or more, 4.5% or more, 4.7% or more, 5% or more, 5.2% or more, 5.5% or more, or 5.8% or more, particularly 6.0% or more. In addition, a suitable upper limit range of the content of Li₂O is 15% or less, 13% or less, 12% or less, 11.5% or less, 11% or less, 10.5% or less, 10% or less, 9.8% or less, 9.5% or less, 9.3% or less, 9% or less, 8.8% or less, 8.5% or less, or 8.2% or less, particularly 8.0% or less.

Na₂O is an ion exchange component, and is also a component that reduces the viscosity at high temperature to improve the meltability and the formability. In addition, Na₂O is a component that improves the devitrification resistance, and is particularly a component that suppresses devitrification caused by a reaction with alumina-based refractory. Accordingly, a suitable lower limit range of the content of Na₂O is 0% or more, 0.5% or more, 1% or more, 1.2% or more, 1.5% or more, 1.8% or more, 2% or more, 2.1% or more, 2.3% or more, 2.5% or more, 2.8% or more, 3% or more, 3.2% or more, 3.5% or more, 4% or more, 4.5% or more, 5% or more, 5.5% or more, 6% or more, or 6.5% or more, particularly 7% or more. Meanwhile, when the content of Na₂O is too large, the thermal expansion coefficient is excessively increased, and the thermal shock resistance is liable to be reduced. In addition, the glass composition loses its component balance, and the devitrification resistance may be reduced contrarily. Accordingly, a suitable upper limit range of the content of Na₂O is 25% or less, 21% or less, 20% or less, or 19% or less, particularly 18% or less, 15% or less, 13% or less, or 11% or less, particularly 10% or less.

K₂O is a component that reduces the viscosity at high temperature to improve the meltability and the formability. Further, K₂O is a component that increases the depth of compression. Accordingly, a suitable lower limit range of the content of K₂O is 0% or more, 0.01% or more, 0.02% or more, 0.03% or more, 0.05% or more, 0.08% or more, 0.1% or more, 0.2% or more, 0.3% or more, or 0.4% or more, particularly 0.5% or more. Meanwhile, when the content of K₂O is too large, the thermal expansion coefficient may be increased, and the thermal shock resistance may be reduced. In addition, a compressive stress value on the outermost surface is liable to be reduced. Accordingly, a suitable upper limit range of the content of K₂O is 10% or less, 7% or less, 6% or less, 5% or less, 4% or less, 3% or less, 2% or less, 1.5% or less, or 1% or less, particularly less than 1%.

MgO is a component that reduces the viscosity at high temperature to improve the meltability and the formability, and increases the strain point and the Vickers hardness. Among alkaline earth metal oxides, MgO is a component that has a high improving effect on the ion exchange performance. Accordingly, a suitable lower limit range of the content of MgO is 0% or more, 0.03% or more, 0.05% or more, 0.07% or more, 0.10% or more, 0.15% or more, 0.2% or more, 0.5% or more, 0.6% or more, 0.7% or more, 1.0% or more, or 1.5% or more, particularly 1.8% or more. Meanwhile, when the content of MgO is too large, the devitrification resistance is liable to be reduced. In particular, it becomes difficult to suppress devitrification caused by a reaction with alumina-based refractory. Accordingly, a suitable upper limit range of the content of MgO is 15% or less, 12% or less, 11% or less, 10% or less, 8% or less, 7% or less, 6.5% or less, 6% or less, 5.5% or less, 5% or less, 4.7% or less, 4.5% or less, 4.2% or less, 4% or less, or 3.8% or less, particularly 3.5% or less.

CaO is a component that reduces the viscosity at high temperature to improve the meltability and the formability without reducing the devitrification resistance as compared to other components, and increases the strain point and the Vickers hardness. However, when the content of CaO is too large, the ion exchange performance may be reduced, or an ion exchange solution may be degraded at the time of ion exchange treatment. Accordingly, the content of CaO is preferably from 0% to 10%, from 0% to 9%, from 0% to 8%, from 0% to 7%, from 0% to 6%, from 0% to 5.5%, from 0% to 5%, from 0% to 4.5%, from 0% to 4%, from 0% to 3.5%, from 0% to 3%, from 0% to 2%, from 0% to 18, from 0% to less than 1%, from 0% to 0.7%, from 0% to 0.5%, from 0% to 0.3%, from 0% to 0.1%, from 0% to 0.05%, or from 0% to 0.02%, particularly preferably from 0% to less than 0.01%. When mixing of CaO as an impurity is permitted, the content of CaO is preferably 0.01% or more or 0.02% or more, particularly preferably 0.03% or more.

SrO is a component that reduces the viscosity at high temperature to improve the meltability and the formability, and increases the strain point and the Young's modulus. However, when the content of SrO is too large, an ion exchange reaction is liable to be inhibited. Besides, the density or the thermal expansion coefficient is increased inappropriately, or the glass is liable to devitrify. Accordingly, the content of SrO is preferably from 0% to 2%, from 0% to 1.5%, from 0% to 1%, from 0% to 0.5%, or from 0% to 0.1%, particularly preferably from 0% to less than 0.1%.

BaO is a component that reduces the viscosity at high temperature to improve the meltability and the formability, and increases the strain point and the Young's modulus. However, when the content of BaO is too large, the ion exchange reaction is liable to be inhibited. Besides, the density or the thermal expansion coefficient is increased inappropriately, or the glass is liable to devitrify. Accordingly, the content of BaO is preferably from 0% to 2%, from 0% to 1.5%, from 0% to 1%, from 0% to 0.5%, or from 0% to 0.1%, particularly preferably from 0% to less than 0.1%.

ZnO is a component that improves the ion exchange performance, and is particularly a component that has a high increasing effect on the compressive stress value of the compressive stress layer on the outermost surface. In addition, ZnO is a component that reduces the viscosity at high temperature without significantly reducing a viscosity at low temperature. Meanwhile, when the content of ZnO is too large, there is a tendency that the glass undergoes phase separation, the devitrification resistance is reduced, the density is increased, or the depth of compression is reduced. Accordingly, a suitable upper limit range of the content of ZnO is 10% or less, 8% or less, 7% or less, 6% or less, 5.5% or less, 5.2% or less, 5% or less, or 4.5% or less, particularly 4% or less. A suitable lower limit range of the content of ZnO is 0% or more, 0.1% or more, 0.2% or more, 0.3% or more, 0.4% or more, 0.5% or more, 0.7% or more, 1% or more, 1.1% or more, 1.2% or more, 1.5% or more, 1.8% or more, 2.0% or more, 2.1% or more, 2.2% or more, 2.5% or more, 2.8% or more, 3.0% or more, 3.1% or more, or 3.2% or more, particularly 3.5% or more.

P₂O₅ is a component that improves the ion exchange performance, and is particularly a component that increases the depth of compression. Further, P₂O₅ is a component that improves the acid resistance. Further, P₂O₅ is a component that increases the oxygen electron constraint force exhibited by a cation to reduce the basicity of the glass. However, when the content of P₂O₅ is too large, the glass undergoes phase separation, and water resistance is liable to be reduced. In addition, the depth of compression (DOC_{Na}) obtained through ion exchange between a Li ion in the glass and a Na ion in the molten salt is excessively increased, with the result that the compressive stress value at a predetermined depth (from 5 μm to 50 μm) from the outermost surface is liable to be reduced. Accordingly, a suitable upper limit range of the content of P₂O₅ is 15% or less, 10% or less, 8% or less, 7% or less, 6% or less, 5% or less, 4.7% or less, 4.5% or less, or 4% or less, particularly 3.5% or less. When the content of P₂O₅ is set to fall within the suitable ranges, it becomes easy to form a non-monotonic profile. Meanwhile, when the content of P₂O₅ is too small, the ion exchange performance may not be sufficiently exhibited. In particular, the efficiency of ion exchange between a Na ion in the glass and a K ion in the molten salt is liable to be reduced, and the diffusion of the K ion is liable to be reduced. In addition, the glass may become unstable, and the devitrification resistance may be reduced. In addition, the basicity of the glass is excessively increased, and the release amount of O₂ through a reaction of a fining agent is reduced to reduce the bubble forming property, with the result that bubbles may remain in the glass when the glass is formed into a sheet shape. Accordingly, a suitable lower limit range of the content of P₂O₅ is 0% or more, 0.01% or more, 0.02% or more, 0.03% or more, 0.05% or more, 0.1% or more, 0.4% or more, 0.7% or more, 1% or more, 1.2% or more, 1.4% or more, 1.6% or more, 2% or more, or 2.3% or more, particularly 2.5% or more.

SnO₂ is a fining agent, and is also a component that improves the ion exchange performance. However, when the content of SnO₂ is too large, the devitrification resistance is liable to be reduced. Accordingly, a suitable lower limit range of the content of SnO₂ is 0% or more, 0.001% or more, 0.002% or more, 0.005% or more, or 0.007% or more, particularly 0.010% or more, and a suitable upper limit range thereof is 0.30% or less, 0.27% or less, 0.25% or less, 0.20% or less, 0.18% or less, 0.15% or less, 0.12% or less, 0.10% or less, 0.09% or less, 0.08% or less, 0.07% or less, 0.06% or less, 0.05% or less, 0.047% or less, 0.045% or less, 0.042% or less, 0.040% or less, 0.038% or less, 0.035% or less, 0.032% or less, 0.030% or less, 0.025% or less, or 0.020% or less, particularly 0.015% or less.

Cl is a fining agent. Particularly when Cl is used in combination with SnO₂, a bubble diameter in the glass is easily expanded, and a fining effect is easily exhibited. Meanwhile, Cl is a component that adversely affects an environment or a facility when the content thereof is too large. Accordingly, a suitable lower limit range of the content of cl is 0.001% or more, 0.005% or more, 0.008% or more, 0.010% or more, 0.015% or more, 0.018% or more, 0.019% or more, 0.020% or more, 0.023% or more, 0.025% or more, 0.027% or more, 0.030% or more, 0.035% or more, 0.040% or more, 0.050% or more, 0.07% or more, or 0.09% or more, particularly 0.10% or more, and a suitable upper limit range thereof is 0.3% or less, 0.2% or less, 0.17% or less, or 0.15% or less, particularly 0.12% or less.

MoO₃ is a component that absorbs UV light (light at a wavelength of from 200 nm to 300 nm). When MoO₃ is incorporated in the glass, an internal element of a device using the tempered glass sheet of the present invention as a cover glass can be prevented from being degraded by UV light. In addition, MoO₃ is a component that is mixed in through a manufacturing process as well. Particularly when a raw material batch is melted through electric melting heating, MoO₃ is mixed in by being eluted from a Mo electrode. The use of electric melting can reduce the amount of water in the glass. When the amount of water in the glass is reduced, a liquidus viscosity and the strain point are increased, and the devitrification resistance and heat resistance of the glass can be improved. In addition, when the strain point is increased, stress relaxation is less liable to occur, and a high compressive stress value can be maintained. When the content of MoO₃ is too small, the electric melting, which may involve mixing of MoO₃, cannot be used, and hence the above-mentioned effects are not obtained. Accordingly, a suitable lower limit range of the content of MoO₃ is 0% or more, 0.0001% or more, 0.0003% or more, 0.0005% or more, 0.0008% or more, 0.001% or more, 0.0012% or more, or 0.0015% or more, particularly 0.002% or more. Meanwhile, when the content of MoO₃ is too large, the transmittance of a cover glass is liable to be reduced. Accordingly, a suitable upper limit range of the content of MoO₃ is 0.02% or less, 0.018% or less, 0.015% or less, 0.012% or less, 0.01% or less, 0.008% or less, 0.007% or less, 0.006% or less, or 0.005% or less, particularly less than 0.004%.

A suitable lower limit range of [B₂O₃]+[MgO]+[CaO], which is the total of the contents of B₂O₃, MgO, and CaO, is 0.1% or more, 0.5% or more, 0.8% or more, 1% or more, 2% or more, 3% or more, 3.5% or more, 4% or more, 5% or more, 6% or more, or 6.5% or more, particularly 7% or more. When the value of [B₂O₃]+[MgO]+[CaO] is too small, it is difficult to reduce the softening point. Meanwhile, when the value of [B₂O₃]+[MgO]+[CaO] is too large, the glass may become unstable, and the devitrification resistance may be reduced. Accordingly, a suitable upper limit range of [B₂O₃]+[MgO]+[CaO] is 30% or less, 28% or less, 25% or less, 24% or less, 22% or less, or 20% or less, particularly 18% or less.

A suitable lower limit range of [Li₂O]+[Na₂O]+[K₂O], which is the total of the contents of Li₂O, Na₂O, and K₂O, is 7% or more, 7.5% or more, 8% or more, 8.5% or more, 8.8% or more, 9% or more, 9.5% or more, 9.7% or more, 10% or more, or 10.2% or more, particularly 10.5% or more. When the value of [Li₂O]+[Na₂O]+[K₂O] is too small, the efficiency of ion exchange is liable to be reduced, and it is difficult to reduce the softening point. Meanwhile, when the value of [Li₂O]+[Na₂O]+[K₂O] is too large, chemical resistance may be reduced. A suitable upper limit range of [Li₂O]+[Na₂O]+[K₂O] is 30% or less, 28% or less, 25% or less, or 24% or less, particularly 23% or less.

A suitable lower limit range of [Al₂O₃]+[Li₂O]+[Na₂O]+[K₂O], which is the total of the contents of Al₂O₃, Li₂O, Na₂O, and K₂O, is 10.5% or more, 11% or more, 11.5% or more, 12.0% or more, 12.3% or more, 12.5% or more, 13.0% or more, 14.0% or more, 15% or more, 16% or more, 18% or more, 19% or more, 20% or more, 21% or more, 24% or more, 25% or more, or 28% or more, particularly 30% or more. When the value of [Al₂O₃]+[Li₂O]+[Na₂O]+[K₂O] is too small, the efficiency of ion exchange is liable to be reduced, and it is difficult to reduce the softening point. Meanwhile, when the value of [Al₂O₃]+[Li₂O]+[Na₂O]+[K₂O] is too large, the liquidus viscosity and the chemical resistance may be reduced. A suitable upper limit range of [Al₂O₃]+[Li₂O]+[Na₂O]+[K₂O] is 45% or less, 40% or less, 38% or less, or 35% or less, particularly 33% or less.

A suitable lower limit range of a molar ratio ([Li₂O]+[Na₂O]+[K₂O])/[Al₂O₃] is 0.5 or more, 0.6 or more, 0.7 or more, 0.75 or more, 0.8 or more, 0.85 or more, or 0.9 or more, particularly 0.95 or more. When the molar ratio ([Li₂O]+[Na₂O]+[K₂O])/[Al₂O₃] is too low, the efficiency of ion exchange is liable to be reduced. Meanwhile, also when the molar ratio ([Li₂O]+[Na₂O]+[K₂O])/[Al₂O₃] is too high, the efficiency of ion exchange is liable to be reduced. Accordingly, a suitable upper limit range of the molar ratio ([Li₂O]+[Na₂O]+[K₂O])/[Al₂O₃] is 2.0 or less, 1.9 or less, 1.8 or less, 1.7 or less, 1.6 or less, 1.5 or less, or 1.4 or less, particularly 1.3 or less. The molar ratio “([Li₂O]+[Na₂O]+[K₂O])/[Al₂O₃]” refers to a value obtained by dividing the total of the contents of Li₂O, Na₂O, and K₂O by the content of Al₂O₃.

A suitable upper limit range of a molar ratio [Al₂O₃]/([R₂O]+[RO]) is 1.5 or less, 1.4 or less, 1.3 or less, 1.2 or less, 1.1 or less, or 1 or less, particularly 0.9 or less. When the molar ratio [Al₂O₃]/([R₂O]+[RO]) is too high, the viscosity at high temperature is increased, with the result that the meltability and the formability are liable to be reduced. Meanwhile, when the molar ratio [Al₂O₃]/([R₂O]+[RO]) is too low, the liquidus temperature may be increased, and the liquidus viscosity may be reduced. Accordingly, a suitable lower limit range of the molar ratio [Al₂O₃]/([R₂O]+[RO]) is 0.2 or more, 0.25 or more, 0.3 or more, or 0.35 or more, particularly 0.4 or more. The molar ratio [Al₂O₃]/([R₂O]+[RO]) refers to a value obtained by dividing the content of Al₂O₃ by the total of the total content R₂O of alkali metal oxides and the total content RO of alkaline earth oxides.

A suitable upper limit range of a molar ratio [Na₂O]/[Li₂O] is 1.0 or less, 0.9 or less, 0.8 or less, 0.7 or less, 0.6 or less, 0.5 or less, 0.4 or less, or 0.35 or less, particularly 0.3 or less. When the molar ratio [Na₂O]/[Li₂O] is too high, the efficiency of ion exchange between a Li ion in the glass and a Na ion in the molten salt is liable to be reduced. Meanwhile, when the molar ratio [Na₂O]/[Li₂O] is too low, the efficiency of ion exchange between a Na ion in the glass and a K ion in the molten salt is liable to be reduced. The molar ratio [Na₂O]/[Li₂O] is preferably 0.03 or more, 0.05 or more, 0.07 or more, 0.10 or more, or 0.15 or more, particularly preferably 0.2 or more. The molar ratio [Na₂O]/[Li₂O] refers to a value obtained by dividing the content of Na₂O by the content of Li₂O.

A suitable lower limit range of a molar ratio ([ZnO]+[Li₂O]+[Na₂O]+[K₂O])/[Al₂O₃] is 0.7 or more, 0.75 or more, 0.8 or more, 0.85 or more, or 0.9 or more, particularly 0.95 or more. When the molar ratio ([ZnO]+[Li₂O]+[Na₂O]+[K₂O])/[Al₂O₃] is too low, the efficiency of ion exchange is liable to be reduced, and it is difficult to reduce the softening point. Meanwhile, also when the molar ratio ([ZnO]+[Li₂O]+[Na₂O]+[K₂O])/[Al₂O₃] is too high, the efficiency of ion exchange is liable to be reduced. Accordingly, a suitable upper limit range of the molar ratio ([ZnO]+[Li₂O]+[Na₂O]+[K₂O])/[Al₂O₃] is 2 or less, 1.9 or less, 1.8 or less, 1.7 or less, 1.6 or less, 1.5 or less, or 1.4 or less, particularly 1.3 or less. The molar ratio ([ZnO]+[Li₂O]+[Na₂O]+[K₂O])/[Al₂O₃] refers to a value obtained by dividing the total of the contents of ZnO, Li₂O, Na₂O, and K₂O by the content of Al₂O₃.

A molar ratio [MgO]/[Al₂O₃] is preferably 1.0 or less, 0.8 or less, 0.6 or less, 0.5 or less, 0.4 or less, 0.3 or less, or 0.25 or less, particularly preferably 0.2 or less. When the molar ratio [MgO]/[Al₂O₃] is too high, reaction stones are liable to be generated at the time of contact with a forming body (particularly, an alumina forming body) at high temperature, with the result that the quality of the glass formed into a sheet shape may be reduced. Meanwhile, the lower limit of the molar ratio [MgO]/[Al₂O₃] is not particularly limited, but is, for example, 0 or more, 0.01 or more, 0.03 or more, or 0.05 or more. The molar ratio “[MgO]/[Al₂O₃]” refers to a value obtained by dividing the content of MgO by the content of Al₂O₃.

When the range of a molar ratio ([SiO₂]+[B₂O₃]+[P₂O₅])/((100×[SnO₂])×([Li 20]+[Na₂O]+[K₂O]+[MgO]+[CaO]+[BaO]+[SrO]+[ZnO]+[Al₂O₃])) is restricted, the devitrification resistance can be improved while a fining property is improved. A suitable lower limit range of the molar ratio ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is 0.30 or more, 0.33 or more, 0.35 or more, 0.37 or more, 0.38 or more, 0.39 or more, 0.40 or more, 0.41 or more, 0.42 or more, 0.43 or more, 0.44 or more, 0.45 or more, 0.48 or more, 0.50 or more, 0.51 or more, 0.52 or more, 0.53 or more, or 0.54 or more, particularly 0.55 or more. When ratio the molar ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is too low, a SnO₂ crystal is liable to be precipitated. An upper limit range of the molar ratio ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is not particularly limited, but is, for example, 4.0 or less, 3.0 or less, 2.0 or less, 1.5 or less, or 1.0 or less. The molar ratio “([SiO₂]+[B₂O₃]+[P₂O₅])/((100×[SnO₂])×([Al₂O₃]+[Li₂O]+[Na₂O]+[K₂O]+[MgO]+[CaO]+[BaO]+[SrO]+[ZnO]))” refers to a value obtained by dividing the total content of SiO₂, B₂O₃, and P₂O₅ by a value obtained by multiplying a value that is 100 times as large as the content of SnO₂ and the total content of Al₂O₃, Li₂O, Na₂O, K₂O, MgO, CaO, BaO, SrO, and ZnO together.

A suitable lower limit range of a molar ratio [Li₂O]/([Na₂O]+[K₂O]) is 0.1 or more, 0.3 or more, 0.5 or more, or 0.6 or more, particularly 0.7 or more. When the molar ratio [Li₂O]/([Na₂O]+[K₂O]) is too low, the ion exchange performance may not be sufficiently exhibited. In particular, the efficiency of ion exchange between a Li ion in the glass and a Na ion in the molten salt is liable to be reduced. Meanwhile, when the molar ratio [Li₂O]/([Na₂O]+[K₂O]) is too high, a devitrified crystal is liable to be precipitated in the glass, and it becomes difficult to form the glass into a sheet shape by an overflow down-draw method or the like. Accordingly, a suitable upper limit range of the molar ratio [Li₂O]/([Na₂O]+[K₂O]) is 10 or less, 9 or less, 8.5 or less, 8 or less, 7.5 or less, 7 or less, 6.5 or less, or 6.3 or less, particularly 6 or less. The molar ratio “[Li₂O]/([Na₂O]+[K₂O])” refers to a value obtained by dividing the content of Li₂O by the total content of Na₂O and K₂O.

A Q value calculated by the following equation is a factor correlated to the acid resistance. When the Q value is too low, the acid resistance is liable to be reduced. Accordingly, a suitable lower limit range of the Q value is −30 or more, −25 or more, −20 or more, −18 or more, −15 or more, −12 or more, −10 or more, or −8 or more, particularly −5 or more. Meanwhile, when the Q value is too high, the ion exchange performance may not be sufficiently exhibited. Accordingly, a suitable upper limit range of the Q value is 50 or less, 45 or less, 42 or less, or 40 or less, particularly 35 or less.

$$Q = [ {SiO}_{2} ] + 1.2 \times [ {P}_{2} {O}_{5} ] - 3 \times [ {Al}_{2} {O}_{3} ] - [ {B}_{2} {O}_{3} ] - 2 \times [ L {i}_{2} O ] - 1.5 \times [ {Na}_{2} O ] - [ {K}_{2} O ]$$

A suitable lower limit range of a molar ratio [Li₂O]/[Al₂O₃] is 0.1 or more, 0.2 or more, 0.3 or more, 0.40 or more, 0.42 or more, 0.44 or more, 0.50 or more, 0.52 or more, or 0.55 or more, particularly 0.58 or more. When the molar ratio [Li₂O]/[Al₂O₃] is too low, the ion exchange performance may not be sufficiently exhibited. In particular, the efficiency of ion exchange between a Li ion in the glass and a Na ion in the molten salt is liable to be reduced. Meanwhile, when the molar ratio [Li₂O]/[Al₂O₃] is too high, a devitrified crystal is liable to be precipitated in the glass, and it becomes difficult to form the glass into a sheet shape by an overflow down-draw method or the like. Accordingly, a suitable upper limit range of the molar ratio [Li₂O]/[Al₂O₃] is 2.0 or less, 1.8 or less, 1.5 or less, 1.2 or less, 1.0 or less, 0.8 or less, 0.7 or less, or 0.68 or less, particularly 0.60 or less. The molar ratio “[Li₂O]/[Al₂O₃]” refers to a value obtained by dividing the content of Li₂O by the content of Al₂O₃.

An X value calculated by the following equation is a factor correlated to an exchange speed between a Li ion and a Na ion. When the X value is too low, the efficiency of ion exchange between a Li ion and a Na ion in the molten salt is reduced, and it becomes difficult to produce a compressive stress. In particular, the depth of compression (DOC_{Na}) of the compressive stress layer obtained through ion exchange between a Li ion in the glass and a Na ion in the molten salt may be reduced. Accordingly, a suitable lower limit range of the X value is 300 or more, 320 or more, 330 or more, 340 or more, 350 or more, 400 or more, 450 or more, 460 or more, 480 or more, 500 or more, or 520 or more, particularly 550 or more. An upper limit range of the X value is not particularly limited, but is, for example, 900 or less or 880 or less.

$$X = - 1.49 \times [ S i {O}_{2} ] + 2 6.98 \times [ A {l}_{2} {O}_{3} ] - 3.23 \times [ {B}_{2} {O}_{3} ] + 48.56 \times [ L {i}_{2} O ] - 24. 31 \times [ N {a}_{2} O ] - 0.28 \times [ M g O ] + 2.74 \times [ C a O ]$$

A Y value calculated by the following equation is a factor correlated to an exchange speed between a Na ion and a K ion. When the Y value is too low, the efficiency of ion exchange between a Na ion in the glass and a K ion in the molten salt is reduced, and it becomes difficult to produce a compressive stress. In particular, the depth of compression (DOCK) of the compressive stress layer obtained through ion exchange between a Na ion in the glass and a K ion in the molten salt may be reduced. Accordingly, a suitable lower limit range of the Y value is 4 or more, 4.3 or more, 4.5 or more, 4.8 or more, 5 or more, 5.2 or more, 5.5 or more, 6 or more, 7 or more, 8 or more, 9 or more, or 10 or more, particularly 11 or more. An upper limit range of the Y value is not particularly limited, but is, for example, 30 or less or 25 or less.

$$Y = 3 + 0.21 \times [ S i {O}_{2} ] + 0.25 \times [ A {l}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ M g O ] - 1.46 \times [ C a O ]$$

A Z value calculated by the following equation is strongly correlated to both the exchange speed between a Li ion and a Na ion and the exchange speed between a Na ion and a K ion, and is a particularly important factor when the glass sheet to be tempered is subjected to ion exchange treatment a plurality of times. When the Z value is too low, the efficiency of ion exchange between a Li ion and a Na ion in the molten salt is liable to be reduced, and also the efficiency of ion exchange between a Na ion and a K ion in the molten salt is liable to be reduced. Thus, it becomes difficult to produce a compressive stress through each of the above-mentioned two kinds of ion exchange. Accordingly, a suitable lower limit range of the Z value is 18 or more, 18.5 or more, 19 or more, 20 or more, 25 or more, 30 or more, 35 or more, or 45 or more, particularly 50 or more. An upper limit range of the Z value is not particularly limited, but is, for example, 120 or less or 100 or less.

$$Z = 0.13 \times [ S i {O}_{2} ] + 2.36 \times [ A {l}_{2} {O}_{3} ] - 0.14 \times [ {B}_{2} {O}_{3} ] + 4.9 \times [ L {i}_{2} O ] - 5.53 \times [ N {a}_{2} O ] - 2.14 \times [ M g O ] - 2.34 \times [ C a O ]$$

A W value calculated by the following equation is a factor correlated to the Young's modulus. When the W value is too low, the Young's modulus is reduced, and the glass is liable to be broken. Accordingly, a suitable lower limit range of the W value is 250 or more, 300 or more, 330 or more, 340 or more, 350 or more, 360 or more, 370 or more, 400 or more, 430 or more, 450 or more, or 480 or more, particularly 500 or more. An upper limit range of the W value is not particularly limited, but is, for example, 750 or less or 700 or less.

$$W = 0. 07 \times [ S i {O}_{2} ] + 18. 17 \times [ A {l}_{2} {O}_{3} ] - 4.42 \times [ {B}_{2} {O}_{3} ] + 41.43 \times [ L {i}_{2} O ] - 29.3 \times [ N {a}_{2} O ] + 1.43 \times [ M g O ] - 10.43 \times [ C a O ]$$

A U value calculated by the following equation is a factor correlated to the fracture toughness. When the U value is too low, the fracture toughness value is reduced, and the glass is liable to be broken. Accordingly, a suitable lower limit range of the U value is 7,000 or more, 7,100 or more, 7,500 or more, 7,600 or more, 7,700 or more, 7,750 or more, 7,800 or more, or 7,850 or more, particularly 7,900 or more. An upper limit range of the U value is not particularly limited, but is, for example, 20,000 or less, 18,000 or less, 15,000 or less, 12,000 or less, 10,000 or less, or 9,500 or less.

$$U = 87.39 \times [ S i {O}_{2} ] + 180.12 \times [ A {l}_{2} {O}_{3} ] + 93.63 \times [ {B}_{2} {O}_{3} ] + 113.78 \times ( [ M g O ] + [ C a O ] + [ B a O ] + [ S r O ] ) - 46.2 \times [ L {i}_{2} O ] - 71 \text{.1} \times [ N {a}_{2} O ] - 58.6 \times [ {K}_{2} O ] - 40.0 \times [ {P}_{2} {O}_{5} ]$$

For example, the following components may be added in addition to the above-mentioned components.

TiO₂ is a component that improves the ion exchange performance, and is also a component that reduces the viscosity at high temperature. However, when the content of TiO₂ is too large, transparency and the devitrification resistance are liable to be reduced. Accordingly, a suitable content of TiO₂ is from 0% to 10%, from 0% to 5%, from 0% to 3%, from 0% to 1.5%, from 0% to 1%, or from 0% to 0.1%, particularly from 0.001% to 0.1%.

ZrO₂ is a component that increases the Vickers hardness, and is also a component that increases viscosity around the liquidus viscosity and the strain point. However, when the content of ZrO₂ is too large, the devitrification resistance may be significantly reduced. Accordingly, a suitable content of ZrO₂ is from 0% to 10%, from 0% to 5%, from 0% to 3%, from 0% to 1.5%, from 0% to 1%, from 0% to 0.5%, from 0% to 0.4%, from 0% to 0.3%, or from 0% to 0.2%, particularly from 0% to 0.1%.

La₂O₃ is a component that increases the Young's modulus and the fracture toughness. However, when the content of La₂O₃ is too large, the liquidus viscosity may be reduced. Accordingly, a suitable content of La₂O₃ is from 0% to 5%, from 0% to 3%, from 0% to 1.5%, from 0% to 1%, from 0% to 0.8%, from 0% to 0.5%, from 0% to 0.4%, from 0% to 0.3%, or from 0% to 0.2%, particularly from 0% to 0.1%.

Fe₂O₃ is an impurity that is mixed in from raw materials. A suitable upper limit range of the content of Fe₂O₃ is 0.1% or less, 0.08% or less, 0.05% or less, 0.02% or less, or less than 0.015%, less than 0.01%, or less than 0.008%, particularly less than 0.005%. When the content of Fe₂O₃ is too large, the transmittance of a cover glass is liable to be reduced. Meanwhile, a suitable lower limit range of the content of Fe₂O₃ is 0.001% or more, 0.002% or more, or 0.003% or more. When the content of Fe₂O₃ is too small, a raw material cost rises owing to the use of high-purity raw materials, and a product cannot be manufactured inexpensively.

As a fining agent, SO₃ and/or CeO₂ may be added at from 0.001% to 1%.

Rare earth oxides, such as Nd₂O₃, Y₂O₃, Nb₂O₅, Ta₂O₅, and Hf₂O₃, are each a component that increases the Young's modulus. However, raw material costs therefor are high. In addition, when the rare earth oxides are each added in a large amount, the devitrification resistance is liable to be reduced. Accordingly, a suitable total content of the rare earth oxides is 5% or less, 4% or less, 3% or less, 2% or less, 1% or less, or 0.5% or less, particularly 0.1% or less, and a suitable content of each of Nd₂O₃, Y₂O₃, Nb₂O₅, Ta₂O₅, and Hf₂O₃ is 3% or less, 2% or less, 1% or less, or 0.5% or less, particularly 0.1% or less.

The tempered glass sheet and glass sheet to be tempered of the present invention are each preferably substantially free of As₂O₃, Sb₂O₃, PbO, and F as a glass composition from the standpoint of environmental considerations. In addition, the tempered glass sheet and the glass sheet to be tempered are each preferably substantially free of Bi₂O₃ from the standpoint of environmental considerations. The phrase “substantially free of” has a concept in which the explicit component is not positively added as a glass component, but its addition at an impurity level is permitted, and specifically refers to the case in which the content of the explicit component is less than 0.05%.

The tempered glass sheet and glass sheet to be tempered of the present invention each preferably have the following characteristics.

The density (ρ) is preferably 2.55 g/cm³ or less, 2.53 g/cm³ or less, 2.50 g/cm³ or less, 2.49 g/cm³ or less, 2.48 g/cm³ or less, 2.45 g/cm³ or less, or from 2.35 g/cm³ to 2.44 g/cm³, particularly preferably from 2.25 g/cm³ to 2.44 g/cm³. As the density becomes lower, the weight of the tempered glass sheet can be reduced more.

A thermal expansion coefficient (α₃₀₋₃₈₀° C.) at from 30° C. to 380° C. is preferably 150×10⁻⁷/° C. or less, 100×10⁻⁷/° C. or less, from 50×10⁻⁷/° C. to 95×10⁻⁷/° C., or from 40×10⁻⁷/° C. to 85×10⁻⁷/° C., particularly preferably from 35×10⁻⁷/° C. to 80×10⁻⁷/° C. The term “thermal expansion coefficient at from 30° C. to 380° C.” refers to a value measured for an average thermal expansion coefficient with a dilatometer.

The softening point (Ts) is preferably 950° C. or less, 940° C. or less, 930° C. or less, 920° C. or less, 910° C. or less, 900° C. or less, 890° C. or less, 880° C. or less, 870° C. or less, 860° C. or less, 850° C. or less, 840° C. or less, 830° C. or less, 820° C. or less, or 810° C. or less, particularly preferably from 700° C. to 800° C. When the softening point is too high, thermal processability may be reduced.

A temperature (10^{2.5} dPa·s) at a viscosity at high temperature of 10^{2.5} dPa·s is preferably 1, 680° C. or less, 1, 670° C. or less, 1,660° C. or less, 1,650° C. or less, 1,640° C. or less, 1,630° C. or less, 1,620° C. or less, 1,600° C. or less, 1,550° C. or less, 1,520° C. or less, or 1,500° C. or less, particularly preferably from 1,300° C. to 1, 490° C. When the temperature at a viscosity at high temperature of 10^{2.5} dPa·s is too high, the meltability and the formability are reduced, and it becomes difficult to form molten glass into a sheet shape.

The liquidus viscosity is preferably 10^{3.74} dPa·s or more, 10^{4.3} dPa·s or more, 10^{4.4} dPa·s or more, 10^{4.5} dPa·s or more, 10^{4.6} dPa·s or more, 10^{4.7} dPa·s or more, 10^{4.8} dPa·s or more, 10^{4.9} dPa·s or more, 10^{5.0} dPa·s or more, 10^{5.1} dPa·s or more, 10^{5.2} dPa·s or more, 10^{5.3} dPa·s or more, or 10^{5.4} dPa·s or more, particularly preferably 10^{5.5} dPa·s or more. As the liquidus viscosity becomes higher, the devitrification resistance is improved more, and devitrified stones are less liable to be generated at the time of forming. The term “liquidus viscosity” as used herein refers to a value measured for a viscosity at a liquidus temperature by a platinum sphere pull up method.

The Young's modulus (E) is preferably 60 GPa or more, 65 GPa or more, 70 GPa or more, 71 GPa or more, 72 GPa or more, 73 GPa or more, or 74 GPa or more, particularly preferably 75 GPa or more. When the Young's modulus is low, a cover glass is liable to be deflected when its sheet thickness is small. In addition, an upper limit range of the Young's modulus is not particularly limited, but is substantially 100 GPa or less. The “Young's modulus” may be calculated by a well-known resonance method.

The tempered glass sheet of the present invention has a compressive stress layer in a surface thereof. The compressive stress value (CS) of the compressive stress layer on the outermost surface of the tempered glass sheet is preferably 200 MPa or more, 220 MPa or more, 250 MPa or more, 280 MPa or more, 300 MPa or more, 310 MPa or more, 320 MPa or more, 330 MPa or more, 340 MPa or more, 350 MPa or more, 360 MPa or more, 370 MPa or more, 380 MPa or more, 390 MPa or more, 400 MPa or more, 420 MPa or more, or 430 MPa or more, particularly preferably 450 MPa or more. As the compressive stress value (CS) of the compressive stress layer on the outermost surface becomes higher, the Vickers hardness is increased more. Meanwhile, when an excessively large compressive stress is formed in the surface, the internal tensile stress of the tempered glass sheet may be increased excessively, and a dimensional change before and after ion exchange treatment may be increased. Accordingly, the compressive stress value (CS) of the compressive stress layer on the outermost surface is preferably 1,400 MPa or less, 1,200 MPa or less, 1, 100 MPa or less, 1,000 MPa or less, 900 MPa or less, 700 MPa or less, 680 MPa or less, or 650 MPa or less, particularly preferably 600 MPa or less. There is a tendency that the compressive stress value of the compressive stress layer on the outermost surface is increased when an ion exchange time period is shortened, or the temperature of an ion exchange solution is reduced.

The compressive stress value (CS30) of the tempered glass sheet at a depth of 30 μm from the outermost surface is preferably 35 MPa or more, 40 MPa or more, 50 MPa or more, 60 MPa or more, 70 MPa or more, 80 MPa or more, 90 MPa or more, 100 MPa or more, 105 MPa or more, 110 MPa or more, or 115 MPa or more, particularly preferably 120 MPa or more. As the compressive stress value (CS30) at a depth of 30 μm from the outermost surface becomes higher, the strength of the tempered glass sheet is increased more. Meanwhile, when an excessively large compressive stress is formed at a depth of 30 μm from the outermost surface, the internal tensile stress of the tempered glass sheet may be increased excessively, and a dimensional change before and after the ion exchange treatment may be increased. Accordingly, the compressive stress value (CS30) at a depth of 30 μm from the outermost surface is preferably 400 MPa or less, 350 MPa or less, 300 MPa or less, 250 MPa or less, 230 MPa or less, 220 MPa or less, 210 MPa or less, 205 MPa or less, 200 MPa or less, or 195 MPa or less, particularly preferably 190 MPa or less.

The compressive stress value (CS50) of the tempered glass sheet at a depth of 50 μm from the outermost surface is preferably 20 MPa or more, 30 MPa or more, 40 MPa or more, 50 MPa or more, 60 MPa or more, 70 MPa or more, 80 MPa or more, 90 MPa or more, or 95 MPa or more, particularly preferably 100 MPa or more. As the compressive stress value (CS50) at a depth of 50 μm from the outermost surface becomes higher, the strength of the tempered glass sheet is increased more. Meanwhile, when an excessively large compressive stress is formed at a depth of 50 μm from the outermost surface, the internal tensile stress of the tempered glass sheet may be increased excessively, and a dimensional change before and after the ion exchange treatment may be increased. Accordingly, the compressive stress value (CS50) at a depth of 50 μm from the outermost surface is preferably 380 MPa or less, 350 MPa or less, 300 MPa or less, 250 MPa or less, 220 MPa or less, 210 MPa or less, 200 MPa or less, 195 MPa or less, 190 MPa or less, or 180 MPa or less, particularly preferably 170 MPa or less.

The internal tensile stress value (CT) of the tempered glass sheet is preferably 150 MPa or less, 130 MPa or less, 120 MPa or less, 110 MPa or less, 100 MPa or less, 90 MPa or less, 85 MPa or less, 80 MPa or less, 75 MPa or less, 70 MPa or less, or 60 MPa or less, particularly preferably 50 MPa or less. When the internal tensile stress value is too high, the tempered glass sheet may undergo self-destruction by point collision. An upper limit range of the internal tensile stress value (CT) is not particularly limited, but is substantially 5 μm or more.

The depth of compression of the compressive stress layer of the tempered glass sheet, that is, a depth (DOC) at which the stress value becomes zero is preferably 3 μm or more, 5 μm or more, 10 μm or more, 20 μm or more, 30 μm or more, 40 μm or more, 45 μm or more, 50 μm or more, 55 μm or more, 58 μm or more, 60 μm or more, 65 μm or more, 70 μm or more, 75 μm or more, 80 μm or more, or 85 μm or more, particularly preferably 90 μm or more. As the depth of compression becomes larger, protrusions or sand grains on a road surface are less liable to reach a tensile stress layer at the time of dropping of a smartphone, and thus the breakage probability of a cover glass can be reduced more. Meanwhile, when the depth of compression is too large, a dimensional change before and after the ion exchange treatment may be increased. Further, there is a tendency that the compressive stress value on the outermost surface is reduced. Accordingly, the depth of compression (DOC) is preferably 200 μm or less, 180 μm or less, 150 μm or less, 140 μm or less, 135 μm or less, 130 μm or less, or 125 μm or less, particularly preferably 120 μm or less, particularly more preferably 110 μm or less. There is a tendency that the depth of compression is increased when the ion exchange time period is prolonged, or the temperature of the ion exchange solution is increased.

In addition, a compressive stress value (CSK) on the outermost surface, which is obtained through ion exchange between a Na ion in the glass and a K ion in the molten salt when the glass sheet to be tempered is subjected to ion exchange treatment by being immersed in a KNO₃ molten salt at 430° C. for 4 hours, is preferably 200 MPa or more, 220 MPa or more, 250 MPa or more, 280 MPa or more, 300 MPa or more, 310 MPa or more, 320 MPa or more, 330 MPa or more, 340 MPa or more, 350 MPa or more, 360 MPa or more, 370 MPa or more, 380 MPa or more, 390 MPa or more, 400 MPa or more, 420 MPa or more, or 430 MPa or more, particularly preferably 450 MPa or more. As the compressive stress value on the outermost surface becomes higher, the Vickers hardness is increased more. Meanwhile, when an excessively large compressive stress is formed in the surface, the internal tensile stress of the tempered glass sheet may be increased excessively, and a dimensional change before and after the ion exchange treatment may be increased. Accordingly, the compressive stress value (CS) on the outermost surface is preferably 1,400 MPa or less, 1,200 MPa or less, 1,100 MPa or less, 1,000 MPa or less, 900 MPa or less, 700 MPa or less, 680 MPa or less, or 650 MPa or less, particularly preferably 600 MPa or less. There is a tendency that the compressive stress value on the outermost surface is increased when the ion exchange time period is shortened, or the temperature of the ion exchange solution is reduced.

A depth of layer (DOL_{K}), which is obtained through ion exchange between a Na ion in the glass and a K ion in the molten salt when the glass sheet to be tempered is subjected to ion exchange treatment by being immersed in a KNO₃ molten salt at 430° C. for 4 hours, is preferably 3 μm or more, 4 μm or more, 4.5 μm or more, 5 μm or more, 6 μm or more, 7 μm or more, 8 μm or more, or 9 μm or more, particularly preferably 10 μm or more. As the depth of layer becomes larger, protrusions or sand grains on a road surface are less liable to reach the tensile stress layer at the time of dropping of a smartphone, and thus the breakage probability of a cover glass can be reduced more. Meanwhile, when the depth of layer is too large, a dimensional change before and after the ion exchange treatment may be increased. Further, there is a tendency that the compressive stress value on the outermost surface is reduced. Accordingly, the depth of layer (DOL_{K}) is preferably 40 μm or less, 35 μm or less, 30 μm or less, 28 μm or less, 25 μm or less, 23 μm or less, or 20 μm or less, particularly preferably 18 μm or less. There is a tendency that the depth of layer is increased when the ion exchange time period is prolonged, or the temperature of the ion exchange solution is increased.

Further, a compressive stress value (CS_{Na}) on the outermost surface, which is obtained through ion exchange between a Li ion in the glass and a Na ion in the molten salt when the glass sheet to be tempered is subjected to ion exchange treatment by being immersed in a NaNO₃ molten salt at 380° C. for 1 hour, is preferably 140 MPa or more, 150 MPa or more, 160 MPa or more, 170 MPa or more, 180 MPa or more, or 190 MPa or more, particularly preferably 200 MPa or more. As the compressive stress value on the outermost surface becomes higher, the strength of the tempered glass sheet is increased more. Meanwhile, when an excessively large compressive stress is formed in the surface, the internal tensile stress of the tempered glass sheet is increased excessively, and a dimensional change before and after the ion exchange treatment may be increased. Accordingly, the compressive stress value (CS_{Na}) of the compressive stress layer on the outermost surface is preferably 650 MPa or less, 630 MPa or less, 600 MPa or less, 580 MPa or less, 560 MPa or less, 550 MPa or less, 540 MPa or less, 530 MPa or less, 500 MPa or less, 480 MPa or less, 450 MPa or less, 430 MPa or less, 400 MPa or less, or 380 MPa or less, particularly preferably 350 MPa or less.

A compressive stress value (CS30Na) at a depth of 30 μm from the outermost surface, which is obtained through ion exchange between a Li ion in the glass and a Na ion in the molten salt when the glass sheet to be tempered is subjected to ion exchange treatment by being immersed in a NaNO₃ molten salt at 380° C. for 1 hour, is preferably 35 MPa or more, 40 MPa or more, 50 MPa or more, 60 MPa or more, 70 MPa or more, 80 MPa or more, 90 MPa or more, 100 MPa or more, 105 MPa or more, 110 MPa or more, or 115 MPa or more, particularly preferably 120 MPa or more. As the compressive stress value (CS30Na) at a depth of 30 μm from the outermost surface becomes higher, the strength of the tempered glass sheet is increased more. Meanwhile, when an excessively large compressive stress is formed at a depth of 30 μm from the outermost surface, the internal tensile stress of the tempered glass sheet is increased excessively, and a dimensional change before and after the ion exchange treatment may be increased. Accordingly, the compressive stress value (CS30Na) at a depth of 30 μm from the outermost surface is preferably 400 MPa or less, 350 MPa or less, 300 MPa or less, 250 MPa or less, 230 MPa or less, 220 MPa or less, 210 MPa or less, 205 MPa or less, 200 MPa or less, or 195 MPa or less, particularly preferably 190 MPa or less.

A depth of compression (DOC_{Na}), which is obtained through ion exchange between a Li ion in the glass and a Na ion in the molten salt when the glass sheet to be tempered is subjected to ion exchange treatment by being immersed in a NaNO₃ molten salt at 380° C. for 1 hour, is preferably 3 μm or more, 5 μm or more, 10 μm or more, 20 μm or more, 30 μm or more, 40 μm or more, 45 μm or more, 50 μm or more, 55 μm or more, 58 μm or more, 60 μm or more, 65 μm or more, 70 μm or more, 75 μm or more, 80 μm or more, or 85 μm or more, particularly preferably 90 μm or more. As the depth of compression becomes larger, protrusions or sand grains on a road surface are less liable to reach the tensile stress layer at the time of dropping of a smartphone, and thus the breakage probability of the cover glass can be reduced more. Meanwhile, when the depth of compression is too large, a dimensional change before and after the ion exchange treatment may be increased. Further, there is a tendency that the compressive stress value of the compressive stress layer on the outermost surface is reduced. Accordingly, the depth of compression (DOC_{Na}) is preferably 200 μm or less, 180 μm or less, 150 μm or less, 140 μm or less, 130 μm or less, or 120 μm or less, particularly preferably 110 μm or less. There is a tendency that the depth of compression is increased when the ion exchange time period is prolonged, or the temperature of the ion exchange solution is increased.

An internal tensile stress value (CTcv_{Na}), which is obtained through ion exchange between a Li ion in the glass and a Na ion in the molten salt when the glass sheet to be tempered is subjected to ion exchange treatment by being immersed in a NaNO₃ molten salt at 380° C. for 1 hour, is preferably 150 MPa or less, 130 MPa or less, 120 MPa or less, 110 MPa or less, 100 MPa or less, 90 MPa or less, 85 MPa or less, 80 MPa or less, 75 MPa or less, 70 MPa or less, or 60 MPa or less, particularly preferably 50 MPa or less. When the internal tensile stress value is too high, the tempered glass sheet may undergo self-destruction by point collision. An upper limit range of the internal tensile stress value (CTcv_{Na}) is not particularly limited, but is substantially 5 μm or more.

A ratio DOC_{Na}/DOL_{K} between the depth of compression (DOC_{Na}), which is obtained through ion exchange between a Li ion in the glass and a Na ion in the molten salt when the glass sheet to be tempered is subjected to ion exchange treatment by being immersed in a NaNO₃ molten salt at 380° C. for 1 hour, and the depth of layer (DOL_{K}), which is obtained through ion exchange between a Na ion in the glass and a K ion in the molten salt when the glass sheet to be tempered is subjected to ion exchange treatment by being immersed in a KNO₃ molten salt at 430° C. for 4 hours, is preferably 15 or less, 12 or less, 10 or less, 9 or less, 8 or less, 7.5 or less, 7.0 or less, 6.5 or less, 6.0 or less, 5.5 or less, 5.0 or less, or 4.5 or less. When the ratio DOC_{Na}/DOL_{K} is too high, the compressive stress value (CS30) of the tempered glass sheet, which has been subjected to two-step tempering by being immersed in a NaNO₃ molten salt and then immersed in a KNO₃ molten salt, at a depth of 30 μm from the outermost surface may be reduced. Meanwhile, when the ratio DOC_{Na}/DOL_{K} is too low, a time period required for ion exchange between a Li ion in the glass and a Na ion in the molten salt may be excessively prolonged.

A mass loss of the tempered glass sheet of the present invention per unit surface area when the tempered glass sheet is immersed in a 5 mass % HCl aqueous solution warmed to 80° C. for 24 hours is preferably 2.0 mg/cm² or less, 1.5 mg/cm² or less, 1.0 mg/cm² or less, or 0.8 mg/cm² or less, particularly preferably 0.5 mg/cm² or less. The tempered glass sheet may be brought into contact with an acidic chemical solution depending on a use environment of a device, and hence preferably has high acid resistance from the viewpoint of preventing a failure of the device.

In addition, a mass loss of the tempered glass sheet per unit surface area when the tempered glass sheet is immersed in a 5 mass % NaOH aqueous solution warmed to 80° C. for 6 hours is preferably 5.0 mg/cm² or less, 4.5 mg/cm² or less, 4.0 mg/cm² or less, 3.5 mg/cm² or less, or 3.0 mg/cm² or less, particularly preferably 2.0 mg/cm² or less. The tempered glass sheet may be brought into contact with an alkaline chemical solution or a detergent depending on a use environment of a device, and is hence required to have high alkali resistance.

The fracture toughness K1c is preferably 0.75 MPa·m^{0.5} or more, 0.78 MPa·m^{0.5} or more, 0.79 MPa·m^{0.5} or more, 0.80 MPa·m^{0.5} or more, or 0.81 MPa·m^{0.5} or more, particularly preferably 0.82 MPa·m^{0.5} or more. When the fracture toughness K1c is low, the tempered glass sheet is liable to be broken. The upper limit of the fracture toughness is not particularly limited, but is realistically 10 MPa·m°0.5 or less.

The fracture energy γ is energy per unit fracture area consumed at the time of fracture, and is energy calculated by the equation: γ=(K1c)²/E. The fracture energy γ is preferably 5.0 J/m² or more, 5.5 J/m² or more, 6.0 J/m² or more, 6.5 J/m² or more, 7.0 J/m² or more, 7.5 J/m² or more, or 7.8 J/m² or more, particularly preferably 8.0 J/m² or more. When the fracture energy γ is low, the tempered glass sheet is liable to be shattered at the time of breakage, and it becomes difficult to secure safety. The upper limit of the fracture energy is not particularly limited, but is realistically 30 J/m² or less.

The abraded four-point bending strength of the tempered glass sheet of the present invention is preferably 150 MPa or more, 160 MPa or more, 170 MPa or more, 175 MPa or more, 180 MPa or more, 185 MPa or more, 190 MPa or more, or 195 MPa or more, particularly preferably 200 MPa or more. When the abraded four-point bending strength is too low, the tempered glass sheet is liable to be broken at the time of dropping when used as a cover glass of a smartphone. The upper limit of the abraded four-point bending strength is not particularly limited, but is realistically 1,500 MPa or less.

The tempered glass sheet of the present invention has a thickness of preferably 2.0 mm or less, 1.5 mm or less, 1.3 mm or less, 1.1 mm or less, 1.0 mm or less, or 0.9 mm or less, particularly preferably 0.8 mm or less. As the thickness becomes smaller, the mass of the tempered glass sheet can be reduced more. Meanwhile, when the thickness is too small, it becomes difficult to obtain desired mechanical strength. Accordingly, the thickness is preferably 0.03 mm or more, 0.05 mm or more, 0.1 mm or more, 0.2 mm or more, 0.3 mm or more, 0.4 mm or more, 0.5 mm or more, or 0.6 mm or more, particularly preferably 0.7 mm or more.

A method of manufacturing a tempered glass sheet of the present invention comprises: a preparation step of preparing a glass sheet to be tempered including as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0; and an ion exchange step of subjecting the glass sheet to be tempered to ion exchange treatment to provide a tempered glass sheet having a compressive stress layer in a surface thereof. The method of manufacturing a tempered glass sheet of the present invention encompasses not only the case of performing the ion exchange treatment a plurality of times, but also the case of performing the ion exchange treatment only once.

The method of manufacturing a glass to be tempered is, for example, as described below. As a preferred method, first, glass raw materials blended so as to give a desired glass composition are loaded into a continuous melting furnace, are heated to be melted at from 1,400° C. to 1,700° C., and are fined. After that, the molten glass is supplied to a forming apparatus and formed into a sheet shape, followed by cooling. A well-known method may be adopted as a method of cut processing, into predetermined dimensions, the glass having been formed into a sheet shape.

A method of forming the molten glass into a sheet shape is preferably an overflow down-draw method. In the overflow down-draw method, a glass sheet to be obtained has an overflow-merged surface parallel to a main surface in the inside thereof, and a surface to serve as the surface of the glass sheet is not brought into contact with the surface of the forming body refractory, and is formed into a sheet shape in a state of a free surface. Thus, a glass sheet having satisfactory surface quality can be manufactured inexpensively without polishing. Further, in the overflow down-draw method, alumina-based refractory, zircon-based refractory, or zirconia-based refractory is used as the forming body refractory. Moreover, the tempered glass sheet and the glass sheet to be tempered of the present invention each have good compatibility with the alumina-based refractory or the zirconia-based refractory (particularly the alumina-based refractory), and hence have a property of hardly generating bubbles, stones, or the like through a reaction with the refractory.

Various forming methods may be adopted in addition to the overflow down-draw method. For example, forming methods, such as a float method, a down-draw method (e.g., a slot down-draw method or a re-draw method), a roll out method, and a press method, may be adopted.

At the time of forming of the molten glass, the molten glass is preferably cooled in a temperature region of from the annealing point of the molten glass to the strain point thereof at a cooling rate of 3° C./min or more and less than 1,000° C./min. A lower limit range of the cooling rate is preferably 10° C./min or more, 20° C./min or more, or 30° C./min or more, particularly preferably 50° C./min or more, and an upper limit range thereof is preferably less than 1,000° C./min or less than 500° C./min, particularly preferably less than 300° C./min. When the cooling rate is too high, the structure of the glass becomes coarse, and it becomes difficult to increase the Vickers hardness after the ion exchange treatment. Meanwhile, when the cooling rate is too low, the production efficiency of the glass sheet is reduced.

In the method of manufacturing a tempered glass sheet of the present invention, the ion exchange treatment may be performed a plurality of times. As the ion exchange treatment performed a plurality of times, it is preferred to perform ion exchange treatment in which the glass sheet to be tempered is immersed in a molten salt containing a KNO₃ molten salt and/or a NaNO₃ molten salt, and then perform ion exchange treatment in which the glass sheet to be tempered is immersed in a molten salt containing a KNO₃ molten salt and/or a NaNO₃ molten salt. With this configuration, the compressive stress value of the compressive stress layer on the outermost surface can be increased while a large depth of compression is ensured.

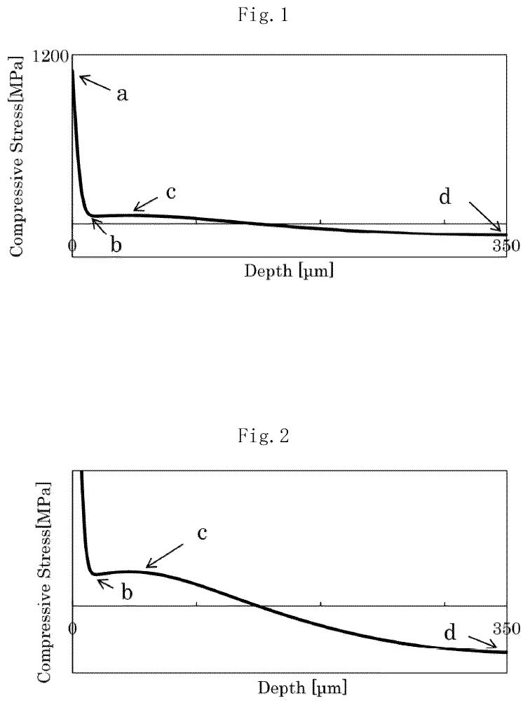

In particular, in the method of manufacturing a tempered glass sheet of the present invention, it is preferred to perform ion exchange treatment (first ion exchange step) in which the glass sheet to be tempered is immersed in a NaNO₃ molten salt or a mixed molten salt of NaNO₃ and KNO₃, and then perform ion exchange treatment (second ion exchange step) in which the glass sheet to be tempered is immersed in a mixed molten salt of KNO₃ and LiNO₃. With this configuration, a non-monotonic stress profile (stress distribution of the glass sheet in a thickness direction) as illustrated in FIG. 1 is easily formed. FIG. 1 is a schematic view of a stress profile obtained by measuring a stress of the tempered glass sheet from a surface in a depth direction, with a compressive stress being a positive number and a tensile stress being a negative number. FIG. 2 is an enlarged view of a low compressive stress region in the stress profile of FIG. 1. Specifically, the stress profile having the first peak “a”, the first bottom “b”, the second peak “c”, and the second bottom “d” can be formed. As a result, the breakage probability of a cover glass can be significantly reduced at the time of dropping of a smartphone.

In the present invention, the first peak, the first bottom, the second peak, and the second bottom are defined as described below. Herein, “a” at which the compressive stress becomes the maximum value on the surface is defined as the first peak, “b” at which the stress becomes the local minimum value after having been gradually reduced from the first peak in the depth direction is defined as the first bottom, “c” at which the compressive stress becomes the local maximum value after having been gradually increased from the first bottom in the depth direction is defined as the second peak, and “d” at which the tensile stress becomes the minimum value after having been gradually reduced from the second peak in the depth direction is defined as the second bottom.

In the first ion exchange step, a Li ion in the glass and a Na ion in the molten salt are ion exchanged with each other, and in the case of using the mixed molten salt of NaNO₃ and KNO₃, a Na ion in the glass and a K ion in the molten salt are further ion exchanged with each other. In this case, the ion exchange between a Li ion in the glass and a Na ion in the molten salt is faster and more efficient than the ion exchange between a Na ion in the glass and a K ion in the molten salt. In the second ion exchange step, a Na ion in the vicinity of the glass surface (a shallow region from the outermost surface to 20% of a sheet thickness) and a Li ion in the molten salt are ion exchanged with each other, and besides, a Na ion in the vicinity of the glass surface (the shallow region from the outermost surface to 20% of the sheet thickness) and a K ion in the molten salt are ion exchanged with each other. That is, in the second ion exchange step, while a Na ion in the vicinity of the glass surface is released, a K ion, which has a large ionic radius, can be introduced. As a result, the compressive stress value of the compressive stress layer on the outermost surface can be increased while a large depth of compression is maintained.

In the first ion exchange step, the temperature of the molten salt is preferably from 360° C. to 400° C., and the ion exchange time period is preferably from 30 minutes to 10 hours. In the second ion exchange step, the temperature of the ion exchange solution is preferably from 370° C. to 400° C., and the ion exchange time period is preferably from 15 minutes to 3 hours.

In order to form the non-monotonic stress profile, it is preferred that the concentration of NaNO₃ be higher than the concentration of KNO₃ in the mixed molten salt of NaNO₃ and KNO₃ to be used in the first ion exchange step, and that the concentration of KNO₃ be higher than the concentration of LiNO₃ in the mixed molten salt of KNO₃ and LiNO₃ to be used in the second ion exchange step.

In the mixed molten salt of NaNO₃ and KNO₃ to be used in the first ion exchange step, the concentration of KNO₃ is preferably 0 mass % or more, 0.5 mass % or more, 1 mass % or more, 5 mass % or more, 7 mass % or more, 10 mass % or more, or 15 mass % or more, particularly preferably from 20 mass % to 90 mass %. When the concentration of KNO₃ is too high, the compressive stress value obtained through ion exchange between a Li ion in the glass and a Na ion in the molten salt may be excessively reduced. In addition, when the concentration of KNO₃ is too low, measurement of a stress with a surface stress meter FSM-6000 may become difficult.

In the mixed molten salt of KNO₃ and LiNO₃ to be used in the second ion exchange step, the concentration of LiNO₃ is preferably from 0 mass % to 5 mass %, from 0.1 mass % to 3 mass %, or from 0.15 mass % to 2 mass %, particularly preferably from 0.2 mass % to 1.5 mass %. When the concentration of LiNO₃ is too low, it becomes difficult to release a Na ion in the vicinity of the glass surface. Meanwhile, when the concentration of LiNO₃ is too high, the compressive stress value obtained through ion exchange between a Na ion in the vicinity of the glass surface and a K ion in the molten salt may be excessively reduced.

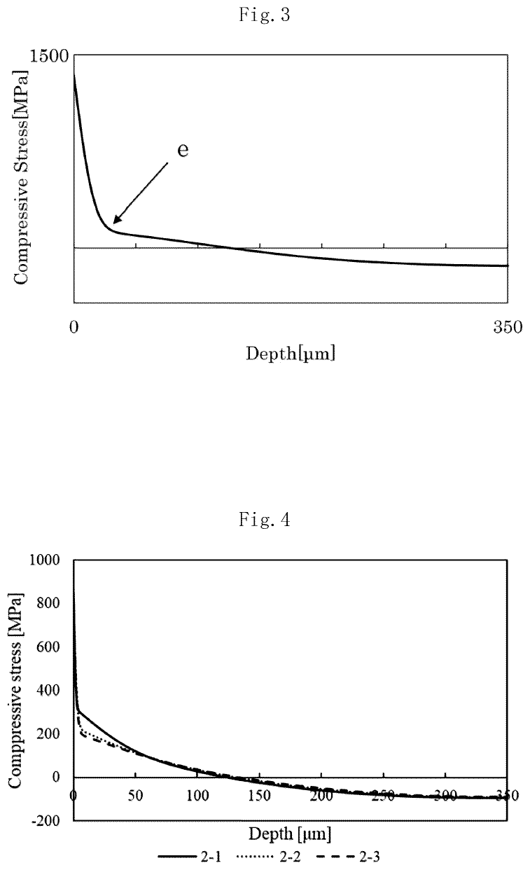

A molten salt of 100% KNO₃ free of LiNO₃ may be used as the molten salt to be used in the second ion exchange step. In this case, an inflected stress profile without the first bottom “b” and the second peak “c”, specifically, a stress profile having an inflection point “e” as illustrated in FIG. 3 is easily obtained.

In addition, in the method of manufacturing a tempered glass sheet of the present invention, ion exchange treatment in which the glass sheet to be tempered is immersed in the mixed molten salt of NaNO₃ and KNO₃ once, and the second ion exchange step is not performed may be used. When the above-mentioned ion exchange treatment is performed, the stress profile having an inflection point (“e” of FIG. 3) can be efficiently formed. When the stress profile having the inflection point “e” is formed, a glass having a high compressive stress on the surface and a large depth of compression is easily obtained. For example, when the stress profile can be approximated to a polyline formed of two straight lines, the inflection point “e” may be determined as a point on the stress profile at a depth corresponding to the intersection point between the two straight lines (inflection point of the polyline). For example, a well-known method such as a least squares method may be used for the approximation of a line.

The depth (De) of the inflection point “e” is preferably a shallow position closer to the surface. Specifically, the depth (De) of the inflection point “e” is preferably 30 μm or less, 25 μm or less, or 20 μm or less, particularly preferably 18 μm or less from the surface. Meanwhile, when the depth (De) of the inflection point “e” is too small, protrusions or sand grains on a road surface may be liable to reach the tensile stress layer at the time of dropping of a smartphone. Accordingly, the depth (De) of the inflection point “e” is preferably 3 μm or more, 4 μm or more, or 4.5 μm or more, particularly preferably 5 μm or more. In addition, the compressive stress at the inflection point is preferably 80 MPa or more, particularly preferably 100 MPa or more.

A suitable upper limit range of a Na ion (substantially, Na ion-Li ion) mutual diffusion coefficient D_{Na} at 380° C. is 1×10⁻¹¹ m² sec⁻¹ or less, 0.8×10⁻¹¹ m² sec⁻¹ or less, 0.5×10⁻¹¹ m² sec⁻¹ or less, or 1×10⁻¹² m² sec⁻¹ or less. When the mutual diffusion coefficient D_{Na} is too high, the diffusion of a Na ion is too fast, and the compressive stress value of the glass sheet in a relatively deep region in a thickness direction is liable to be reduced. Meanwhile, a suitable lower limit range of the Na ion mutual diffusion coefficient D_{Na} is 1×10⁻¹⁴ m² sec⁻¹ or more, 0.5×10⁻¹³ m² sec⁻¹ or more, 1×10⁻¹³ m² sec⁻¹ or more, 2×10⁻¹³ m² sec⁻¹ or more, 3×10⁻¹³ m² sec⁻¹ or more, or 5×10⁻¹³ m² sec⁻¹ or more, particularly 8×10⁻¹³ m² sec⁻¹ or more. When the Na ion mutual diffusion coefficient D_{Na} is too low, a Na ion hardly diffuses, and it becomes difficult to obtain a large depth of compression (DOC). In addition, mutual diffusion between a Na ion and a Li ion hardly occurs, and it becomes difficult to form the non-monotonic stress profile.

A suitable upper limit range of a K ion (substantially, K ion-Na ion) mutual diffusion coefficient D_{K} at 380° C. is 1×10⁻¹⁴ m² sec⁻¹ or less, 0.8×10⁻¹⁴ m² sec⁻¹ or less, 0.5×10⁻¹⁴ m² sec⁻¹ or less, 1×10⁻¹⁵ m² sec⁻¹ or less, 0.8×10⁻¹⁵ m² sec⁻¹ or less, 0.5×10⁻¹⁵ m² sec⁻¹ or less, or 0.3×10⁻¹⁵ m² sec⁻¹ or less, particularly 0.2×10⁻¹⁵ m² sec⁻¹ or less. When the K ion mutual diffusion coefficient D_{K} is too high, the diffusion of a K ion is too fast, and the compressive stress value of the glass sheet in a relatively shallow region in the thickness direction is liable to be reduced. Meanwhile, a suitable lower limit range of the K ion mutual diffusion coefficient D_{K} is 1×10⁻¹⁷ m² sec⁻¹ or more, 0.5×10⁻¹⁶ m² sec⁻¹ or more, 1×10⁻¹⁶ m² sec⁻¹ or more, 2×10⁻¹⁶ m² sec⁻¹ or more, 3×10⁻¹⁶ m² sec⁻¹ or more, 5×10⁻¹⁶ m² sec⁻¹ or more, or 7×10⁻¹⁶ m² sec⁻¹ or more, particularly 8×10⁻¹⁶ m² sec⁻¹ or more. When the K ion mutual diffusion coefficient D_{K} is too low, a K ion hardly diffuses, and the depth of layer (DOL_{K}) of the compressive stress layer obtained through ion exchange with a K ion may be reduced.

A suitable lower limit range of a mutual diffusion coefficient ratio D_{K}/D_{Na} at 380° C. is 0.0001 or more, 0.0003 or more, 0.0005 or more, 0.0008 or more, 0.0010 or more, 0.0012 or more, 0.0013 or more, 0.0014 or more, 0.0015 or more, 0.0016 or more, or 0.0017 or more, particularly 0.0018 or more. When the ratio D_{K}/D_{Na} is too low, the diffusion speed of a K ion is too slow with respect to the diffusion speed of a Na ion, and hence the Na ion excessively diffuses in the deep region, with the result that the compressive stress value (CS30Na) at a depth of 30 μm may be reduced. The upper limit of the ratio D_{K}/D_{Na} is 0.0100 or less, 0.0080 or less, 0.0050 or less, 0.0040 or less, or 0.0030 or less. When the ratio D_{K}/D_{Na} is too low, it becomes difficult to form the non-monotonic stress profile.

The Na ion mutual diffusion coefficient D_{Na} at 380° C. may be calculated by using the following equation of [Math. 1] based on a Na ion concentration profile (concentration distribution) in the thickness direction of the tempered glass sheet having been subjected to ion exchange with a molten salt of NaNO₃ (100%) at 380° C. In the equation of [Math. 1], the diffusion coefficient is defined assuming that an alkali metal ion to be ion exchanged diffuses in the glass according to a complementary error function, which is an analytical solution of a diffusion equation. The Na ion concentration profile may be obtained by using EPMA measurement of a cross section of the tempered glass sheet. In the equation of [Math. 1], “x” represents a depth from the surface, C(x) represents a concentration at a depth of “x”, Cₘᵢₙ represents a minimum concentration, Cₘₐₓ represents a maximum concentration, “t” represents a diffusion time period, and D represents the mutual diffusion coefficient. The mutual diffusion coefficient D may be determined as a solution by substituting the results of the EPMA measurement into the equation of [Math. 1], and performing an operation assuming that the results of the measurement fit to the complementary error function. The diffusion time period “t” substantially coincides with the ion exchange time period.

$$[ Math . 1 ]$$

$$\frac{C ( x ) - {C}_{min}}{{C}_{max} - {C}_{min}} = erfc ( \frac{x}{\sqrt{4 \tilde{D} t}} )$$

The K ion mutual diffusion coefficient D_{K} at 380° C. may be calculated by using the above-mentioned equation of [Math. 1] based on a K ion concentration profile (concentration distribution) in the thickness direction of the tempered glass sheet having been subjected to ion exchange with a molten salt of KNO₃ (100%) at 380° C. The K ion concentration profile may be obtained by using EPMA measurement of a cross section of the tempered glass sheet.

The Na ion mutual diffusion coefficient D_{Na} and K ion mutual diffusion coefficient D_{K} at 380° may each be calculated based on the ion concentration profile and the equation of [Math. 1] as described above, but may be obtained as follows: the tempered glass sheet having been subjected to ion exchange is subjected to heat treatment (annealing) at 380° C., and the diffusion coefficient is calculated from a difference in concentration before and after the heat treatment. A heat treatment time period is not particularly limited, but is 1 minute or more, 5 minutes or more, 10 minutes or more, or 20 minutes or more, particularly from 30 minutes to 120 minutes.

When two-step ion a exchange is performed, compressive stress value (CS30_{2nd}) at a depth of 30 μm after second ion exchange is lower than a compressive stress value (CS30₁ₛₜ) at a depth of 30 μm after first ion exchange in some cases. A compressive stress drop rate (CS30Droprate) at a depth of 30 μm before and after the second ion exchange in such cases is represented by the following equation of [Math. 2]. A suitable upper limit range of the CS30Droprate is 1.00 or less, 0.70 or less, 0.50 or less, 0.45 or less, 0.40 or less, 0.35 or less, 0.32 or less, 0.30 or less, 0.28 or less, or 0.25 or less, particularly 0.20 or less. When the CS30Droprate is low, the CS30_{2nd} is increased, and the strength of the tempered glass sheet is easily increased. Meanwhile, the lower limit thereof is not particularly limited, but is 0.05 or more or 0.10 or more, particularly 0.15 or more.

$$[ Math . 2 ]$$

$$CS {30}_{Drop rate} = \frac{CS {30}_{2 nd} - CS {30}_{1 st}}{CS {30}_{1 st}}$$

### EXAMPLES

The present invention is described below by way of Examples. The following Examples are merely illustrative. The present invention is by no means limited to the following Examples.

### EXAMPLE 1

The glass compositions and glass characteristics of Examples of the present invention (Samples Nos. 001 to 102 and Nos. 104 to 285) and Comparative Example (Sample No. 103) are shown in Tables 1 to 30. In each of the tables, the term “N.A.” means not applicable, and the term “R₂O/Al₂O₃” means the molar ratio ([Li₂O]+[Na₂O]+[K₂O])/[Al₂O₃].

TABLE 1

| | No. | No. | No. | No. | No. | No. | No. | No. | No. | No. |
|---|---|---|---|---|---|---|---|---|---|---|
| Component (mol %) | 001 | 002 | 003 | 004 | 005 | 006 | 007 | 008 | 009 | 010 |
| SiO₂ | 69.867 | 69.863 | 69.862 | 69.866 | 69.859 | 69.854 | 69.962 | 65.864 | 65.862 | 65.865 |
| Al₂O₃ | 10.0 | 10.0 | 10.0 | 10.0 | 10.0 | 10.0 | 10.0 | 12.0 | 12.0 | 12.0 |
| B₂O₃ | 10.0 | 0.0 | 0.0 | 5.0 | 0.0 | 5.0 | 3.3 | 10.0 | 0.0 | 5.0 |
| Li₂O | 8.0 | 8.0 | 8.0 | 8.0 | 8.0 | 8.0 | 8.0 | 9.6 | 9.6 | 9.6 |
| Na₂O | 2.0 | 2.0 | 2.0 | 2.0 | 2.0 | 2.0 | 2.0 | 2.4 | 2.4 | 2.4 |
| K₂O | 0.0 | 0.0 | 0.0 | 0.0 | 0.0 | 0.0 | 0.0 | 0.0 | 0.0 | 0.0 |
| MgO | 0.0 | 10.0 | 0.0 | 5.0 | 5.0 | 0.0 | 3.3 | 0.0 | 0.0 | 5.0 |
| CaO | 0.0 | 0.0 | 10.0 | 0.0 | 5.0 | 5.0 | 3.3 | 0.0 | 10.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.001 | 0.002 | 0.001 | 0.002 | 0.001 | 0.001 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.001 | 0.003 | 0.003 | 0.001 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.001 | 0.001 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.001 | 0.002 | 0.004 | 0.001 | 0.007 | 0.012 | 0.004 | 0.002 | 0.004 | 0.001 |
| B₂O₃ + MgO + CaO | 10.0 | 10.0 | 10.0 | 10.0 | 10.0 | 10.0 | 9.9 | 10.0 | 10.0 | 10.0 |
| Al₂O₃ + Li₂O + Na₂O + K₂O | 20.0 | 20.0 | 20.0 | 20.0 | 20.0 | 20.0 | 20.0 | 24.0 | 24.0 | 24.0 |
| R₂O/Al₂O₃ | 1.00 | 1.00 | 1.00 | 1.00 | 1.00 | 1.00 | 1.00 | 1.00 | 1.00 | 1.00 |
| Al₂O₃/(R₂O + RO) | 1.00 | 0.50 | 0.50 | 0.67 | 0.50 | 0.67 | 0.60 | 1.00 | 0.55 | 0.71 |
| Na₂O/Li₂O | 0.25 | 0.25 | 0.25 | 0.25 | 0.25 | 0.25 | 0.25 | 0.25 | 0.25 | 0.25 |
| Li₂O/Al₂O₃ | 0.80 | 0.80 | 0.80 | 0.80 | 0.80 | 0.80 | 0.80 | 0.80 | 0.80 | 0.80 |
| Q | 10.87 | 20.86 | 20.86 | 15.87 | 20.86 | 15.85 | 17.66 | −2.94 | 7.06 | 2.07 |
| X | 473 | 503 | 533 | 488 | 518 | 503 | 503 | 601 | 661 | 616 |
| Y | 13 | 7 | 2 | 10 | 5 | 8 | 8 | 12 | 1 | 9 |
| Z | 59 | 39 | 37 | 49 | 38 | 48 | 46 | 69 | 47 | 59 |
| W | 415 | 474 | 355 | 444 | 414 | 385 | 415 | 506 | 446 | 535 |
| U | 8,331 | 8,533 | 8,532 | 8,432 | 8,532 | 8,431 | 8,463 | 8,239 | 8,441 | 8,340 |
| ρ (g/cm³) | 2.280 | 2.419 | 2.472 | 2.354 | 2.445 | 2.393 | 2.397 | 2.304 | 2.493 | 2.378 |
| Ts (° C.) | 807 | N.A. | 792 | 816 | N.A. | 795 | 764 | 805 | 775 | 795 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,610 | 1,524 | 1,470 | 1,569 | 1,501 | 1,538 | 1,529 | 1,550 | 1,414 | 1,491 |
| E (GPa) | 67 | 84 | 85 | 77 | N.A. | N.A. | N.A. | 70 | N.A. | 79 |
| CS_{K} (MPa) | 503 | 915 | N.A. | 703 | N.A. | N.A. | 868 | 596 | N.A. | N.A. |
| DOL_{K} (μm) | 12 | 6 | N.A. | 8 | N.A. | N.A. | 5 | 12 | N.A. | N.A. |
| CS_{Na} (MPa) | 391 | 390 | 243 | 371 | 349 | 305 | 338 | 495 | 307 | 358 |
| CS30_{Na} (MPa) | 116 | 120 | 46 | 106 | 74 | 65 | 91 | 163 | 58 | 83 |
| DOC_{Na} (μm) | 57 | 58 | 47 | 56 | 49 | 49 | 55 | 61 | 47 | 51 |
| CTcv_{Na} (MPa) | 30 | 34 | 19 | 31 | 26 | 22 | 26 | 40 | 22 | 27 |
| DOC_{Na}/DOL_{K} | 4.8 | 9.6 | N.A. | 7.0 | N.A. | N.A. | 10.9 | 5.1 | N.A. | N.A. |
| Acid resistance | 0.04 | 0.03 | 0.03 | 0.06 | N.A. | N.A. | N.A. | 0.32 | 0.01 | 0.05 |
| 5 wt % HCl 80° C. 24 h | | | | | | | | | | |
| (mg/cm²) | | | | | | | | | | |
| Alkali resistance | 1.20 | 0.30 | 0.30 | 0.70 | N.A. | N.A. | N.A. | 1.30 | 0.20 | 1.60 |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 2

| | No. | No. | No. | No. | No. | No. | No. | No. | No. | No. |
|---|---|---|---|---|---|---|---|---|---|---|
| Component (mol %) | 011 | 012 | 013 | 014 | 015 | 016 | 017 | 018 | 019 | 020 |
| SiO₂ | 65.866 | 65.866 | 65.966 | 73.864 | 73.864 | 73.856 | 73.866 | 73.866 | 73.859 | 73.955 |
| Al₂O₃ | 12.0 | 12.0 | 12.0 | 8.0 | 8.0 | 8.0 | 8.0 | 8.0 | 8.0 | 8.0 |
| B₂O₃ | 0.0 | 5.0 | 3.3 | 10.0 | 0.0 | 0.0 | 5.0 | 0.0 | 5.0 | 3.3 |
| Li₂O | 9.6 | 9.6 | 9.6 | 6.4 | 6.4 | 6.4 | 6.4 | 6.4 | 6.4 | 6.4 |
| Na₂O | 2.4 | 2.4 | 2.4 | 1.6 | 1.6 | 1.6 | 1.6 | 1.6 | 1.6 | 1.6 |
| K₂O | 0.0 | 0.0 | 0.0 | 0.0 | 0.0 | 0.0 | 0.0 | 0.0 | 0.0 | 0.0 |
| MgO | 5.0 | 0.0 | 3.3 | 0.0 | 10.0 | 0.0 | 5.0 | 5.0 | 0.0 | 3.3 |
| CaO | 5.0 | 5.0 | 3.3 | 0.0 | 0.0 | 10.0 | 0.0 | 5.0 | 5.0 | 3.3 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.000 | 0.000 | 0.000 | 0.002 | 0.002 | 0.010 | 0.000 | 0.000 | 0.007 | 0.011 |
| B₂O₃ + MgO + CaO | 10.0 | 10.0 | 9.9 | 10.0 | 10.0 | 10.0 | 10.0 | 10.0 | 10.0 | 9.9 |
| Al₂O₃ + Li₂O + Na₂O + K₂O | 24.0 | 24.0 | 24.0 | 16.0 | 16.0 | 16.0 | 16.0 | 16.0 | 16.0 | 16.0 |
| R₂O/Al₂O₃ | 1.00 | 1.00 | 1.00 | 1.00 | 1.00 | 1.00 | 1.00 | 1.00 | 1.00 | 1.00 |
| Al₂O₃/(R₂O + RO) | 0.55 | 0.71 | 0.65 | 1.00 | 0.44 | 0.44 | 0.62 | 0.44 | 0.62 | 0.55 |
| Na₂O/Li₂O | 0.25 | 0.25 | 0.25 | 0.25 | 0.25 | 0.25 | 0.25 | 0.25 | 0.25 | 0.25 |
| Li₂O/Al₂O₃ | 0.80 | 0.80 | 0.80 | 0.80 | 0.80 | 0.80 | 0.80 | 0.80 | 0.80 | 0.80 |
| Q | 7.07 | 2.07 | 3.87 | 24.66 | 34.66 | 34.66 | 29.67 | 34.67 | 29.66 | 31.46 |
| X | 646 | 631 | 631 | 345 | 375 | 405 | 360 | 390 | 375 | 375 |
| Y | 3 | 7 | 7 | 14 | 8 | 3 | 11 | 6 | 9 | 9 |
| Z | 48 | 58 | 55 | 50 | 30 | 28 | 40 | 29 | 39 | 36 |
| W | 505 | 476 | 506 | 325 | 383 | 265 | 354 | 324 | 295 | 325 |
| U | 8,441 | 8,340 | 8,372 | 8,423 | 8,624 | 8,624 | 8,524 | 8,624 | 8,523 | 8,554 |
| ρ (g/cm³) | 2.469 | 2.414 | 2.420 | 2.256 | 2.390 | 2.446 | 2.328 | 2.420 | 2.369 | 2.373 |
| Ts (° C.) | N.A. | 756 | N.A. | 821 | N.A. | 817 | 837 | N.A. | N.A. | N.A. |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,440 | 1,470 | 1,468 | 1,670 | 1,604 | 1,528 | 1,626 | 1,572 | 1,584 | 1,602 |
| E (GPa) | N.A. | N.A. | N.A. | N.A. | N.A. | N.A. | N.A. | N.A. | N.A. | N.A. |
| CS_{K} (MPa) | 986 | N.A. | N.A. | 412 | 712 | N.A. | 573 | N.A. | 682 | 664 |
| DOL_{K} (μm) | 7 | N.A. | N.A. | 12 | 7 | N.A. | 9 | N.A. | 5 | 6 |
| CS_{Na} (MPa) | 554 | 417 | 459 | 275 | 276 | 202 | 262 | 261 | 226 | 261 |
| CS30_{Na} (MPa) | 167 | 92 | 107 | 87 | 96 | 41 | 86 | 64 | 54 | 70 |
| DOC_{Na} (μm) | 58 | 51 | 52 | 60 | 62 | 48 | 60 | 52 | 52 | 54 |
| CTcv_{Na} (MPa) | 44 | 27 | 32 | 20 | 27 | 15 | 23 | 20 | 17 | 21 |
| DOC_{Na}/DOL_{K} | 8.0 | N.A. | N.A. | 5.0 | 9.4 | N.A. | 6.7 | N.A. | 9.8 | 9.5 |
| Acid resistance | N.A. | N.A. | N.A. | 0.03 | 0.00 | 0.00 | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | 1.20 | 0.20 | 0.30 | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 3

| | No. | No. | No. | No. | No. | No. | No. | No. | No. | No. |
|---|---|---|---|---|---|---|---|---|---|---|
| Component (mol %) | 021 | 022 | 023 | 024 | 025 | 026 | 027 | 028 | 029 | 030 |
| SiO₂ | 73.866 | 73.866 | 73.855 | 73.854 | 73.854 | 73.863 | 73.862 | 69.863 | 69.865 | 69.865 |
| Al₂O₃ | 10.0 | 10.0 | 10.0 | 10.0 | 10.0 | 10.0 | 10.0 | 10.0 | 10.0 | 9.0 |
| B₂O₃ | 6.0 | 0.0 | 0.0 | 3.0 | 0.0 | 3.0 | 2.0 | 10.0 | 0.0 | 10.0 |
| Li₂O | 8.0 | 8.0 | 8.0 | 8.0 | 8.0 | 8.0 | 8.0 | 7.0 | 7.0 | 8.0 |
| Na₂O | 2.0 | 2.0 | 2.0 | 2.0 | 2.0 | 2.0 | 2.0 | 3.0 | 3.0 | 3.0 |
| K₂O | 0.0 | 0.0 | 0.0 | 0.0 | 0.0 | 0.0 | 0.0 | 0.0 | 0.0 | 0.0 |
| MgO | 0.0 | 6.0 | 0.0 | 3.0 | 3.0 | 0.0 | 2.0 | 0.0 | 10.0 | 0.0 |
| CaO | 0.0 | 0.0 | 6.0 | 0.0 | 3.0 | 3.0 | 2.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.000 | 0.000 | 0.011 | 0.012 | 0.012 | 0.003 | 0.004 | 0.003 | 0.001 | 0.001 |
| B₂O₃ + MgO + CaO | 6.0 | 6.0 | 6.0 | 6.0 | 6.0 | 6.0 | 6.0 | 10.0 | 10.0 | 10.0 |
| Al₂O₃ + Li₂O + Na₂O + K₂O | 20.0 | 20.0 | 20.0 | 20.0 | 20.0 | 20.0 | 20.0 | 20.0 | 20.0 | 20.0 |
| R₂O/Al₂O₃ | 1.00 | 1.00 | 1.00 | 1.00 | 1.00 | 1.00 | 1.00 | 1.00 | 1.00 | 1.22 |
| Al₂O₃/(R₂O + RO) | 1.00 | 0.63 | 0.63 | 0.77 | 0.63 | 0.77 | 0.71 | 1.00 | 0.50 | 0.82 |
| Na₂O/Li₂O | 0.25 | 0.25 | 0.25 | 0.25 | 0.25 | 0.25 | 0.25 | 0.43 | 0.43 | 0.38 |
| Li₂O/Al₂O₃ | 0.80 | 0.80 | 0.80 | 0.80 | 0.80 | 0.80 | 0.80 | 0.70 | 0.70 | 0.89 |
| Q | 18.87 | 24.87 | 24.86 | 21.85 | 24.85 | 21.86 | 22.86 | 11.36 | 21.37 | 12.37 |
| X | 480 | 498 | 516 | 489 | 507 | 498 | 498 | 400 | 430 | 422 |
| Y | 16 | 12 | 9 | 14 | 10 | 12 | 12 | 14 | 8 | 14 |
| Z | 61 | 49 | 47 | 55 | 48 | 54 | 52 | 49 | 29 | 52 |
| W | 433 | 468 | 397 | 451 | 433 | 415 | 433 | 345 | 403 | 368 |
| U | 8,306 | 8,427 | 8,426 | 8,366 | 8,426 | 8,367 | 8,387 | 8.306 | 8,508 | 8,080 |
| ρ (g/cm³) | 2.299 | 2.377 | 2.414 | 2.341 | 2.397 | 2.366 | 2.368 | 2.282 | 2.420 | 2.296 |
| Ts (° C.) | 861 | N.A. | N.A. | 869 | N.A. | N.A. | N.A. | 819 | N.A. | 745 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,677 | 1,633 | 1,593 | 1,641 | 1,623 | 1,623 | 1,630 | 1,616 | 1,541 | 1,623 |
| E (GPa) | 71 | 81 | N.A. | 77 | N.A. | N.A. | N.A. | 67 | 84 | 70 |
| CS_{K} (MPa) | 638 | 867 | 854 | 779 | 884 | 733 | 790 | 553 | 1,026 | 552 |
| DOL_{K} (μm) | 15 | 9 | 5 | 11 | 7 | 8 | 8 | 12 | 6 | 10 |
| CS_{Na} (MPa) | N.A. | 359 | 342 | N.A. | 396 | 344 | 389 | 312 | 312 | 241 |
| CS30_{Na} (MPa) | N.A. | 165 | 101 | N.A. | 132 | 120 | 132 | 121 | 108 | 102 |
| DOC_{Na} (μm) | N.A. | 75 | 57 | N.A. | 61 | 62 | 61 | 67 | 60 | 70 |
| CTcv_{Na} (MPa) | N.A. | 44 | 27 | N.A. | 36 | 31 | 34 | 28 | 34 | 27 |
| DOC_{Na}/DOL_{K} | N.A. | 8.0 | 10.9 | N.A. | 8.6 | 8.3 | 7.3 | 5.6 | 9.4 | 7.1 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 4

| | No. | No. | No. | No. | No. | No. | No. | No. | No. | No. |
|---|---|---|---|---|---|---|---|---|---|---|
| Component (mol %) | 031 | 032 | 033 | 034 | 035 | 036 | 037 | 038 | 039 | 040 |
| SiO₂ | 69.865 | 69.863 | 69.865 | 69.865 | 69.865 | 69.866 | 69.866 | 69.865 | 69.864 | 73.854 |
| Al₂O₃ | 9.0 | 11.0 | 11.0 | 9.0 | 9.0 | 10.0 | 9.0 | 11.0 | 9.0 | 10.0 |
| B₂O₃ | 0.0 | 10.0 | 0.0 | 10.0 | 0.0 | 5.0 | 5.0 | 5.0 | 5.0 | 6.0 |
| Li₂O | 8.0 | 7.0 | 7.0 | 9.0 | 9.0 | 7.0 | 8.0 | 7.0 | 9.0 | 7.0 |
| Na₂O | 3.0 | 2.0 | 2.0 | 2.0 | 2.0 | 3.0 | 3.0 | 2.0 | 2.0 | 3.0 |
| K₂O | 0.0 | 0.0 | 0.0 | 0.0 | 0.0 | 0.0 | 0.0 | 0.0 | 0.0 | 0.0 |
| MgO | 10.0 | 0.0 | 10.0 | 0.0 | 10.0 | 5.0 | 5.0 | 5.0 | 5.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.001 | 0.003 | 0.001 | 0.001 | 0.001 | 0.000 | 0.000 | 0.001 | 0.002 | 0.012 |
| B₂O₃ + MgO + CaO | 10.0 | 10.0 | 10.0 | 10.0 | 10.0 | 10.0 | 10.0 | 10.0 | 10.0 | 6.0 |
| Al₂O₃ + Li₂O + Na₂O + K₂O | 20.0 | 20.0 | 20.0 | 20.0 | 20.0 | 20.0 | 20.0 | 20.0 | 20.0 | 20.0 |
| R₂O/Al₂O₃ | 1.22 | 0.82 | 0.82 | 1.22 | 1.22 | 1.00 | 1.22 | 0.82 | 1.22 | 1.00 |
| Al₂O₃/(R₂O + RO) | 0.43 | 1.22 | 0.58 | 0.82 | 0.43 | 0.67 | 0.56 | 0.79 | 0.56 | 1.00 |
| Na₂O/Li₂O | 0.38 | 0.29 | 0.29 | 0.22 | 0.22 | 0.43 | 0.38 | 0.29 | 0.22 | 0.43 |
| Li₂O/Al₂O₃ | 0.89 | 0.64 | 0.64 | 1.00 | 1.00 | 0.70 | 0.89 | 0.64 | 1.00 | 0.70 |
| Q | 22.37 | 9.86 | 19.87 | 11.87 | 21.87 | 16.37 | 17.37 | 14.87 | 16.86 | 19.35 |
| X | 451 | 452 | 481 | 495 | 524 | 415 | 437 | 466 | 510 | 407 |
| Y | 7 | 14 | 8 | 13 | 6 | 11 | 10 | 11 | 9 | 17 |
| Z | 32 | 57 | 37 | 62 | 42 | 39 | 42 | 47 | 52 | 50 |
| W | 426 | 392 | 450 | 438 | 497 | 374 | 397 | 421 | 468 | 362 |
| U | 8,281 | 8,557 | 8,759 | 8,105 | 8,306 | 8,407 | 8,181 | 8,658 | 8,206 | 8,280 |
| ρ (g/cm³) | 2.419 | 2.283 | 2.421 | 2.293 | 2.415 | 2.356 | 2.359 | 2.351 | 2.356 | 2.295 |
| Ts (° C.) | N.A. | 856 | N.A. | 742 | N.A. | 817 | 773 | 857 | N.A. | 869 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,511 | 1,608 | 1,546 | 1,595 | 1,500 | 1,563 | 1,533 | 1,589 | 1,530 | 1,680 |
| E (GPa) | 84 | 68 | 86 | 70 | 85 | 77 | 78 | 77 | 78 | 70 |
| CS_{K} (MPa) | 952 | 565 | N.A. | 543 | 964 | 773 | 756 | 759 | 721 | 637 |
| DOL_{K} (μm) | 6 | 10 | N.A. | 9 | 5 | 9 | 8 | 8 | 7 | 16 |
| CS_{Na} (MPa) | 368 | 312 | 336 | 339 | 387 | 310 | 298 | 330 | 379 | 288 |
| CS30_{Na} (MPa) | 115 | 113 | 107 | 117 | 149 | 112 | 97 | 115 | 115 | 151 |
| DOC_{Na} (μm) | 58 | 64 | 59 | 62 | 67 | 63 | 59 | 62 | 58 | 84 |
| CTcv_{Na} (MPa) | 33 | 27 | 31 | 29 | 35 | 30 | 29 | 29 | 30 | 42 |
| DOC_{Na}/DOL_{K} | 9.2 | 6.4 | N.A. | 7.0 | 12.6 | 7.1 | 7.6 | 8.0 | 8.4 | 5.2 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | 0.86 | 0.87 | N.A. | N.A. | N.A. | N.A. | 0.92 | 0.75 | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 5

| | No. | No. | No. | No. | No. | No. | No. | No. | No. | No. |
|---|---|---|---|---|---|---|---|---|---|---|
| Component (mol %) | 041 | 042 | 043 | 044 | 045 | 046 | 047 | 048 | 049 | 050 |
| SiO₂ | 73.858 | 73.866 | 73.858 | 73.862 | 73.862 | 73.855 | 73.858 | 65.865 | 65.864 | 65.865 |
| Al₂O₃ | 9.0 | 11.0 | 9.0 | 10.0 | 9.0 | 11.0 | 9.0 | 12.0 | 10.8 | 13.2 |
| B₂O₃ | 6.0 | 6.0 | 6.0 | 3.0 | 3.0 | 3.0 | 3.0 | 10.0 | 10.0 | 10.0 |
| Li₂O | 8.0 | 7.0 | 9.0 | 7.0 | 8.0 | 7.0 | 9.0 | 8.4 | 9.6 | 8.4 |
| Na₂O | 3.0 | 2.0 | 2.0 | 3.0 | 3.0 | 2.0 | 2.0 | 3.6 | 3.6 | 2.4 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 3.0 | 3.0 | 3.0 | 3.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.008 | 0.000 | 0.008 | 0.004 | 0.004 | 0.011 | 0.008 | 0.001 | 0.002 | 0.001 |
| B₂O₃ + MgO + CaO | 6.0 | 6.0 | 6.0 | 6.0 | 6.0 | 6.0 | 6.0 | 10.0 | 10.0 | 10.0 |
| Al₂O₃ + Li₂O + Na₂O + K₂O | 20.0 | 20.0 | 20.0 | 20.0 | 20.0 | 20.0 | 20.0 | 24.0 | 24.0 | 24.0 |
| R₂O/Al₂O₃ | 1.22 | 0.82 | 1.22 | 1.00 | 1.22 | 0.82 | 1.22 | 1.00 | 1.22 | 0.82 |
| Al₂O₃/(R₂O + RO) | 0.82 | 1.22 | 0.82 | 0.77 | 0.64 | 0.92 | 0.64 | 1.00 | 0.82 | 1.22 |
| Na₂O/Li₂O | 0.38 | 0.29 | 0.22 | 0.43 | 0.38 | 0.29 | 0.22 | 0.43 | 0.38 | 0.29 |
| Li₂O/Al₂O₃ | 0.89 | 0.64 | 1.00 | 0.70 | 0.89 | 0.64 | 1.00 | 0.70 | 0.89 | 0.64 |
| Q | 20.36 | 17.87 | 19.86 | 22.36 | 23.36 | 20.86 | 22.86 | −2.33 | −1.14 | −4.14 |
| X | 429 | 459 | 502 | 416 | 438 | 468 | 511 | 514 | 540 | 575 |
| Y | 16 | 16 | 15 | 15 | 14 | 14 | 13 | 14 | 13 | 13 |
| Z | 53 | 58 | 63 | 44 | 47 | 52 | 57 | 57 | 60 | 66 |
| W | 386 | 410 | 456 | 380 | 403 | 427 | 474 | 421 | 449 | 478 |
| U | 8,054 | 8,533 | 8,079 | 8,342 | 8,115 | 8,592 | 8,140 | 8,210 | 7,938 | 8,511 |
| ρ (g/cm³) | 2.319 | 2.288 | 2.313 | 2.343 | 2.348 | 2.337 | 2.344 | 2.307 | 2.319 | 2.310 |
| Ts (° C.) | 772 | 927 | 775 | 878 | N.A. | 923 | N.A. | 811 | 741 | 840 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,655 | 1,682 | 1,637 | 1,659 | 1,623 | 1,673 | 1,617 | 1,569 | 1,548 | 1,554 |
| E (GPa) | 74 | 71 | 74 | 76 | 77 | 77 | 77 | 69 | 72 | 70 |
| CS_{K} (MPa) | 597 | 645 | 573 | 778 | 719 | 794 | 711 | 676 | 639 | 693 |
| DOL_{K} (μm) | 11 | 14 | 10 | 12 | 12 | 11 | 9 | 12 | 10 | 9 |
| CS_{Na} (MPa) | 308 | 306 | 366 | 300 | 316 | 255 | 349 | 375 | 362 | 384 |
| CS30_{Na} (MPa) | 138 | 151 | 152 | 141 | 138 | 121 | 146 | 171 | 147 | 150 |
| DOC_{Na} (μm) | 75 | 80 | 71 | 75 | 72 | 75 | 69 | 75 | 68 | 68 |
| CTcv_{Na} (MPa) | 32 | 39 | 35 | 39 | 35 | 38 | 39 | 42 | 38 | 33 |
| DOC_{Na}/DOL_{K} | 6.8 | 5.7 | 7.2 | 6.1 | 6.1 | 6.7 | 7.7 | 6.1 | 6.8 | 7.3 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 6

| | No. | No. | No. | No. | No. | No. | No. | No. | No. | No. |
|---|---|---|---|---|---|---|---|---|---|---|
| Component (mol %) | 051 | 052 | 053 | 054 | 055 | 056 | 057 | 058 | 059 | 060 |
| SiO₂ | 65.865 | 65.865 | 65.863 | 65.864 | 65.863 | 69.864 | 69.863 | 69.864 | 69.864 | 69.864 |
| Al₂O₃ | 10.8 | 12.0 | 10.8 | 13.2 | 10.8 | 10.0 | 10.0 | 10.5 | 10.0 | 11.0 |
| B₂O₃ | 10.0 | 5.0 | 5.0 | 5.0 | 5.0 | 7.5 | 7.5 | 7.5 | 7.5 | 7.5 |
| Li₂O | 10.8 | 8.4 | 9.6 | 8.4 | 10.8 | 8.0 | 8.5 | 8.0 | 7.0 | 7.0 |
| Na₂O | 2.4 | 3.6 | 3.6 | 2.4 | 2.4 | 2.0 | 1.5 | 1.5 | 3.0 | 2.0 |
| K₂O | 0.0 | 0.0 | 0.0 | 0.0 | 0.0 | 0.0 | 0.0 | 0.0 | 0.0 | 0.0 |
| MgO | 0.0 | 5.0 | 5.0 | 5.0 | 5.0 | 2.5 | 2.5 | 2.5 | 2.5 | 2.5 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.001 | 0.001 | 0.003 | 0.002 | 0.003 | 0.002 | 0.003 | 0.002 | 0.002 | 0.002 |
| B₂O₃ + MgO + CaO | 10.0 | 10.0 | 10.0 | 10.0 | 10.0 | 10.0 | 10.0 | 10.0 | 10.0 | 10.0 |
| Al₂O₃ + Li₂O + Na₂O + K₂O | 24.0 | 24.0 | 24.0 | 24.0 | 24.0 | 20.0 | 20.0 | 20.0 | 20.0 | 20.0 |
| R₂O/Al₂O₃ | 1.22 | 1.00 | 1.22 | 0.82 | 1.22 | 1.00 | 1.00 | 0.90 | 1.00 | 0.82 |
| Al₂O₃/(R₂O + RO) | 0.82 | 0.71 | 0.59 | 0.84 | 0.59 | 0.80 | 0.80 | 0.88 | 0.80 | 0.96 |
| Na₂O/Li₂O | 0.22 | 0.43 | 0.38 | 0.29 | 0.22 | 0.25 | 0.18 | 0.19 | 0.43 | 0.29 |
| Li₂O/Al₂O₃ | 1.00 | 0.70 | 0.89 | 0.64 | 1.00 | 0.80 | 0.85 | 0.76 | 0.70 | 0.64 |
| Q | −1.74 | 2.67 | 3.86 | 0.86 | 3.26 | 13.36 | 13.11 | 12.61 | 13.86 | 12.36 |
| X | 627 | 528 | 554 | 590 | 642 | 481 | 517 | 506 | 408 | 459 |
| Y | 11 | 10 | 9 | 10 | 8 | 12 | 11 | 12 | 13 | 13 |
| Z | 72 | 47 | 50 | 56 | 62 | 54 | 60 | 58 | 44 | 52 |
| W | 534 | 450 | 478 | 507 | 563 | 430 | 465 | 454 | 359 | 407 |
| U | 7,968 | 8,310 | 8,039 | 8,612 | 8,069 | 8,381 | 8,394 | 8,507 | 8,357 | 8,608 |
| ρ (g/cm³) | 2.315 | 2.380 | 2.384 | 2.377 | 2.380 | 2.317 | 2.316 | 2.314 | 2.321 | 2.316 |
| Ts (° C.) | 744 | 802 | N.A. | 843 | 746 | 811 | 810 | 837 | 812 | 856 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,533 | 1,508 | 1,481 | 1,515 | 1,473 | 1,587 | 1,584 | 1,591 | 1,600 | 1,599 |
| E (GPa) | 72 | 79 | 79 | 79 | 80 | 73 | 73 | 72 | 72 | 72 |
| CS_{K} (MPa) | 627 | 964 | 867 | 952 | 850 | 692 | 674 | 689 | 665 | 673 |
| DOL_{K} (μm) | 9 | 8 | 7 | 7 | 6 | 9 | 8 | 9 | 10 | 10 |
| CS_{Na} (MPa) | 420 | 419 | 405 | 449 | 501 | 375 | 402 | 390 | 309 | 323 |
| CS30_{Na} (MPa) | 133 | 153 | 137 | 136 | 143 | 124 | 124 | 128 | 115 | 122 |
| DOC_{Na} (μm) | 59 | 64 | 61 | 58 | 56 | 61 | 59 | 61 | 65 | 66 |
| CTcv_{Na} (MPa) | 37 | 37 | 36 | 36 | 40 | 31 | 30 | 32 | 28 | 29 |
| DOC_{Na}/DOL_{K} | 6.6 | 8.1 | 8.7 | 8.7 | 9.0 | 6.7 | 7.0 | 6.9 | 6.5 | 6.9 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | 0.85 | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 7

| | No. | No. | No. | No. | No. | No. | No. | No. | No. | No. |
|---|---|---|---|---|---|---|---|---|---|---|
| Component (mol %) | 061 | 062 | 063 | 064 | 065 | 066 | 067 | 068 | 069 | 070 |
| SiO₂ | 71.864 | 71.864 | 71.863 | 71.864 | 71.864 | 69.864 | 69.864 | 67.864 | 67.966 | 67.865 |
| Al₂O₃ | 10.0 | 10.0 | 10.5 | 10.0 | 11.0 | 10.0 | 10.5 | 11.0 | 11.0 | 11.0 |
| B₂O₃ | 8.0 | 8.0 | 8.0 | 8.0 | 8.0 | 10.0 | 10.0 | 7.5 | 7.5 | 7.5 |
| Li₂O | 8.0 | 8.5 | 8.0 | 7.0 | 7.0 | 8.5 | 8.0 | 8.8 | 9.3 | 7.7 |
| Na₂O | 2.0 | 1.5 | 1.5 | 3.0 | 2.0 | 1.5 | 1.5 | 2.2 | 1.6 | 3.3 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 0.0 | 0.0 | 2.5 | 2.5 | 2.5 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.002 | 0.002 | 0.003 | 0.002 | 0.002 | 0.002 | 0.002 | 0.002 | 0.000 | 0.001 |
| B₂O₃ + MgO + CaO | 8.0 | 8.0 | 8.0 | 8.0 | 8.0 | 10.0 | 10.0 | 10.0 | 10.0 | 10.0 |
| Al₂O₃ + Li₂O + Na₂O + K₂O | 20.0 | 20.0 | 20.0 | 20.0 | 20.0 | 20.0 | 20.0 | 22.0 | 21.9 | 22.0 |
| R₂O/Al₂O₃ | 1.00 | 1.00 | 0.90 | 1.00 | 0.82 | 1.00 | 0.90 | 1.00 | 0.99 | 1.00 |
| Al₂O₃/(R₂O + RO) | 1.00 | 1.00 | 1.11 | 1.00 | 1.22 | 1.00 | 1.11 | 0.81 | 0.82 | 0.81 |
| Na₂O/Li₂O | 0.25 | 0.18 | 0.19 | 0.43 | 0.29 | 0.18 | 0.19 | 0.25 | 0.17 | 0.43 |
| Li₂O/Al₂O₃ | 0.80 | 0.85 | 0.76 | 0.70 | 0.64 | 0.85 | 0.76 | 0.80 | 0.85 | 0.70 |
| Q | 14.86 | 14.61 | 14.11 | 15.36 | 13.86 | 10.61 | 10.11 | 6.46 | 6.47 | 7.02 |
| X | 477 | 513 | 502 | 404 | 455 | 510 | 499 | 545 | 583 | 464 |
| Y | 14 | 14 | 14 | 15 | 15 | 13 | 13 | 11 | 11 | 12 |
| Z | 60 | 65 | 64 | 50 | 57 | 65 | 63 | 59 | 65 | 48 |
| W | 424 | 460 | 448 | 353 | 401 | 451 | 439 | 475 | 513 | 397 |
| U | 8,319 | 8,331 | 8,444 | 8,294 | 8,545 | 8,344 | 8,457 | 8,336 | 8,364 | 8,308 |
| ρ (g/cm³) | 2.286 | 2.284 | 2.285 | 2.289 | 2.290 | 2.275 | 2.277 | 2.329 | 2.328 | 2.333 |
| Ts (° C.) | 844 | 850 | 875 | 851 | 890 | 823 | 846 | 806 | 806 | 806 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,651 | 1,658 | 1,658 | 1,660 | 1,656 | 1,618 | 1,612 | 1,558 | 1,554 | 1,567 |
| E (GPa) | 69 | 69 | 68 | 68 | 69 | 67 | 67 | 73 | 74 | 73 |
| CS_{K} (MPa) | 589 | 590 | 599 | 592 | 602 | 544 | 570 | 748 | 738 | 753 |
| DOL_{K} (μm) | 13 | 13 | 13 | 15 | 12 | 11 | 11 | 9 | 8 | 10 |
| CS_{Na} (MPa) | 371 | 404 | 385 | 310 | 328 | 372 | 363 | 409 | 465 | 344 |
| CS30_{Na} (MPa) | 162 | 168 | 152 | 143 | 135 | 135 | 134 | 132 | 142 | 128 |
| DOC_{Na} (μm) | 73 | 70 | 68 | 76 | 69 | 64 | 65 | 60 | 58 | 65 |
| CTcv_{Na} (MPa) | 39 | 40 | 37 | 36 | 32 | 35 | 32 | 35 | 37 | 32 |
| DOC_{Na}/DOL_{K} | 5.5 | 5.5 | 5.4 | 5.2 | 5.7 | 5.6 | 5.9 | 6.9 | 7.1 | 6.6 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 8

| | No. | No. | No. | No. | No. | No. | No. | No. | No. | No. |
|---|---|---|---|---|---|---|---|---|---|---|
| Component (mol %) | 071 | 072 | 073 | 074 | 075 | 076 | 077 | 078 | 079 | 080 |
| SiO₂ | 67.865 | 69.865 | 69.963 | 69.863 | 69.864 | 65.863 | 66.965 | 67.965 | 67.965 | 73.865 |
| Al₂O₃ | 12.1 | 11.0 | 11.0 | 11.0 | 12.1 | 10.8 | 12.6 | 11.0 | 11.5 | 9.0 |
| B₂O₃ | 7.5 | 6.0 | 6.0 | 6.0 | 6.0 | 5.0 | 7.5 | 7.5 | 7.5 | 3.0 |
| Li₂O | 7.7 | 8.8 | 9.3 | 7.7 | 7.7 | 8.4 | 8.0 | 8.2 | 8.2 | 7.0 |
| Na₂O | 2.2 | 2.2 | 1.6 | 3.3 | 2.2 | 4.8 | 2.3 | 2.7 | 2.2 | 4.0 |
| K₂O | 0.0 | 0.0 | 0.0 | 0.0 | 0.0 | 0.0 | 0.0 | 0.0 | 0.0 | 0.0 |
| MgO | 2.5 | 2.0 | 2.0 | 2.0 | 2.0 | 5.0 | 2.5 | 2.5 | 2.5 | 3.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.001 | 0.001 | 0.003 | 0.003 | 0.002 | 0.003 | 0.001 | 0.001 | 0.001 | 0.001 |
| B₂O₃ + MgO + CaO | 10.0 | 8.0 | 8.0 | 8.0 | 8.0 | 10.0 | 10.0 | 10.0 | 10.0 | 6.0 |
| Al₂O₃ + Li₂O + Na₂O + K₂O | 22.0 | 22.0 | 21.9 | 22.0 | 22.0 | 24.0 | 22.9 | 21.9 | 21.9 | 20.0 |
| R₂O/Al₂O₃ | 0.82 | 1.00 | 0.99 | 1.00 | 0.82 | 1.22 | 0.82 | 0.99 | 0.90 | 1.22 |
| Al₂O₃/(R₂O + RO) | 0.98 | 0.85 | 0.85 | 0.85 | 1.02 | 0.59 | 0.98 | 0.82 | 0.89 | 0.64 |
| Na₂O/Li₂O | 0.29 | 0.25 | 0.17 | 0.43 | 0.29 | 0.57 | 0.29 | 0.33 | 0.27 | 0.57 |
| Li₂O/Al₂O₃ | 0.64 | 0.80 | 0.85 | 0.70 | 0.64 | 0.78 | 0.63 | 0.75 | 0.71 | 0.78 |
| Q | 5.37 | 9.97 | 9.96 | 10.51 | 8.86 | 4.46 | 2.22 | 7.02 | 6.27 | 23.87 |
| X | 521 | 547 | 585 | 466 | 523 | 467 | 548 | 503 | 529 | 365 |
| Y | 12 | 13 | 12 | 14 | 14 | 11 | 12 | 12 | 12 | 15 |
| Z | 57 | 61 | 67 | 49 | 58 | 37 | 59 | 54 | 58 | 36 |
| W | 450 | 481 | 520 | 403 | 456 | 393 | 468 | 436 | 459 | 333 |
| U | 8,585 | 8,313 | 8,341 | 8,286 | 8,562 | 8,009 | 8,575 | 8,337 | 8,462 | 8,091 |
| ρ (g/cm³) | 2.329 | 2.329 | 2.328 | 2.333 | 2.330 | 2.386 | 2.334 | 2.330 | 2.328 | 2.351 |
| Ts (° C.) | 850 | 827 | 828 | 827 | 877 | 759 | 839 | 808 | 829.5 | 818 |
| α_{300-380° C.} | 48.1 | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,576 | 1,588 | 1,588 | 1,605 | 1,608 | 1,472 | 1,538 | 1,549 | 1,553 | 1,633 |
| E (GPa) | 73 | 74 | 75 | 74 | 74 | 79 | 74 | 74 | 73 | 78 |
| CS_{K} (MPa) | 761 | 770 | 756 | 768 | 781 | 871 | 790 | 747 | 743 | 726 |
| DOL_{K} (μm) | 9 | 10 | 9 | 11 | 10 | 8 | 8 | 10 | 9 | 12 |
| CS_{Na} (MPa) | 376 | 432 | 442 | 346 | 374 | 322 | 376 | 342 | 385 | 261 |
| CS30_{Na} (MPa) | 124 | 168 | 168 | 147 | 141 | 135 | 141 | 150 | 141 | 129 |
| DOC_{Na} (μm) | 60 | 67 | 66 | 71 | 65 | 70 | 65 | 73 | 64 | 80 |
| CTcv_{Na} (MPa) | 32 | 41 | 40 | 37 | 37 | 36 | 36 | 37 | 37 | 35 |
| DOC_{Na}/DOL_{K} | 6.9 | 6.8 | 7.1 | 6.3 | 6.5 | 8.7 | 7.7 | 7.5 | 7.0 | 6.9 |
| Acid resistance | 0.03 | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | 1.32 | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | 0.83 | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 9

| | No. | No. | No. | No. | No. | No. | No. | No. | No. | No. |
|---|---|---|---|---|---|---|---|---|---|---|
| Component (mol %) | 081 | 082 | 083 | 084 | 085 | 086 | 087 | 088 | 089 | 090 |
| SiO₂ | 69.864 | 69.858 | 69.866 | 69.861 | 69.858 | 69.860 | 69.862 | 69.859 | 69.854 | 69.859 |
| Al₂O₃ | 10.8 | 10.8 | 10.8 | 10.8 | 10.8 | 10.8 | 10.8 | 11.8 | 12.8 | 12.8 |
| B₂O₃ | 3.0 | 2.0 | 1.0 | 0.0 | 1.0 | 1.0 | 0.0 | 1.0 | 1.0 | 0.0 |
| Li₂O | 8.4 | 8.4 | 8.4 | 8.4 | 8.4 | 8.4 | 8.4 | 8.4 | 8.4 | 8.4 |
| Na₂O | 4.8 | 5.8 | 6.8 | 7.8 | 5.8 | 4.8 | 5.8 | 5.8 | 4.8 | 5.8 |
| K₂O | 0.0 | 0.0 | 0.0 | 0.0 | 0.0 | 0.0 | 0.0 | 0.0 | 0.0 | 0.0 |
| MgO | 3.0 | 3.0 | 3.0 | 3.0 | 4.0 | 5.0 | 5.0 | 3.0 | 3.0 | 3.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.002 | 0.008 | 0.000 | 0.005 | 0.008 | 0.006 | 0.004 | 0.007 | 0.012 | 0.007 |
| B₂O₃ + MgO + CaO | 6.0 | 5.0 | 4.0 | 3.0 | 5.0 | 6.0 | 5.0 | 4.0 | 4.0 | 3.0 |
| Al₂O₃ + Li₂O + Na₂O + K₂O | 24.0 | 25.0 | 26.0 | 27.0 | 25.0 | 24.0 | 25.0 | 26.0 | 26.0 | 27.0 |
| R₂O/Al₂O₃ | 1.22 | 1.31 | 1.41 | 1.50 | 1.31 | 1.22 | 1.31 | 1.20 | 1.03 | 1.11 |
| Al₂O₃/(R₂O + RO) | 0.67 | 0.63 | 0.59 | 0.56 | 0.59 | 0.59 | 0.56 | 0.69 | 0.79 | 0.74 |
| Na₂O/Li₂O | 0.57 | 0.69 | 0.81 | 0.93 | 0.69 | 0.57 | 0.69 | 0.69 | 0.57 | 0.69 |
| Li₂O/Al₂O₃ | 0.78 | 0.78 | 0.78 | 0.78 | 0.78 | 0.78 | 0.78 | 0.71 | 0.66 | 0.66 |
| Q | 10.46 | 9.96 | 9.47 | 8.96 | 10.96 | 12.46 | 11.96 | 7.96 | 6.45 | 5.96 |
| X | 468 | 447 | 426 | 405 | 450 | 474 | 453 | 477 | 528 | 507 |
| Y | 14 | 15 | 16 | 16 | 14 | 13 | 14 | 15 | 15 | 16 |
| Z | 42 | 37 | 32 | 26 | 35 | 38 | 33 | 39 | 47 | 42 |
| W | 400 | 375 | 350 | 325 | 380 | 411 | 386 | 397 | 445 | 420 |
| U | 7,944 | 7,778 | 7,614 | 7,449 | 7,798 | 7,984 | 7,819 | 7,865 | 8,116 | 7,951 |
| ρ (g/cm³) | 2.376 | 2.389 | 2.400 | 2.410 | 2.398 | 2.397 | 2.408 | 2.392 | 2.388 | 2.400 |
| Ts (° C.) | 795 | N.A. | N.A. | N.A. | N.A. | N.A. | N.A. | N.A. | N.A. | N.A. |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,564 | 1,549 | 1,544 | 1,536 | 1,546 | 1,547 | 1,546 | 1,579 | 1,596 | 1,602 |
| E (GPa) | 77 | 79 | 80 | 80 | 80 | 81 | 81 | 79 | 80 | 80 |
| CS_{K} (MPa) | 824 | 817 | 808 | 803 | 876 | 944 | 955 | 922 | 1,050 | 1,093 |
| DOL_{K} (μm) | 11 | 11 | 12 | 13 | 11 | 10 | 11 | 13 | 14 | 14 |
| CS_{Na} (MPa) | 302 | 282 | 258 | 253 | 323 | 310 | 293 | 282 | 334 | 291 |
| CS30_{Na} (MPa) | 152 | 149 | 148 | 150 | 157 | 163 | 162 | 163 | 189 | 188 |
| DOC_{Na} (μm) | 80 | 83 | 91 | 96 | 79 | 83 | 87 | 92 | 90 | 110 |
| CTcv_{Na} (MPa) | 43 | 46 | 48 | 47 | 46 | 49 | 52 | 53 | 58 | 71 |
| DOC_{Na}/DOL_{K} | 7.5 | 7.4 | 7.6 | 7.1 | 7.0 | 8.1 | 7.6 | 7.1 | 6.7 | 8.0 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 10

| | No. | No. | No. | No. | No. | No. | No. | No. | No. | No. |
|---|---|---|---|---|---|---|---|---|---|---|
| Component (mol %) | 091 | 092 | 093 | 094 | 095 | 096 | 097 | 098 | 099 | 100 |
| SiO₂ | 70.858 | 71.866 | 71.866 | 65.864 | 66.365 | 66.064 | 67.644 | 69.365 | 66.56 | 66.564 |
| Al₂O₃ | 10.8 | 10.8 | 10.8 | 12.1 | 12.1 | 12.1 | 12.1 | 11.9 | 12.1 | 12.1 |
| B₂O₃ | 1.0 | 1.0 | 0.0 | 7.5 | 7.0 | 7.5 | 7.5 | 4.3 | 7.5 | 7.5 |
| Li₂O | 8.4 | 8.4 | 8.4 | 8.2 | 8.2 | 7.7 | 7.7 | 7.7 | 7.7 | 7.7 |
| Na₂O | 5.8 | 4.8 | 5.8 | 3.4 | 3.4 | 3.7 | 2.2 | 3.8 | 2.9 | 3.2 |
| K₂O | 0.0 | 0.0 | 0.0 | 0.3 | 0.3 | 0.3 | 0 | 0.3 | 0.6 | 0.3 |
| MgO | 3.0 | 3.0 | 3.0 | 2.5 | 2.5 | 2.5 | 2.5 | 2.5 | 2.5 | 2.5 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.03 | 0.03 | 0.03 | 0.25 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.000 | 0.000 | 0.000 | 0.000 | 0.000 | 0.000 | 0.000 | 0.000 | 0.000 | 0.000 |
| Cl | 0.10 | 0.10 | 0.10 | 0.10 | 0.10 | 0.10 | 0.10 | 0.10 | 0.10 | 0.10 |
| MoO₃ | 0.008 | 0.000 | 0.000 | 0.002 | 0.001 | 0.002 | 0.002 | 0.001 | 0.002 | 0.002 |
| B₂O₃ + MgO + CaO | 4.0 | 4.0 | 3.0 | 10.0 | 9.5 | 10.0 | 10.0 | 6.8 | 10.0 | 10.0 |
| Al₂O₃ + Li₂O + Na₂O + K₂O | 25.0 | 24.0 | 25.0 | 24.0 | 24.0 | 23.8 | 22.0 | 23.7 | 23.3 | 23.3 |
| R₂O/Al₂O₃ | 1.31 | 1.22 | 1.31 | 0.98 | 0.98 | 0.97 | 0.82 | 0.99 | 0.93 | 0.93 |
| Al₂O₃/(R₂O + RO) | 0.63 | 0.67 | 0.63 | 0.84 | 0.84 | 0.85 | 0.98 | 0.83 | 0.88 | 0.88 |
| Na₂O/Li₂O | 0.69 | 0.57 | 0.69 | 0.41 | 0.41 | 0.48 | 0.29 | 0.49 | 0.38 | 0.42 |
| Li₂O/Al₂O₃ | 0.78 | 0.78 | 0.78 | 0.68 | 0.68 | 0.64 | 0.64 | 0.65 | 0.64 | 0.64 |
| Q | 11.96 | 14.47 | 13.97 | 0.26 | 1.27 | 1.01 | 5.14 | 7.97 | 2.41 | 2.26 |
| X | 449 | 471 | 450 | 519 | 520 | 487 | 521 | 485 | 506 | 498 |
| Y | 15 | 15 | 16 | 12 | 12 | 12 | 12 | 14 | 12 | 12 |
| Z | 37 | 43 | 37 | 52 | 52 | 48 | 57 | 48 | 53 | 51 |
| W | 379 | 409 | 384 | 435 | 437 | 406 | 450 | 413 | 429 | 420 |
| U | 7,772 | 7,931 | 7,767 | 8,284 | 8,281 | 8,303 | 8,565 | 8,249 | 8,386 | 8,382 |
| ρ (g/cm³) | 2.390 | 2.380 | 2.391 | 2.345 | 2.347 | 2.343 | 2.338 | 2.357 | 2.338 | 2.337 |
| Ts (° C.) | N.A. | N.A. | N.A. | 795 | 799 | 801 | 850 | 896 | 806 | 805 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,575 | 1,600 | 1,597 | 1,526 | 1,538 | 1,529 | 1,559 | 1,604 | 1,532 | 1,531 |
| E (GPa) | 79 | 79 | N.A. | N.A. | N.A. | 73 | N.A. | N.A. | 73 | 74 |
| CS_{K} (MPa) | 853 | 881 | 878 | 794 | 801 | 783 | 766 | 882 | 744 | 756 |
| DOL_{K} (μm) | 12 | 12 | 13 | 10 | 10 | 11 | 9 | 13 | 10 | 10 |
| CS_{Na} (MPa) | 244 | 289 | 254 | 380 | 366 | 340 | 355 | 321 | 339 | 354 |
| CS30_{Na} (MPa) | 152 | 163 | 155 | 139 | 123 | 122 | 128 | 162 | 110 | 130 |
| DOC_{Na} (μm) | 103 | 88 | 97 | 65 | 61 | 63 | 64 | 82 | 60 | 65 |
| CTcv_{Na} (MPa) | 51 | 57 | 57 | 33 | 34 | 32 | 32 | 41 | 30 | 32 |
| DOC_{Na}/DOL_{K} | 8.8 | 7.5 | 7.5 | 6.4 | 5.9 | 5.9 | 7.3 | 6.5 | 5.7 | 6.6 |
| Acid resistance | N.A. | N.A. | N.A. | N.A. | N.A. | 0.17 | N.A. | 0.03 | 0.20 | 0.27 |
| 5 wt % HCl 80° C. 24 h | | | | | | | | | | |
| (mg/cm²) | | | | | | | | | | |
| Alkali resistance | N.A. | N.A. | N.A. | N.A. | N.A. | 1.32 | N.A. | 0.88 | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 11

| Component (mol %) | No. 101 | No. 102 | No. 103 |
|---|---|---|---|
| SiO₂ | 66.565 | 66.564 | 68.146 |
| Al₂O₃ | 12.1 | 12.1 | 9.5 |
| B₂O₃ | 7.5 | 7.2 | 0.1 |
| Li₂O | 7.7 | 7.7 | 9.0 |
| Na₂O | 2.9 | 2.9 | 8.2 |
| K₂O | 0.9 | 0.9 | 3.0 |
| MgO | 2.2 | 2.5 | 2.0 |
| CaO | 0.0 | 0.0 | 0.0 |
| SrO | 0.0 | 0.0 | 0.0 |
| BaO | 0.0 | 0.0 | 0.0 |
| ZnO | 0.0 | 0.0 | 0.0 |
| TiO₂ | 0.002 | 0.002 | 0.002 |
| ZrO₂ | 0.0 | 0.0 | 0.0 |
| SnO₂ | 0.03 | 0.03 | 0.04 |
| Y₂O₃ | 0.0 | 0.0 | 0.0 |
| Fe₂O₃ | 0.002 | 0.002 | 0.002 |
| P₂O₅ | 0.0 | 0.0 | 0.0 |
| SO₃ | 0.000 | 0.000 | 0.000 |
| Cl | 0.10 | 0.10 | 0.01 |
| MoO₃ | 0.001 | 0.002 | 0.000 |
| B₂O₃ + MgO + CaO | 9.7 | 9.7 | 2.1 |
| Al₂O₃ + Li₂O + Na₂O + K₂O | 23.6 | 23.6 | 29.7 |
| R₂O/Al₂O₃ | 0.95 | 0.95 | 2.13 |
| Al₂O₃/(R₂O + RO) | 0.88 | 0.86 | 0.43 |
| Na₂O/Li₂O | 0.38 | 0.38 | 0.91 |
| Li₂O/Al₂O₃ | 0.64 | 0.64 | 0.95 |
| Q | 2.12 | 2.41 | 6.25 |
| X | 506 | 507 | 392 |
| Y | 12 | 12 | 16 |
| Z | 53 | 53 | 26 |
| W | 429 | 430 | 312 |
| U | 8,334 | 8,340 | 6,729 |
| ρ (g/cm³) | 2.337 | 2.342 | 2.428 |
| Ts (° C.) | 799 | 800 | 701 |
| α_{300-380° C.} | N.A. | N.A. | 94.3 |
| (×10⁻⁷/° C.) | | | |
| 10^{2.5} dPa's (° C.) | 1,538 | 1,532 | 1,427 |
| E (GPa) | N.A. | N.A. | 78 |
| CS_{K} (MPa) | 722 | 736 | 506 |
| DOL_{K} (μm) | 11 | 11 | 17 |
| CS_{Na} (MPa) | 333 | 331 | 136 |
| CS30_{Na} (MPa) | 102 | 118 | N.A. |
| DOC_{Na} (μm) | 58 | 64 | 79 |
| CTcv_{Na} (MPa) | 27 | 28 | N.A. |
| DOC_{Na}/DOL_{K} | 5.2 | 5.6 | 4.6 |
| Acid resistance | 0.18 | 0.22 | 0.00 |
| 5 wt % HCl 80° C. 24 h | | | |
| (mg/cm²) | | | |
| Alkali resistance | N.A. | N.A. | 0.56 |
| 5 wt % NaOH 80° C. 6 h | | | |
| (mg/cm²) | | | |
| K1c (SEPB) | N.A. | N.A. | N.A. |
| (MPam^{0.5}) | | | |
| Fracture energy γ | N.A. | N.A. | N.A. |

TABLE 12

| | No. | No. | No. | No. | No. | No. | No. | No. | No. | No. |
|---|---|---|---|---|---|---|---|---|---|---|
| Component (mol %) | 104 | 105 | 106 | 107 | 108 | 109 | 110 | 111 | 112 | 113 |
| SiO₂ | 67.145 | 66.845 | 66.845 | 67.125 | 67.095 | 67.075 | 66.885 | 67.275 | 67.365 | 66.825 |
| Al₂O₃ | 16.0 | 15.8 | 15.6 | 16.0 | 16.0 | 16.0 | 14.4 | 15.2 | 16.0 | 15.6 |
| B₂O₃ | 1.2 | 1.5 | 1.7 | 1.2 | 1.2 | 1.2 | 3.6 | 2.3 | 1.1 | 1.7 |
| Li₂O | 7.5 | 7.5 | 7.5 | 7.5 | 7.5 | 7.5 | 3.8 | 5.7 | 7.4 | 7.5 |
| Na₂O | 7.4 | 7.5 | 7.5 | 7.4 | 7.4 | 7.4 | 3.7 | 5.5 | 7.2 | 7.5 |
| K₂O | 0.3 | 0.3 | 0.3 | 0.3 | 0.3 | 0.3 | 0.2 | 0.2 | 0.3 | 0.3 |
| MgO | 0.3 | 0.4 | 0.4 | 0.3 | 0.3 | 0.3 | 2.2 | 1.2 | 0.4 | 0.4 |
| CaO | 0.0 | 0.0 | 0.0 | 0.0 | 0.0 | 0.0 | 3.7 | 1.8 | 0.1 | 0.0 |
| SrO | 0.0 | 0.0 | 0.0 | 0.0 | 0.0 | 0.0 | 0.2 | 0.1 | 0.0 | 0.0 |
| BaO | 0.0 | 0.0 | 0.0 | 0.0 | 0.0 | 0.0 | 1.2 | 0.6 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.05 | 0.05 | 0.05 | 0.07 | 0.10 | 0.12 | 0.06 | 0.04 | 0.03 | 0.07 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.1 | 0.1 | 0.1 | 0.1 | 0.1 | 0.1 | 0.1 | 0.1 | 0.1 | 0.1 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 1.5 | 1.9 | 2.1 | 1.5 | 1.5 | 1.5 | 9.5 | 5.3 | 1.6 | 2.1 |
| Al₂O₃ + Li₂O + Na₂O + K₂O | 31.2 | 31.1 | 30.9 | 31.2 | 31.2 | 31.2 | 22.1 | 26.6 | 30.9 | 30.9 |
| R₂O/Al₂O₃ | 0.95 | 0.97 | 0.98 | 0.95 | 0.95 | 0.95 | 0.53 | 0.75 | 0.93 | 0.98 |
| Al₂O₃/(R₂O + RO) | 1.03 | 1.01 | 0.99 | 1.03 | 1.03 | 1.03 | 0.96 | 1.01 | 1.04 | 0.99 |
| Na₂O/Li₂O | 0.99 | 1.00 | 1.00 | 0.99 | 0.99 | 0.99 | 0.97 | 0.96 | 0.97 | 1.00 |
| Li₂O/Al₂O₃ | 0.47 | 0.47 | 0.48 | 0.47 | 0.47 | 0.47 | 0.26 | 0.38 | 0.46 | 0.48 |
| Q | −8.45 | −8.60 | −8.20 | −8.47 | −8.50 | −8.53 | 6.73 | −0.47 | −7.63 | −8.22 |
| X | 512 | 504 | 498 | 512 | 512 | 512 | 381 | 450 | 512 | 498 |
| Y | 20 | 19 | 19 | 20 | 20 | 20 | 11 | 16 | 19 | 19 |
| Z | 42 | 40 | 40 | 42 | 42 | 41 | 27 | 35 | 42 | 40 |
| W | 384 | 377 | 372 | 384 | 384 | 384 | 264 | 329 | 386 | 372 |
| U | 8,006 | 7,976 | 7,959 | 8,004 | 8,002 | 8,000 | 9,156 | 8,587 | 8,057 | 7,957 |
| ρ (g/cm³) | 2.397 | 2.397 | 2.395 | 2.398 | 2.400 | 2.400 | 2.462 | 2.430 | 2.398 | 2.395 |
| Ts (° C.) | 935 | 922 | 915 | 937 | 935 | 935 | 906 | 913 | 938 | 912 |
| α_{300-380° C.} | N.A. | N.A. | 77 | N.A. | N.A. | N.A. | N.A. | N.A. | N.A. | N.A. |
| (×10⁻⁷/° C.) | | | | | | | | | | |
| 10^{2.5} dPa · s (° C.) | 1,627 | 1,615 | 1,611 | 1,626 | 1,624 | 1,626 | 1,569 | 1,600 | 1,628 | 1,614 |
| E (GPa) | 78 | 78 | 78 | 79 | 78 | 78 | 80 | 78 | 78 | 77 |
| CS_{K} (MPa) | 1,237 | 1,212 | 1,195 | 1,251 | 1,249 | 1,256 | 791 | 1,252 | 1,279 | 1,184 |
| DOL_{K} (μm) | 25 | 24 | 24 | 25 | 25 | 25 | N.A. | 11 | 24 | 24 |
| CS_{Na} (MPa) | 299 | 322 | 333 | 317 | 328 | 324 | 199 | 319 | 338 | 306 |
| CS30_{Na} (MPa) | 196 | 202 | 206 | 203 | 210 | 205 | 56 | 133 | 205 | 190 |
| DOC_{Na} (μm) | 111 | 103 | 102 | 106 | 107 | 104 | 56 | 70 | 99 | 101 |
| CTcv_{Na} (MPa) | 70 | 68 | 65 | 68 | 69 | 67 | 15 | 35 | 65 | 65 |
| DOC_{Na}/DOL_{K} | 4.5 | 4.2 | 4.2 | 4.3 | 4.3 | 4.2 | N.A. | 6.1 | 4.2 | 4.3 |
| Acid resistance | 0.16 | 0.24 | 0.22 | 0.20 | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | 0.50 | 0.52 | 0.50 | 0.49 | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | 0.81 | N.A. | 0.80 | N.A. | N.A. | N.A. | N.A. | N.A. | N.A. | N.A. |
| (MPam^{0.5}) | | | | | | | | | | |
| Fracture energy γ | 8.39 | N.A. | 8.23 | N.A. | N.A. | N.A. | N.A. | N.A. | N.A. | N.A. |

TABLE 13

| Component (mol %) | No. 114 | No. 115 | No. 116 | No. 117 | No. 118 | No. 119 | No. 120 | No. 121 | No. 122 | No. 123 |
|---|---|---|---|---|---|---|---|---|---|---|
| SiO₂ | 66.795 | 59.065 | 61.065 | 63.165 | 62.665 | 65.765 | 74.465 | 63.165 | 70.165 | 67.665 |
| Al₂O₃ | 15.6 | 17.2 | 14.4 | 13.2 | 13.2 | 16.0 | 9.9 | 17.8 | 10.8 | 11.4 |
| B₂O₃ | 1.7 | 2.2 | 10.0 | 10.0 | 10.0 | 3.0 | 6.5 | 0.2 | 9.3 | 5.8 |
| Li₂O | 7.5 | 12.3 | 10.1 | 8.2 | 8.4 | 7.5 | 6.6 | 8.7 | 8.0 | 11.9 |
| Na₂O | 7.5 | 6.3 | 4.3 | 4.8 | 5.1 | 7.3 | 2.1 | 8.7 | 1.4 | 1.3 |
| K₂O | 0.3 | 0.0 | 0.0 | 0.3 | 0.3 | 0.3 | 0.3 | 1.3 | 0.2 | 1.4 |
| MgO | 0.4 | 1.3 | 0.0 | 0.2 | 0.2 | 0.0 | 0.0 | 0.0 | 0.0 | 0.4 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.10 | 0.03 | 0.03 | 0.03 | 0.03 | 0.03 | 0.03 | 0.03 | 0.03 | 0.03 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 1.6 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.1 | 0.0 | 0.1 | 0.1 | 0.1 | 0.1 | 0.1 | 0.1 | 0.1 | 0.1 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 2.1 | 3.5 | 10.0 | 10.2 | 10.2 | 3.0 | 6.5 | 0.2 | 9.3 | 6.2 |
| Al₂O₃ + Li₂O + Na₂O + K₂O | 30.9 | 35.8 | 28.8 | 26.5 | 27.0 | 31.1 | 18.9 | 36.5 | 20.4 | 26.0 |
| R₂O/Al₂O₃ | 0.98 | 1.08 | 1.00 | 1.01 | 1.05 | 0.94 | 0.91 | 1.05 | 0.89 | 1.28 |
| Al₂O₃/(R₂O + RO) | 0.99 | 0.86 | 1.00 | 0.98 | 0.94 | 1.06 | 1.10 | 0.95 | 1.13 | 0.76 |
| Na₂O/Li₂O | 1.00 | 0.51 | 0.43 | 0.59 | 0.61 | 0.97 | 0.32 | 1.00 | 0.18 | 0.11 |
| Li₂O/Al₂O₃ | 0.48 | 0.72 | 0.70 | 0.62 | 0.64 | 0.47 | 0.67 | 0.49 | 0.74 | 1.04 |
| Q | −8.25 | −26.87 | −18.79 | −10.34 | −11.69 | −11.49 | 21.62 | −22.19 | 10.17 | 0.51 |
| X | 498 | 813 | 651 | 511 | 514 | 511 | 405 | 596 | 511 | 734 |
| Y | 19 | 14 | 13 | 14 | 14 | 19 | 16 | 20 | 14 | 12 |
| Z | 40 | 71 | 66 | 51 | 50 | 42 | 53 | 45 | 65 | 85 |
| W | 372 | 634 | 514 | 399 | 399 | 379 | 368 | 432 | 450 | 642 |
| U | 7,954 | 7,533 | 8,094 | 8,119 | 8,045 | 8,027 | 8,427 | 7,648 | 8,467 | 7,831 |
| ρ (g/cm³) | 2.396 | 2.413 | 2.330 | 2.326 | 2.331 | 2.385 | 2.288 | 2.428 | 2.283 | 2.347 |
| Ts (° C.) | 914 | N.A. | 760 | 791 | 796 | 904 | 910 | N.A. | 861 | N.A. |
| α_{300-380° C.} | N.A. | 78.1 | 65.1 | N.A. | N.A. | N.A. | N.A. | N.A. | N.A. | N.A. |
| (×10⁻⁷/° C.) | | | | | | | | | | |
| 10^{2.5} dPa · s (° C.) | 1,616 | 1,461 | 1,456 | 1,509 | 1,523 | 1,593 | 1,712 | 1,574 | 1,615 | 1,545 |
| E (GPa) | 78 | 79.4 | 71 | 69 | 70 | 76 | 69 | 80 | 68 | 76 |
| CS_{K} (MPa) | 1,186 | 855 | 700 | 706 | 770 | 1,152 | 591 | 1,204 | 574 | 648 |
| DOL_{K} (μm) | 24 | 11 | 10 | 13 | 14 | 23 | 17 | 26 | 11 | 10 |
| CS_{Na} (MPa) | 302 | 556 | 509 | 381 | 389 | 351 | 271 | 365 | 377 | 459 |
| CS30_{Na} (MPa) | 190 | 275 | 166 | 149 | 147 | 201 | 122 | 210 | 120 | 131 |
| DOC_{Na} (μm) | 103 | 79 | 60 | 67 | 66 | 92 | 74 | 92 | 60 | 57 |
| CTcv_{Na} (MPa) | 65 | 80 | 42 | 37 | 35 | 60 | 31 | 66 | 30 | 34 |
| DOC_{Na}/DOL_{K} | 4.4 | 7.5 | 6.0 | 5.2 | 4.8 | 4.0 | 4.3 | 3.5 | 5.4 | 5.7 |
| Acid resistance | N.A. | N.A. | 39.80 | N.A. | 3.98 | 1.58 | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | 1.10 | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | 0.81 | N.A. | N.A. | N.A. | N.A. | N.A. | N.A. | N.A. |
| (MPam^{0.5}) | | | | | | | | | | |
| Fracture energy γ | N.A. | N.A. | 9.24 | N.A. | N.A. | N.A. | N.A. | N.A. | N.A. | N.A. |

TABLE 14

| Component (mol %) | No. 124 | No. 125 | No. 126 | No. 127 | No. 128 | No. 129 | No. 130 | No. 131 | No. 132 | No. 133 |
|---|---|---|---|---|---|---|---|---|---|---|
| SiO₂ | 64.265 | 67.465 | 67.465 | 62.955 | 62.955 | 63.055 | 63.055 | 63.055 | 63.055 | 61.055 |
| Al₂O₃ | 13.1 | 16.0 | 15.0 | 13.8 | 17.8 | 13.8 | 15.8 | 13.8 | 13.8 | 15.8 |
| B₂O₃ | 7.7 | 1.0 | 2.0 | 0.1 | 0.1 | 0.0 | 0.0 | 0.0 | 2.0 | 2.0 |
| Li₂O | 8.2 | 7.5 | 7.5 | 8.3 | 4.3 | 5.3 | 4.3 | 4.3 | 6.3 | 6.3 |
| Na₂O | 6.1 | 7.3 | 7.3 | 11.1 | 11.1 | 11.1 | 11.1 | 11.1 | 11.1 | 11.1 |
| K₂O | 0.3 | 0.3 | 0.3 | 0.0 | 0.0 | 0.0 | 0.0 | 0.0 | 0.0 | 0.0 |
| MgO | 0.2 | 0.3 | 0.3 | 0.0 | 0.0 | 2.0 | 2.0 | 4.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.03 | 0.03 | 0.03 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 2.5 | 2.5 | 2.5 | 2.5 | 2.5 | 2.5 | 2.5 |
| SO₃ | 0.0 | 0.0 | 0.0 | 0.0 | 0.0 | 0.0 | 0.0 | 0.0 | 0.0 | 0.0 |
| Cl | 0.1 | 0.1 | 0.1 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 7.9 | 1.3 | 2.3 | 0.1 | 0.1 | 2.0 | 2.0 | 4.0 | 2.0 | 2.0 |
| Al₂O₃ + Li₂O + Na₂O + K₂O | 27.7 | 31.1 | 30.1 | 33.2 | 33.2 | 31.2 | 31.2 | 29.2 | 31.2 | 33.2 |
| R₂O/Al₂O₃ | 1.11 | 0.94 | 1.01 | 1.41 | 0.87 | 1.26 | 0.97 | 1.12 | 1.26 | 1.10 |
| Al₂O₃/(R₂O + RO) | 0.89 | 1.04 | 0.97 | 0.71 | 1.16 | 0.71 | 0.91 | 0.71 | 0.79 | 0.91 |
| Na₂O/Li₂O | 0.74 | 0.97 | 0.97 | 1.34 | 2.58 | 1.76 | 2.58 | 2.58 | 1.76 | 1.76 |
| Li₂O/Al₂O₃ | 0.63 | 0.47 | 0.50 | 0.60 | 0.24 | 0.46 | 0.27 | 0.31 | 0.46 | 0.40 |
| Q | −8.58 | −7.78 | −5.78 | −8.79 | −12.80 | −4.60 | −6.60 | −0.59 | −6.60 | −14.60 |
| X | 483 | 515 | 484 | 411 | 325 | 314 | 271 | 216 | 308 | 365 |
| Y | 15 | 20 | 19 | 20 | 23 | 19 | 21 | 18 | 21 | 21 |
| Z | 44 | 42 | 40 | 20 | 10 | 6 | 1 | −8 | 10 | 14 |
| W | 370 | 388 | 366 | 273 | 180 | 194 | 147 | 114 | 182 | 218 |
| U | 7,889 | 8,022 | 7,936 | 6,724 | 7,629 | 7,043 | 7,496 | 7,363 | 7,003 | 7,188 |
| ρ (g/cm³) | 2.350 | 2.397 | 2.389 | 2.436 | 2.432 | 2.443 | 2.442 | 2.452 | 2.420 | 2.427 |
| Ts (° C.) | 795 | 942 | 896 | 881 | 949 | 886 | 901 | 906 | N.A. | 841 |
| α_{300-380° C.} | N.A. | N.A. | N.A. | 87.4 | 76.2 | 85.1 | 79 | 83.1 | 81.7 | 81.6 |
| (×10⁻⁷/° C.) | | | | | | | | | | |
| 10^{2.5} dPa · s (° C.) | 1,556 | 1,637 | 1,615 | 1,512 | 1,629 | 1,539 | 1,603 | 1,559 | 1,547 | 1,549 |
| E (GPa) | 72 | 79 | 77 | 76 | 75 | 77 | 76 | 76 | 73 | 74 |
| CS_{K} (MPa) | 806 | 1,239 | 1,104 | N.A. | N.A. | N.A. | N.A. | N.A. | N.A. | N.A. |
| DOL_{K} (μm) | 15 | 24 | 22 | N.A. | N.A. | N.A. | N.A. | N.A. | N.A. | N.A. |
| CS_{Na} (MPa) | 363 | 312 | 305 | N.A. | N.A. | N.A. | N.A. | N.A. | N.A. | N.A. |
| CS30_{Na} (MPa) | 173 | 203 | 191 | N.A. | N.A. | N.A. | N.A. | N.A. | N.A. | N.A. |
| DOC_{Na} (μm) | 78 | 109 | 103 | N.A. | N.A. | N.A. | N.A. | N.A. | N.A. | N.A. |
| CTcv_{Na} (MPa) | 44 | 71 | 64 | N.A. | N.A. | N.A. | N.A. | N.A. | N.A. | N.A. |
| DOC_{Na}/DOL_{K} | 5.1 | 4.5 | 4.6 | N.A. | N.A. | N.A. | N.A. | N.A. | N.A. | N.A. |
| Acid resistance | 0.77 | 0.16 | 0.16 | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | 1.19 | 0.71 | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | 0.80 | N.A. | N.A. | N.A. | N.A. | N.A. | N.A. | N.A. | N.A. |
| (MPam^{0.5}) | | | | | | | | | | |
| Fracture energy γ | N.A. | 8.14 | N.A. | N.A. | N.A. | N.A. | N.A. | N.A. | N.A. | N.A. |

TABLE 15

| Component (mol %) | No. 134 | No. 135 | No. 136 | No. 137 | No. 138 | No. 139 | No. 140 | No. 141 | No. 142 | No. 143 |
|---|---|---|---|---|---|---|---|---|---|---|
| SiO₂ | 61.055 | 62.955 | 60.955 | 60.955 | 62.955 | 64.955 | 60.955 | 64.955 | 62.955 | 62.955 |
| Al₂O₃ | 13.8 | 13.8 | 15.8 | 13.8 | 17.8 | 15.8 | 19.8 | 17.8 | 19.8 | 15.8 |
| B₂O₃ | 4.0 | 0.1 | 0.1 | 0.1 | 0.1 | 0.1 | 0.1 | 0.1 | 0.1 | 0.1 |
| Li₂O | 6.3 | 6.3 | 6.3 | 6.3 | 6.3 | 6.3 | 6.3 | 4.3 | 4.3 | 6.3 |
| Na₂O | 11.1 | 11.1 | 11.1 | 11.1 | 11.1 | 11.1 | 11.1 | 11.1 | 11.1 | 13.1 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 2.5 | 4.5 | 4.5 | 6.5 | 0.5 | 0.5 | 0.5 | 0.5 | 0.5 | 0.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 4.0 | 0.1 | 0.1 | 0.1 | 0.1 | 0.1 | 0.1 | 0.1 | 0.1 | 0.1 |
| Al₂O₃ + Li₂O + Na₂O + K₂O | 31.2 | 31.2 | 33.2 | 31.2 | 35.2 | 33.2 | 37.2 | 33.2 | 35.2 | 35.2 |
| R₂O/Al₂O₃ | 1.26 | 1.26 | 1.10 | 1.26 | 0.98 | 1.10 | 0.88 | 0.87 | 0.78 | 1.23 |
| Al₂O₃/(R₂O + RO) | 0.79 | 0.79 | 0.91 | 0.79 | 1.02 | 0.91 | 1.14 | 1.16 | 1.29 | 0.81 |
| Na₂O/Li₂O | 1.76 | 1.76 | 1.76 | 1.76 | 1.76 | 1.76 | 1.76 | 2.58 | 2.58 | 2.08 |
| Li₂O/Al₂O₃ | 0.46 | 0.46 | 0.40 | 0.46 | 0.35 | 0.40 | 0.32 | 0.24 | 0.22 | 0.40 |
| Q | −10.60 | −2.40 | −10.40 | −2.00 | −19.20 | −11.20 | −27.20 | −13.20 | −21.20 | −16.20 |
| X | 305 | 314 | 371 | 317 | 422 | 365 | 479 | 322 | 379 | 320 |
| Y | 19 | 21 | 21 | 21 | 22 | 22 | 22 | 24 | 24 | 23 |
| Z | 9 | 10 | 15 | 10 | 20 | 15 | 24 | 10 | 15 | 4 |
| W | 173 | 190 | 227 | 190 | 263 | 227 | 299 | 180 | 217 | 168 |
| U | 7,016 | 6,736 | 6,922 | 6,482 | 7,617 | 7,431 | 7,802 | 7,884 | 8,070 | 7,114 |
| ρ (g/cm³) | 2.413 | 2.415 | 2.425 | 2.404 | 2.450 | 2.445 | 2.461 | 2.443 | 2.458 | 2.460 |
| Ts (° C.) | 825 | N.A. | 866 | 846 | N.A. | N.A. | 927 | 968 | 961 | 823 |
| α_{300-380° C.} | 81.2 | 82.8 | 82.7 | 82.4 | 81 | 83.6 | 79.1 | 75.3 | 71 | 89.2 |
| (×10⁻⁷/° C.) | | | | | | | | | | |
| 10^{2.5} dPa · s (° C.) | 1,518 | 1,580 | 1,576 | 1,572 | 1,585 | 1,598 | 1,558 | 1,635 | 1,607 | 1,553 |
| E (GPa) | 72 | 73 | 73 | 70 | 78 | 79 | 81 | 79 | 80 | 78 |
| CS_{K} (MPa) | N.A. | N.A. | N.A. | N.A. | N.A. | 1,125 | 1,455 | 1,343 | 1,348 | 945 |
| DOL_{K} (μm) | N.A. | N.A. | N.A. | N.A. | N.A. | 20 | 18 | 21 | 17 | 20 |
| CS_{Na} (MPa) | N.A. | N.A. | N.A. | N.A. | N.A. | 249 | 289 | 209 | 176 | 216 |
| CS30_{Na} (MPa) | N.A. | N.A. | N.A. | N.A. | N.A. | N.A. | N.A. | N.A. | N.A. | N.A. |
| DOC_{Na} (μm) | N.A. | N.A. | N.A. | N.A. | N.A. | 115 | 126 | 132 | 107 | 111 |
| CTcv_{Na} (MPa) | N.A. | N.A. | N.A. | N.A. | N.A. | N.A. | N.A. | N.A. | N.A. | N.A. |
| DOC_{Na}/DOL_{K} | N.A. | N.A. | N.A. | N.A. | N.A. | 5.6 | 7.2 | 6.3 | 6.2 | 5.6 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 16

| Component (mol %) | No. 144 | No. 145 | No. 146 | No. 147 | No. 148 | No. 149 | No. 150 | No. 151 | No. 152 | No. 153 |
|---|---|---|---|---|---|---|---|---|---|---|
| SiO₂ | 60.955 | 64.955 | 62.955 | 61.055 | 63.055 | 59.055 | 61.055 | 59.055 | 63.055 | 61.055 |
| Al₂O₃ | 17.8 | 17.8 | 19.8 | 17.8 | 15.8 | 19.8 | 15.8 | 17.8 | 17.8 | 19.8 |
| B₂O₃ | 0.1 | 0.1 | 0.1 | 0.0 | 0.0 | 0.0 | 0.0 | 0.0 | 0.0 | 0.0 |
| Li₂O | 6.3 | 6.3 | 6.3 | 6.3 | 6.3 | 6.3 | 6.3 | 6.3 | 6.3 | 6.3 |
| Na₂O | 13.1 | 9.1 | 9.1 | 11.1 | 11.1 | 11.1 | 13.1 | 13.1 | 9.1 | 9.1 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 2.0 | 2.0 | 2.0 | 2.0 | 2.0 | 2.0 | 2.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.5 | 0.5 | 0.5 | 0.5 | 0.5 | 0.5 | 0.5 | 0.5 | 0.5 | 0.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 0.1 | 0.1 | 0.1 | 2.0 | 2.0 | 2.0 | 2.0 | 2.0 | 2.0 | 2.0 |
| Al₂O₃ + Li₂O + Na₂O + K₂O | 37.2 | 33.2 | 35.2 | 35.2 | 33.2 | 37.2 | 35.2 | 37.2 | 33.2 | 35.2 |
| R₂O/Al₂O₃ | 1.09 | 0.87 | 0.78 | 0.98 | 1.10 | 0.88 | 1.23 | 1.09 | 0.87 | 0.78 |
| Al₂O₃/(R₂O + RO) | 0.92 | 1.16 | 1.29 | 0.92 | 0.81 | 1.02 | 0.74 | 0.83 | 1.02 | 1.14 |
| Na₂O/Li₂O | 2.08 | 1.44 | 1.44 | 1.76 | 1.76 | 1.76 | 2.08 | 2.08 | 1.44 | 1.44 |
| Li₂O/Al₂O₃ | 0.35 | 0.35 | 0.32 | 0.35 | 0.40 | 0.32 | 0.40 | 0.35 | 0.35 | 0.32 |
| Q | −24.20 | −14.20 | −22.20 | −21.00 | −13.00 | −29.00 | −18.00 | −26.00 | −16.00 | −24.00 |
| X | 377 | 468 | 525 | 425 | 368 | 482 | 322 | 379 | 470 | 527 |
| Y | 23 | 22 | 22 | 20 | 20 | 20 | 20 | 20 | 19 | 19 |
| Z | 8 | 31 | 35 | 15 | 11 | 20 | −1 | 4 | 26 | 31 |
| W | 204 | 322 | 358 | 266 | 230 | 303 | 171 | 208 | 325 | 361 |
| U | 7,300 | 7,934 | 8,119 | 7,669 | 7,484 | 7,854 | 7,167 | 7,352 | 7,986 | 8,171 |
| ρ (g/cm³) | 2.464 | 2.440 | 2.455 | 2.469 | 2.460 | 2.478 | 2.473 | 2.480 | 2.457 | 2.470 |
| Ts (° C.) | 872 | 947 | 942 | N.A. | N.A. | N.A. | 811 | N.A. | N.A. | 911 |
| α_{300-380° C.} | 89.6 | 72.2 | 69.3 | 81.5 | 83.4 | 79 | 90.3 | 88.6 | 72.6 | 69.1 |
| (×10⁻⁷/° C.) | | | | | | | | | | |
| 10^{2.5} dPa · s (° C.) | 1,553 | 1,607 | 1,574 | 1,533 | 1,544 | 1,516 | 1,503 | 1,499 | 1,557 | 1,528 |
| E (GPa) | 79 | 80 | 82 | 81 | 80 | 82 | 80 | 81 | 82 | 83 |
| CS_{K} (MPa) | 1,154 | 1,323 | 1,330 | 1,313 | 1,148 | 1,371 | 1,050 | 1,222 | 1,301 | 1,312 |
| DOL_{K} (μm) | 21 | 17 | 13 | 14 | 16 | 12 | 16 | 16 | 12 | 10 |
| CS_{Na} (MPa) | N.A. | N.A. | 257 | 264 | N.A. | N.A. | 238 | N.A. | N.A. | 284 |
| CS30_{Na} (MPa) | N.A. | N.A. | N.A. | N.A. | N.A. | N.A. | N.A. | N.A. | N.A. | N.A. |
| DOC_{Na} (μm) | N.A. | N.A. | 130 | 103 | N.A. | N.A. | 101 | N.A. | N.A. | 100 |
| CTcv_{Na} (MPa) | N.A. | N.A. | N.A. | N.A. | N.A. | N.A. | N.A. | N.A. | N.A. | N.A. |
| DOC_{Na}/DOL_{K} | N.A. | N.A. | 9.9 | 7.3 | N.A. | N.A. | 6.4 | N.A. | N.A. | 10.2 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 17

| Component (mol %) | No. 154 | No. 155 | No. 156 | No. 157 | No. 158 | No. 159 | No. 160 | No. 161 | No. 162 | No. 163 |
|---|---|---|---|---|---|---|---|---|---|---|
| SiO₂ | 61.055 | 61.055 | 59.055 | 63.055 | 61.055 | 59.055 | 59.055 | 57.055 | 61.055 | 59.055 |
| Al₂O₃ | 17.8 | 15.8 | 17.8 | 17.8 | 19.8 | 17.8 | 15.8 | 17.8 | 17.8 | 19.8 |
| B₂O₃ | 2.0 | 2.0 | 2.0 | 2.0 | 2.0 | 2.0 | 2.0 | 2.0 | 2.0 | 2.0 |
| Li₂O | 6.3 | 6.3 | 6.3 | 6.3 | 6.3 | 6.3 | 6.3 | 6.3 | 6.3 | 6.3 |
| Na₂O | 11.1 | 13.1 | 13.1 | 9.1 | 9.1 | 11.1 | 13.1 | 13.1 | 9.1 | 9.1 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 2.0 | 2.0 | 2.0 | 2.0 | 2.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.5 | 0.5 | 0.5 | 0.5 | 0.5 | 0.5 | 0.5 | 0.5 | 0.5 | 0.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 2.0 | 2.0 | 2.0 | 2.0 | 2.0 | 4.0 | 4.0 | 4.0 | 4.0 | 4.0 |
| Al₂O₃ + Li₂O + Na₂O + K₂O | 35.2 | 35.2 | 37.2 | 33.2 | 35.2 | 35.2 | 35.2 | 37.2 | 33.2 | 35.2 |
| R₂O/Al₂O₃ | 0.98 | 1.23 | 1.09 | 0.87 | 0.78 | 0.98 | 1.23 | 1.09 | 0.87 | 0.78 |
| Al₂O₃/(R₂O + RO) | 1.02 | 0.81 | 0.92 | 1.16 | 1.29 | 0.92 | 0.74 | 0.83 | 1.02 | 1.14 |
| Na₂O/Li₂O | 1.76 | 2.08 | 2.08 | 1.44 | 1.44 | 1.76 | 2.08 | 2.08 | 1.44 | 1.44 |
| Li₂O/Al₂O₃ | 0.35 | 0.40 | 0.35 | 0.35 | 0.32 | 0.35 | 0.40 | 0.35 | 0.35 | 0.32 |
| Q | −23.00 | −20.00 | −28.00 | −18.00 | −26.00 | −25.00 | −22.00 | −30.00 | −20.00 | −28.00 |
| X | 419 | 316 | 373 | 465 | 521 | 421 | 319 | 376 | 467 | 524 |
| Y | 21 | 22 | 22 | 21 | 21 | 19 | 19 | 19 | 18 | 18 |
| Z | 19 | 3 | 8 | 30 | 35 | 15 | −1 | 3 | 26 | 30 |
| W | 255 | 160 | 196 | 313 | 350 | 257 | 162 | 199 | 316 | 352 |
| U | 7,629 | 7,126 | 7,312 | 7,946 | 8,131 | 7,682 | 7,179 | 7,365 | 7,998 | 8,184 |
| ρ (g/cm³) | 2.440 | 2.452 | 2.454 | 2.429 | 2.445 | 2.459 | 2.465 | 2.471 | 2.446 | 2.460 |
| Ts (° C.) | 872 | 788 | 838 | 897 | 897 | 844 | 777 | 809 | 865 | 873 |
| α_{300-380° C.} | 79.4 | 87.7 | 87.5 | 70.5 | 68.4 | 80 | 89 | 87.7 | 71.5 | 69.4 |
| (×10⁻⁷/° C.) | | | | | | | | | | |
| 10^{2.5} dPa · s (° C.) | 1,541 | 1,513 | 1,520 | 1,564 | 1,530 | 1,494 | 1,464 | 1,462 | 1,514 | 1,483 |
| E (GPa) | 77 | 77 | 78 | 78 | 80 | 80 | 78 | 79 | 80 | 81 |
| CS_{K} (MPa) | 1,236 | 1,136 | 932 | 1,244 | 1,246 | 1,263 | 998 | 1,171 | 1,223 | 1,265 |
| DOL_{K} (μm) | 17 | 19 | 17 | 14 | 11 | 13 | 15 | 15 | 11 | 8 |
| CS_{Na} (MPa) | 260 | 225 | N.A. | N.A. | 259 | N.A. | N.A. | N.A. | N.A. | N.A. |
| CS30_{Na} (MPa) | N.A. | N.A. | N.A. | N.A. | N.A. | N.A. | N.A. | N.A. | N.A. | N.A. |
| DOC_{Na} (μm) | 99 | 105 | N.A. | N.A. | 139 | N.A. | N.A. | N.A. | N.A. | N.A. |
| CTcv_{Na} (MPa) | N.A. | N.A. | N.A. | N.A. | N.A. | N.A. | N.A. | N.A. | N.A. | N.A. |
| DOC_{Na}/DOL_{K} | 6.0 | 5.6 | N.A. | N.A. | 13.1 | N.A. | N.A. | N.A. | N.A. | N.A. |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 18

| Component (mol %) | No. 164 | No. 165 | No. 166 | No. 167 | No. 168 | No. 169 | No. 170 | No. 171 | No. 172 | No. 173 |
|---|---|---|---|---|---|---|---|---|---|---|
| SiO₂ | 62.955 | 62.955 | 62.955 | 61.055 | 61.055 | 61.055 | 61.055 | 60.955 | 60.955 | 60.955 |
| Al₂O₃ | 17.8 | 13.8 | 19.8 | 17.8 | 13.8 | 19.8 | 19.8 | 17.8 | 15.8 | 13.8 |
| B₂O₃ | 0.1 | 0.1 | 0.1 | 2.0 | 2.0 | 2.0 | 2.0 | 0.1 | 0.1 | 0.1 |
| Li₂O | 4.3 | 8.3 | 8.3 | 4.3 | 8.3 | 4.3 | 8.3 | 4.3 | 6.3 | 8.3 |
| Na₂O | 13.1 | 13.1 | 7.1 | 13.1 | 13.1 | 11.1 | 7.1 | 13.1 | 13.1 | 13.1 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.5 | 0.5 | 0.5 | 0.5 | 0.5 | 0.5 | 0.5 | 2.5 | 2.5 | 2.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 0.1 | 0.1 | 0.1 | 2.0 | 2.0 | 2.0 | 2.0 | 0.1 | 0.1 | 0.1 |
| Al₂O₃ + Li₂O + Na₂O + K₂O | 35.2 | 35.2 | 35.2 | 35.2 | 35.2 | 35.2 | 35.2 | 35.2 | 35.2 | 35.2 |
| R₂O/Al₂O₃ | 0.98 | 1.55 | 0.78 | 0.98 | 1.55 | 0.78 | 0.78 | 0.98 | 1.23 | 1.55 |
| Al₂O₃/(R₂O + RO) | 1.02 | 0.64 | 1.29 | 1.02 | 0.64 | 1.29 | 1.29 | 1.02 | 0.81 | 0.64 |
| Na₂O/Li₂O | 3.05 | 1.58 | 0.86 | 3.05 | 1.58 | 2.58 | 0.86 | 3.05 | 2.08 | 1.58 |
| Li₂O/Al₂O₃ | 0.24 | 0.60 | 0.42 | 0.24 | 0.60 | 0.22 | 0.42 | 0.24 | 0.40 | 0.60 |
| Q | −18.20 | −14.20 | −23.20 | −22.00 | −18.00 | −25.00 | −27.00 | −17.80 | −15.80 | −13.80 |
| X | 276 | 363 | 671 | 273 | 359 | 376 | 667 | 279 | 323 | 366 |
| Y | 24 | 21 | 20 | 23 | 20 | 23 | 19 | 24 | 22 | 21 |
| Z | −1 | 9 | 56 | −2 | 8 | 14 | 56 | −1 | 4 | 9 |
| W | 122 | 215 | 500 | 113 | 206 | 208 | 491 | 122 | 168 | 215 |
| U | 7,567 | 6,662 | 8,169 | 7,579 | 6,674 | 8,081 | 8,181 | 7,312 | 6,860 | 6,407 |
| ρ (g/cm³) | 2.454 | 2.463 | 2.450 | 2.442 | 2.460 | 2.447 | 2.440 | 2.446 | 2.450 | 2.451 |
| Ts (° C.) | 942 | 738 | 930 | 891 | 718 | 914 | 887 | 926 | 842 | 862 |
| α_{300-380° C.} | 83.5 | 94 | 66 | 82.8 | 91.4 | 70.3 | 65.8 | 84.6 | 90.5 | 93.3 |
| (×10⁻⁷/° C.) | | | | | | | | | | |
| 10^{2.5} dPa · s (° C.) | 1,620 | 1,461 | 1,552 | 1,564 | 1,441 | 1,559 | 1,510 | 1,603 | 1,550 | 1,468 |
| E (GPa) | 79 | 78 | 83 | 75 | 79 | 78 | 81 | 75 | 76 | 77 |
| CS_{K} (MPa) | 1,600 | 711 | 1,521 | 1,474 | 702 | 1,488 | 1,441 | 1,399 | 1,200 | 1,080 |
| DOL_{K} (μm) | 24 | 16 | 10 | 21 | 13 | 14 | 9 | 27 | 26 | 25 |
| CS_{Na} (MPa) | 192 | 213 | 315 | 163 | 205 | 208 | 315 | 171 | 167 | 161 |
| CS30_{Na} (MPa) | N.A. | N.A. | N.A. | N.A. | N.A. | N.A. | N.A. | N.A. | N.A. | N.A. |
| DOC_{Na} (μm) | 123 | 99 | 111 | 132 | 96 | 96 | 101 | 138 | 136 | 107 |
| CTcv_{Na} (MPa) | N.A. | N.A. | N.A. | N.A. | N.A. | N.A. | N.A. | N.A. | N.A. | N.A. |
| DOC_{Na}/DOL_{K} | 5.0 | 6.2 | 11.2 | 6.3 | 7.4 | 7.1 | 11.7 | 5.1 | 5.2 | 4.3 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 19

| Component (mol %) | No. 174 | No. 175 | No. 176 | No. 177 | No. 178 | No. 179 | No. 180 | No. 181 | No. 182 | No. 183 |
|---|---|---|---|---|---|---|---|---|---|---|
| SiO₂ | 60.955 | 60.955 | 60.955 | 61.055 | 61.055 | 61.055 | 61.055 | 64.155 | 60.955 | 60.955 |
| Al₂O₃ | 19.8 | 19.8 | 19.8 | 17.8 | 13.8 | 19.8 | 19.8 | 17.8 | 17.8 | 17.8 |
| B₂O₃ | 0.1 | 0.1 | 0.1 | 0.0 | 0.0 | 0.0 | 0.0 | 0.1 | 0.1 | 0.1 |
| Li₂O | 4.3 | 6.3 | 8.3 | 4.3 | 8.3 | 4.3 | 8.3 | 6.3 | 6.3 | 6.3 |
| Na₂O | 11.1 | 9.1 | 7.1 | 13.1 | 13.1 | 11.1 | 7. | 11.1 | 11.1 | 11.1 |
| K₂O | 0.0 | 0.0 | 0.0 | 0.0 | 0.0 | 0.0 | 0.0 | 0.0 | 2.0 | 0.0 |
| MgO | 0.0 | 0.0 | 0.0 | 2.0 | 2.0 | 2.0 | 2.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1. | 0.0 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 2.0 |
| Fe₂O₃ | 0.002 | 0.002 | 0.002 | 0.002 | 0.002 | 0.002 | 0.002 | 0.002 | 0.002 | 0.002 |
| P₂O₅ | 2.5 | 2.5 | 2.5 | 0.5 | 0.5 | 0.5 | 0.5 | 0.5 | 0.5 | 0.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 0.1 | 0.1 | 0.1 | 2.0 | 2.0 | 2.0 | 2.0 | 0.1 | 0.1 | 0.1 |
| Al₂O₃ + Li₂O + Na₂O + K₂O | 35.2 | 35.2 | 35.2 | 35.2 | 35.2 | 35.2 | 35.2 | 35.2 | 37.2 | 35.2 |
| R₂O/Al₂O₃ | 0.78 | 0.78 | 0.78 | 0.98 | 1.55 | 0.78 | 0.78 | 0.98 | 1.09 | 0.98 |
| Al₂O₃/(R₂O + RO) | 1.29 | 1.29 | 1.29 | 0.92 | 0.59 | 1.14 | 1.14 | 1.02 | 0.92 | 1.02 |
| Na₂O/Li₂O | 2.58 | 1.44 | 0.86 | 3.05 | 1.58 | 2.58 | 0.86 | 1.76 | 1.76 | 1.76 |
| Li₂O/Al₂O₃ | 0.22 | 0.32 | 0.42 | 0.24 | 0.60 | 0.22 | 0.42 | 0.35 | 0.35 | 0.35 |
| Q | −20.80 | −21.80 | −22.80 | −20.00 | −16.00 | −23.00 | −25.00 | −18.00 | −23.20 | −21.20 |
| X | 382 | 528 | 674 | 279 | 365 | 382 | 673 | 420 | 425 | 425 |
| Y | 23 | 21 | 19 | 22 | 19 | 21 | 17 | 22 | 22 | 22 |
| Z | 14 | 35 | 56 | −6 | 4 | 10 | 52 | 20 | 19 | 19 |
| W | 217 | 358 | 499 | 125 | 218 | 220 | 503 | 263 | 263 | 263 |
| U | 7,815 | 7,865 | 7,914 | 7,619 | 6,714 | 8,122 | 8,221 | 7,722 | 7,325 | 7,442 |
| ρ (g/cm³) | 2.443 | 2.440 | 2.437 | 2.470 | 2.475 | 2.473 | 2.466 | 2.424 | 2.464 | 2.563 |
| Ts (° C.) | 950 | 931 | 917 | 900 | 738 | 930 | 900 | 953 | 870 | 888 |
| α_{300-380° C.} | 71.3 | 69.9 | 67.6 | 82.9 | 95.5 | 71.7 | 68.8 | 82.7 | 93.4 | 80.5 |
| (×10⁻⁷/° C.) | | | | | | | | | | |
| 10^{2.5} dPa · s (° C.) | 1,592 | 1,567 | 1,541 | 1,560 | 1,423 | 1,555 | 1,506 | 1,612 | 1,569 | 1,487 |
| E (GPa) | 77 | 79 | 80 | 79 | 80 | 81 | 84 | 78 | 79 | 83 |
| CS_{K} (MPa) | 1,411 | 1,397 | 1,376 | 1,533 | 905 | 1,515 | 1,460 | 1,488 | 1,302 | 1,549 |
| DOL_{K} (μm) | 19 | 16 | 11 | 17 | 15 | 13 | 6 | 23 | 26 | 14 |
| CS_{Na} (MPa) | 152 | 216 | 324 | 185 | 213 | 174 | 290 | 266 | 207 | 196 |
| CS30_{Na} (MPa) | N.A. | N.A. | N.A. | N.A. | N.A. | N.A. | N.A. | N.A. | N.A. | N.A. |
| DOC_{Na} (μm) | 132 | 134 | 116 | 104 | 82 | 99 | 101 | 137 | 103 | 102 |
| CTcv_{Na} (MPa) | N.A. | N.A. | N.A. | N.A. | N.A. | N.A. | N.A. | N.A. | N.A. | N.A. |
| DOC_{Na}/DOL_{K} | 6.8 | 8.4 | 10.3 | 6.0 | 5.6 | 7.9 | 16.3 | 5.9 | 4.0 | 7.6 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 20

| Component (mol %) | No. 184 | No. 185 | No. 186 | No. 187 | No. 188 | No. 189 | No. 190 | No. 191 | No. 192 | No. 193 |
|---|---|---|---|---|---|---|---|---|---|---|
| SiO₂ | 62.955 | 59.055 | 58.955 | 58.955 | 60.055 | 60.055 | 59.955 | 59.955 | 61.055 | 60.955 |
| Al₂O₃ | 17.8 | 19.8 | 19.8 | 17.8 | 19.8 | 17.8 | 19.8 | 17.8 | 18.8 | 18.8 |
| B₂O₃ | 0.1 | 2.0 | 0.1 | 0.1 | 2.0 | 2.0 | 0.1 | 0.1 | 2.0 | 0.1 |
| Li₂O | 6.3 | 6.3 | 6.3 | 6.3 | 6.3 | 6.3 | 6.3 | 6.3 | 6.3 | 6.3 |
| Na₂O | 11.1 | 11.1 | 11.1 | 13.1 | 10.1 | 12.1 | 10.1 | 12.1 | 10.1 | 10.1 |
| K₂O | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 1.2 | 1.2 | 1.2 | 1.2 | 1.2 | 1.2 | 1.2 | 1.2 | 1.2 | 1.2 |
| TiO₂ | 0.002 | 0.002 | 0.002 | 0.002 | 0.002 | 0.002 | 0.002 | 0.002 | 0.002 | 0.002 |
| ZrO₂ | 0.0 | 0.0 | 0.0 | 0.0 | 0.0 | 0.0 | 0.0 | 0.0 | 0.0 | 0.0 |
| SnO₂ | 0.04 | 0.04 | 0.04 | 0.04 | 0.04 | 0.04 | 0.04 | 0.04 | 0.04 | 0.04 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.5 | 0.5 | 2.5 | 2.5 | 0.5 | 0.5 | 2.5 | 2.5 | 0.5 | 2.5 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 0.1 | 2.0 | 0.1 | 0.1 | 2.0 | 2.0 | 0.1 | 0.1 | 2.0 | 0.1 |
| Al₂O₃ + Li₂O + Na₂O + K₂O | 35.2 | 37.2 | 37.2 | 37.2 | 36.2 | 36.2 | 36.2 | 36.2 | 35.2 | 35.2 |
| R₂O/Al₂O₃ | 0.98 | 0.88 | 0.88 | 1.09 | 0.83 | 1.03 | 0.83 | 1.03 | 0.87 | 0.87 |
| Al₂O₃/(R₂O + RO) | 1.02 | 1.14 | 1.14 | 0.92 | 1.21 | 0.97 | 1.21 | 0.97 | 1.15 | 1.15 |
| Na₂O/Li₂O | 1.76 | 1.76 | 1.76 | 2.08 | 1.60 | 1.92 | 1.60 | 1.92 | 1.60 | 1.60 |
| Li₂O/Al₂O₃ | 0.35 | 0.32 | 0.32 | 0.35 | 0.32 | 0.35 | 0.32 | 0.35 | 0.34 | 0.34 |
| Q | −19.20 | −31.00 | −26.80 | −23.80 | −28.50 | −25.50 | −24.30 | −21.30 | −24.50 | −20.30 |
| X | 422 | 476 | 482 | 380 | 499 | 396 | 505 | 402 | 470 | 476 |
| Y | 22 | 21 | 22 | 22 | 21 | 21 | 22 | 22 | 21 | 22 |
| Z | 20 | 24 | 24 | 8 | 29 | 13 | 30 | 14 | 27 | 27 |
| W | 263 | 291 | 299 | 204 | 320 | 225 | 329 | 234 | 302 | 310 |
| U | 7,617 | 7,814 | 7,548 | 7,045 | 7,973 | 7,470 | 7,706 | 7,204 | 7,880 | 7,613 |
| ρ (g/cm³) | 2.601 | 2.451 | 2.453 | 2.457 | 2.448 | 2.445 | 2.447 | 2.450 | 2.440 | 2.440 |
| Ts (° C.) | 884 | 882 | 913 | 871 | 890 | 855 | 924 | 889 | 890 | 923 |
| α_{300-380° C.} | 83.7 | 77.6 | 79.6 | 89.5 | 73.6 | 85.1 | 75 | 86.6 | 74.6 | 76.9 |
| (×10⁻⁷/° C.) | | | | | | | | | | |
| 10^{2.5} dPa · s (° C.) | 1,485 | 1,519 | 1,547 | 1,541 | 1,525 | 1,529 | 1,557 | 1,560 | 1,540 | 1,578 |
| E (GPa) | 82 | 78 | 78 | 77 | 79 | 74 | 79 | 77 | 78 | 78 |
| CS_{K} (MPa) | 1,494 | 1,486 | 1,453 | 1,297 | 1,492 | 1,421 | 1,438 | 1,349 | 1,476 | 1,395 |
| DOL_{K} (μm) | 13 | 15 | 18 | 26 | 12 | 16 | 16 | 23 | 14 | 18 |
| CS_{Na} (MPa) | 193 | 280 | 254 | 217 | 263 | 260 | 237 | 225 | 259 | 245 |
| CS30_{Na} (MPa) | N.A. | N.A. | N.A. | N.A. | N.A. | N.A. | N.A. | N.A. | N.A. | N.A. |
| DOC_{Na} (μm) | 102 | 115 | 134 | 127 | 111 | 112 | 131 | 127 | 112 | 134 |
| CTcv_{Na} (MPa) | N.A. | N.A. | N.A. | N.A. | N.A. | N.A. | N.A. | N.A. | N.A. | N.A. |
| DOC_{Na}/DOL_{K} | 7.8 | 7.8 | 7.3 | 4.9 | 9.3 | 6.8 | 8.0 | 5.6 | 8.3 | 7.3 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 21

| Component (mol %) | No. 194 | No. 195 | No. 196 | No. 197 | No. 198 | No. 199 | No. 200 | No. 201 | No. 202 | No. 203 |
|---|---|---|---|---|---|---|---|---|---|---|
| SiO₂ | 59.055 | 70.005 | 63.205 | 62.695 | 67.895 | 63.376 | 61.965 | 60.277 | 60.242 | 60.173 |
| Al₂O₃ | 18.8 | 10.0 | 14.3 | 15.5 | 8.1 | 15.7 | 17.2 | 18.9 | 18.9 | 18.9 |
| B₂O₃ | 2.0 | 0.0 | 0.0 | 7.0 | 0.3 | 3.2 | 1.7 | 0.2 | 0.2 | 0.2 |
| Li₂O | 6.3 | 10.0 | 13.5 | 7.0 | 0.0 | 3.6 | 5.4 | 7.2 | 7.2 | 7.2 |
| Na₂O | 12.1 | 3.0 | 2.0 | 4.1 | 14.3 | 4.0 | 6.0 | 8.2 | 8.2 | 8.2 |
| K₂O | 0.0 | 1.0 | 5.0 | 0.1 | 1.1 | 0.2 | 0.3 | 0.4 | 0.4 | 0.4 |
| MgO | 0.0 | 5.0 | 1.0 | 1.0 | 5.2 | 2.4 | 1.5 | 0.3 | 0.3 | 0.3 |
| CaO | 0.0 | 0.0 | 0.0 | 1.5 | 3.0 | 3.8 | 1.9 | 0.0 | 0.0 | 0.0 |
| SrO | 0.0 | 0.0 | 0.0 | 1.1 | 0.0 | 0.2 | 0.1 | 0.0 | 0.0 | 0.0 |
| BaO | 0.0 | 0.0 | 0.0 | 0.0 | 0.0 | 1.3 | 0.6 | 0.0 | 0.0 | 0.0 |
| ZnO | 1.2 | 0.0 | 0.0 | 0.0 | 0.0 | 0.0 | 0.0 | 0.0 | 0.0 | 0.0 |
| TiO₂ | 0.002 | 0.002 | 0.002 | 0.002 | 0.002 | 0.002 | 0.002 | 0.070 | 0.105 | 0.174 |
| ZrO₂ | 0.0 | 1.0 | 1.0 | 0.0 | 0.0 | 0.0 | 0.0 | 0.0 | 0.0 | 0.0 |
| SnO₂ | 0.04 | 0.00 | 0.00 | 0.00 | 0.10 | 0.07 | 0.06 | 0.05 | 0.05 | 0.05 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.5 | 0.0 | 0.0 | 0.0 | 0.0 | 2.1 | 3.2 | 4.3 | 4.3 | 4.3 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.1 | 0.1 | 0.1 | 0.1 | 0.1 |
| MoO₃ | 0.001 | 0.001 | 0.001 | 0.001 | 0.001 | 0.000 | 0.001 | 0.001 | 0.001 | 0.001 |
| B₂O₃ + MgO + CaO | 2.0 | 5.0 | 1.0 | 9.5 | 8.5 | 9.4 | 5.1 | 0.5 | 0.5 | 0.5 |
| Al₂O₃ + Li₂O + Na₂O + K₂O | 37.2 | 24.0 | 34.8 | 26.7 | 23.5 | 23.5 | 28.9 | 34.7 | 34.7 | 34.7 |
| R₂O/Al₂O₃ | 0.98 | 1.40 | 1.43 | 0.72 | 1.90 | 0.50 | 0.68 | 0.84 | 0.84 | 0.84 |
| Al₂O₃/(R₂O + RO) | 1.02 | 0.53 | 0.67 | 1.05 | 0.34 | 1.01 | 1.09 | 1.17 | 1.17 | 1.17 |
| Na₂O/Li₂O | 1.92 | 0.30 | 0.15 | 0.59 | — | 1.11 | 1.11 | 1.14 | 1.14 | 1.14 |
| Li₂O/Al₂O₃ | 0.34 | 1.00 | 0.94 | 0.45 | 0.00 | 0.23 | 0.31 | 0.38 | 0.38 | 0.38 |
| Q | −29.50 | 14.51 | −14.70 | −11.06 | 20.75 | 2.20 | −7.59 | −18.56 | −18.60 | −18.67 |
| X | 425 | 577 | 898 | 546 | −224 | 406 | 487 | 570 | 570 | 570 |
| Y | 21 | 11 | 12 | 13 | 16 | 11 | 15 | 20 | 20 | 20 |
| Z | 16 | 54 | 95 | 50 | −69 | 26 | 34 | 42 | 42 | 42 |
| W | 243 | 520 | 766 | 411 | −292 | 271 | 340 | 405 | 405 | 405 |
| U | 7,563 | 7,754 | 7,154 | 8,715 | 7,272 | 8,996 | 8,317 | 7,614 | 7,611 | 7,605 |
| ρ (g/cm³) | 2.450 | 2.427 | 2.447 | 2.403 | 2.467 | 2.465 | 2.433 | 2.404 | 2.403 | 2.404 |
| Ts (° C.) | 864 | N.A. | N.A. | 839 | 798 | 902 | 902 | 922 | 921 | 921 |
| α_{300-380° C.} | 84.5 | 65.6 | 85 | 58.6 | 89.7 | 53.9 | 63 | 75.2 | 72.4 | 74.5 |
| (×10⁻⁷/° C.) | | | | | | | | | | |
| 10^{2.5} dPa · s (° C.) | 1,521 | 1,526 | 1,468 | 1,492 | 1,484 | 1,551 | 1,570 | 1,580 | 1,576 | 1,579 |
| E (GPa) | 78 | N.A. | N.A. | N.A. | N.A. | N.A. | N.A. | 75 | 75 | 75 |
| CS_{K} (MPa) | 1,433 | N.A. | N.A. | N.A. | 905 | 662 | 1,105 | N.A. | N.A. | N.A. |
| DOL_{K} (μm) | 14 | N.A. | N.A. | N.A. | 25 | N.A. | 13 | N.A. | N.A. | N.A. |
| CS_{Na} (MPa) | 280 | N.A. | N.A. | N.A. | N.A. | 112 | 272 | N.A. | N.A. | 290 |
| CS30_{Na} (MPa) | N.A. | N.A. | N.A. | N.A. | N.A. | 48 | 138 | N.A. | N.A. | N.A. |
| DOC_{Na} (μm) | 118 | N.A. | N.A. | N.A. | N.A. | 79 | 95 | N.A. | N.A. | N.A. |
| CTcv_{Na} (MPa) | N.A. | N.A. | N.A. | N.A. | N.A. | 6 | 15 | N.A. | N.A. | N.A. |
| DOC_{Na}/DOL_{K} | 8.3 | N.A. | N.A. | N.A. | N.A. | N.A. | 7.3 | N.A. | N.A. | N.A. |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 22

| Component (mol %) | No. 204 | No. 205 | No. 206 | No. 207 | No. 208 | No. 209 | No. 210 | No. 211 | No. 212 | No. 213 |
|---|---|---|---|---|---|---|---|---|---|---|
| SiO₂ | 64.42 | 64.507 | 69.417 | 69.047 | 66.227 | 61.647 | 65.647 | 56.647 | 63.647 | 68.817 |
| Al₂O₃ | 13.4 | 11.7 | 11.1 | 12.4 | 11.26 | 25 | 21 | 25 | 23 | 13.63 |
| B₂O₃ | 1.2 | 0.0 | 3.4 | 0.0 | 0.0 | 0.2 | 0.2 | 0.2 | 0.2 | 1.7 |
| Li₂O | 3.5 | 10.6 | 8.3 | 10.9 | 10.27 | 6.5 | 6.5 | 6.5 | 6.5 | 7.51 |
| Na₂O | 10.9 | 9.5 | 2.5 | 4.7 | 5.45 | 6.00 | 6.00 | 11.00 | 6.00 | 7.49 |
| K₂O | 0.4 | 0.3 | 0.2 | 1.1 | 1.43 | 0.3 | 0.3 | 0.3 | 0.3 | 0.3 |
| MgO | 2.4 | 0.8 | 1.1 | 0.1 | 3.1 | 0.2 | 0.2 | 0.2 | 0.2 | 0.4 |
| CaO | 0.0 | 0.2 | 2.9 | 0.1 | 0.3 | 0.0 | 0.0 | 0.0 | 0.0 | 0.0 |
| SrO | 0.0 | 0.0 | 0.2 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.1 | 0.1 | 0.0 | 0.0 | 0.0 | 0.0 | 0.0 | 0.0 | 0.0 |
| TiO₂ | 1.587 | 0.010 | 0.010 | 0.1 | 0.1 | 0.0 | 0.0 | 0.0 | 0.0 | 0.0 |
| ZrO₂ | 0.0 | 1.8 | 0.1 | 0.2 | 1.3 | 0.0 | 0.0 | 0.0 | 0.0 | 0.0 |
| SnO₂ | 0.10 | 0.00 | 0.09 | 0.00 | 0.00 | 0.05 | 0.05 | 0.05 | 0.05 | 0.05 |
| Y₂O₃ | 0.0 | 0.0 | 0.0 | 1.3 | 0.53 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 2.0 | 0.4 | 0.3 | 0.0 | 0.0 | 0.0 | 0.0 | 0.0 | 0.0 | 0.0 |
| SO₃ | 0.0 | 0.0 | 0.0 | 0.01 | 0.0 | 0.0 | 0.0 | 0.0 | 0.0 | 0.0 |
| Cl | 0.1 | 0.0 | 0.3 | 0.02 | 0.1 | 0.1 | 0.1 | 0.1 | 0.1 | 0.1 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 3.6 | 1.0 | 7.4 | 0.2 | 3.33 | 0.4 | 0.4 | 0.4 | 0.4 | 2.1 |
| Al₂O₃ + Li₂O + Na₂O + K₂O | 28.2 | 32.1 | 22.1 | 29.1 | 28.4 | 37.8 | 33.8 | 42.8 | 35.8 | 28.9 |
| R₂O/Al₂O₃ | 1.10 | 1.74 | 0.99 | 1.35 | 1.52 | 0.51 | 0.61 | 0.71 | 0.56 | 1.12 |
| Al₂O₃/(R₂O + RO) | 0.78 | 0.55 | 0.73 | 0.73 | 0.55 | 1.89 | 1.59 | 1.37 | 1.74 | 0.78 |
| Na₂O/Li₂O | 3.11 | 0.90 | 0.30 | 0.43 | 0.53 | 0.92 | 0.92 | 1.69 | 0.92 | 1.00 |
| Li₂O/Al₂O₃ | 0.26 | 0.91 | 0.75 | 0.88 | 0.91 | 0.26 | 0.31 | 0.26 | 0.28 | 0.55 |
| Q | 1.67 | −5.86 | 12.53 | 1.90 | 2.30 | −35.85 | −19.85 | −48.35 | −27.85 | −0.33 |
| X | 166 | 504 | 535 | 647 | 571 | 752 | 638 | 638 | 695 | 442 |
| Y | 20 | 17 | 10 | 16 | 13 | 21 | 21 | 22 | 21 | 19 |
| Z | −8 | 33 | 52 | 65 | 48 | 65 | 56 | 37 | 61 | 35 |
| W | 72 | 377 | 433 | 543 | 477 | 551 | 479 | 405 | 515 | 337 |
| U | 7,389 | 6,660 | 8,277 | 7,388 | 7,249 | 9,187 | 8,816 | 8,395 | 9,002 | 7,777 |
| ρ (g/cm³) | 2.424 | 2.487 | 2.403 | 2.476 | 2.487 | N.A. | 2.434 | 2.477 | 2.451 | 2.391 |
| Ts (° C.) | 898 | 743 | 807 | N.A. | 787 | N.A. | N.A. | N.A. | N.A. | N.A. |
| α_{300-380° C.} | 80.3 | 89.2 | 57.8 | 75.7 | 79.2 | N.A. | N.A. | N.A. | N.A. | N.A. |
| (×10⁻⁷/° C.) | | | | | | | | | | |
| 10^{2.5} dPa · s (° C.) | 1,601 | 1,420 | 1,537 | 1,516 | 1,469 | N.A. | 1,579 | 1,535 | 1,512 | 1,624 |
| E (GPa) | 73 | 82 | 79 | 82 | 83 | N.A. | 84 | 84 | 86 | 77 |
| CS_{K} (MPa) | N.A. | N.A. | N.A. | N.A. | N.A. | N.A. | 1,276 | 633 | 1,312 | 904 |
| DOL_{K} (μm) | N.A. | N.A. | N.A. | N.A. | N.A. | N.A. | 11 | 13 | 8 | 20 |
| CS_{Na} (MPa) | N.A. | N.A. | N.A. | N.A. | N.A. | N.A. | 207 | 192 | 206 | 313 |
| CS30_{Na} (MPa) | N.A. | N.A. | N.A. | N.A. | N.A. | N.A. | 132 | 128 | 128 | 171 |
| DOC_{Na} (μm) | N.A. | N.A. | N.A. | N.A. | N.A. | N.A. | 108 | 115 | 103 | 88 |
| CTcv_{Na} (MPa) | N.A. | N.A. | N.A. | N.A. | N.A. | N.A. | 40 | 45 | 38 | 47 |
| DOC_{Na}/DOL_{K} | N.A. | N.A. | N.A. | N.A. | N.A. | N.A. | 10.1 | 8.5 | 12.4 | 4.5 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 23

| Component (mol %) | No. 214 | No. 215 | No. 216 | No. 217 | No. 218 | No. 219 | No. 220 | No. 221 | No. 222 | No. 223 |
|---|---|---|---|---|---|---|---|---|---|---|
| SiO₂ | 64.817 | 68.517 | 64.817 | 67.217 | 64.817 | 68.817 | 64.817 | 68.817 | 64.817 | 67.117 |
| Al₂O₃ | 17.63 | 15.63 | 15.63 | 15.63 | 15.63 | 15.63 | 15.63 | 15.63 | 15.63 | 15.63 |
| B₂O₃ | 1.7 | 0.0 | 3.7 | 1.7 | 1.7 | 1.7 | 1.7 | 1.7 | 1.7 | 1.7 |
| Li₂O | 7.51 | 7.51 | 7.51 | 7.51 | 7.51 | 5.51 | 9.51 | 7.51 | 7.51 | 7.51 |
| Na₂O | 7.49 | 7.49 | 7.49 | 7.49 | 7.49 | 7.49 | 7.49 | 5.49 | 9.49 | 7.49 |
| K₂O | 0.3 | 0.3 | 0.3 | 0.3 | 0.3 | 0.3 | 0.3 | 0.3 | 0.3 | 0.0 |
| MgO | 0.4 | 0.4 | 0.4 | 0.0 | 2.4 | 0.4 | 0.4 | 0.4 | 0.4 | 0.4 |
| CaO | 0.0 | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.0 | 0.0 |
| SnO₂ | 0.05 | 0.05 | 0.05 | 0.05 | 0.05 | 0.05 | 0.05 | 0.05 | 0.05 | 0.05 |
| Y₂O₃ | 0.0 | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 | 0.002 |
| P₂O₅ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.1 | 0.1 | 0.1 | 0.1 | 0.1 | 0.1 | 0.1 | 0.1 | 0.1 | 0.1 |
| MoO₃ | 0.001 | 0.001 | 0.001 | 0.001 | 0.001 | 0.001 | 0.001 | 0.001 | 0.001 | 0.001 |
| B₂O₃ + MgO + CaO | 2.1 | 0.4 | 4.1 | 1.7 | 4.1 | 2.1 | 2.1 | 2.1 | 2.1 | 2.1 |
| Al₂O₃ + Li₂O + Na₂O + K₂O | 32.9 | 30.9 | 30.9 | 30.9 | 30.9 | 28.9 | 32.9 | 28.9 | 32.9 | 30.6 |
| R₂O/Al₂O₃ | 0.87 | 0.98 | 0.98 | 0.98 | 0.98 | 0.85 | 1.11 | 0.85 | 1.11 | 0.96 |
| Al₂O₃/(R₂O + RO) | 1.01 | 1.00 | 0.81 | 0.92 | 0.81 | 1.01 | 0.81 | 1.01 | 0.81 | 0.91 |
| Na₂O/Li₂O | 1.00 | 1.00 | 1.00 | 1.00 | 1.00 | 1.36 | 0.79 | 0.73 | 1.26 | 1.00 |
| Li₂O/Al₂O₃ | 0.43 | 0.48 | 0.48 | 0.48 | 0.48 | 0.35 | 0.61 | 0.48 | 0.48 | 0.48 |
| Q | −16.33 | −4.93 | −12.33 | −7.93 | −10.33 | −2.33 | −14.33 | −3.33 | −13.33 | −7.73 |
| X | 556 | 502 | 496 | 499 | 502 | 399 | 599 | 545 | 454 | 499 |
| Y | 19 | 20 | 18 | 20 | 17 | 21 | 18 | 19 | 20 | 19 |
| Z | 44 | 40 | 39 | 41 | 35 | 30 | 49 | 51 | 29 | 40 |
| W | 410 | 381 | 364 | 373 | 376 | 291 | 456 | 432 | 315 | 373 |
| U | 8,147 | 7,951 | 7,974 | 7,951 | 8,015 | 8,229 | 7,695 | 8,279 | 7,645 | 8,006 |
| ρ (g/cm³) | 2.409 | 2.402 | 2.385 | 2.391 | 2.414 | 2.390 | 2.408 | 2.385 | 2.415 | 2.393 |
| Ts (° C.) | 929 | N.A. | 871 | 924 | N.A. | 964 | N.A. | 949 | N.A. | 921 |
| α_{300-380° C.} | N.A. | N.A. | N.A. | N.A. | N.A. | N.A. | N.A. | N.A. | N.A. | N.A. |
| (×10⁻⁷/° C.) | | | | | | | | | | |
| 10^{2.5} dPa · s (° C.) | 1,588 | 1,653 | 1,571 | 1,630 | 1,560 | 1,662 | 1,550 | 1,638 | 1,575 | 1,618 |
| E (GPa) | 79 | 79 | 76 | 77 | 80 | 77 | 80 | 79 | 78 | 78 |
| CS_{K} (MPa) | 1,284 | 1,243 | 1,082 | 1,153 | 1,202 | 1,135 | 982 | 1,126 | 991 | 1,185 |
| DOL_{K} (μm) | 20 | 27 | 21 | 25 | 16 | 24 | 17 | 20 | 21 | 23 |
| CS_{Na} (MPa) | 329 | 314 | 328 | 318 | 331 | 235 | 387 | 351 | 326 | 322 |
| CS30_{Na} (MPa) | 192 | 204 | 196 | 206 | 184 | 142 | 204 | 199 | 176 | 199 |
| DOC_{Na} (μm) | 95 | 108 | 98 | 110 | 89 | 99 | 83 | 91 | 87 | 100 |
| CTcv_{Na} (MPa) | 60 | 74 | 56 | 65 | 53 | 43 | 62 | 59 | 50 | 68 |
| DOC_{Na}/DOL_{K} | 4.8 | 4.0 | 4.8 | 4.3 | 5.4 | 4.2 | 5.0 | 4.6 | 4.2 | 4.4 |
| Acid resistance | N.A. | N.A. | N.A. | N.A. | N.A. | N.A. | N.A. | N.A. | N.A. | N.A. |
| 5 wt % HCl 80° C. 24 h | | | | | | | | | | |
| (mg/cm²) | | | | | | | | | | |
| Alkali resistance | N.A. | N.A. | N.A. | N.A. | N.A. | N.A. | N.A. | N.A. | N.A. | N.A. |
| 5 wt % NaOH 80° C. 6 h | | | | | | | | | | |
| (mg/cm²) | | | | | | | | | | |
| K1c (SEPB) | N.A. | N.A. | N.A. | N.A. | N.A. | N.A. | N.A. | N.A. | N.A. | N.A. |
| (MPam^{0.5}) | | | | | | | | | | |
| Fracture energy γ | N.A. | N.A. | N.A. | N.A. | N.A. | N.A. | N.A. | N.A. | N.A. | N.A. |

TABLE 24

| Component (mol %) | No. 224 | No. 225 | No. 226 | No. 227 | No. 228 | No. 229 | No. 230 | No. 231 | No. 232 |
|---|---|---|---|---|---|---|---|---|---|
| SiO₂ | 64.817 | 64.817 | 62.817 | 62.157 | 60.197 | 58.237 | 56.277 | 54.937 | 54.937 |
| Al₂O₃ | 15.63 | 15.63 | 15.63 | 18.01 | 19.01 | 20.01 | 21.01 | 20.01 | 20.01 |
| B₂O₃ | 1.7 | 1.7 | 1.7 | 1.7 | 1.7 | 1.7 | 1.7 | 5.0 | 5.0 |
| Li₂O | 7.51 | 7.51 | 7.51 | 8.65 | 9.13 | 9.61 | 10.09 | 9.61 | 12.01 |
| Na₂O | 7.49 | 7.49 | 7.49 | 8.63 | 9.11 | 9.59 | 10.07 | 9.59 | 7.19 |
| K₂O | 2.3 | 0.3 | 0.3 | 0.3 | 0.3 | 0.3 | 0.3 | 0.3 | 0.3 |
| MgO | 0.4 | 0.4 | 0.4 | 0.4 | 0.4 | 0.4 | 0.4 | 0.4 | 0.4 |
| CaO | 0.0 | 0.0 | 0.0 | 0.0 | 0.0 | 0.0 | 0.0 | 0.0 | 0.0 |
| SrO | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.0 |
| SnO₂ | 0.05 | 0.05 | 0.05 | 0.05 | 0.05 | 0.05 | 0.05 | 0.05 | 0.05 |
| Y₂O₃ | 0.0 | 0.0 | 0.0 | 0.0 | 0.0 | 0.0 | 0.0 | 0.0 | 0.0 |
| Fe₂O₃ | 0.002 | 0.002 | 0.002 | 0.002 | 0.002 | 0.002 | 0.002 | 0.002 | 0.002 |
| P₂O₅ | 0.0 | 2.0 | 4.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 |
| Cl | 0.1 | 0.1 | 0.1 | 0.1 | 0.1 | 0.1 | 0.1 | 0.1 | 0.1 |
| MoO₃ | 0.001 | 0.001 | 0.001 | 0.001 | 0.001 | 0.001 | 0.001 | 0.001 | 0.001 |
| B₂O₃ + MgO + CaO | 2.1 | 2.1 | 2.1 | 2.1 | 2.1 | 2.1 | 2.1 | 5.4 | 5.4 |
| Al₂O₃ + Li₂O + Na₂O + K₂O | 32.9 | 30.9 | 30.9 | 35.6 | 37.6 | 39.5 | 41.5 | 39.5 | 39.5 |
| R₂O/Al₂O₃ | 1.11 | 0.98 | 0.98 | 0.98 | 0.98 | 0.97 | 0.97 | 0.97 | 0.97 |
| Al₂O₃/(R₂O + RO) | 0.81 | 0.90 | 0.90 | 0.92 | 0.92 | 0.93 | 0.93 | 0.80 | 0.80 |
| Na₂O/Li₂O | 1.00 | 1.00 | 1.00 | 1.00 | 1.00 | 1.00 | 1.00 | 1.00 | 0.60 |
| Li₂O/Al₂O₃ | 0.48 | 0.48 | 0.48 | 0.48 | 0.48 | 0.48 | 0.48 | 0.48 | 0.60 |
| Q | −12.33 | −7.93 | −7.53 | −24.12 | −30.76 | −37.40 | −44.04 | −44.00 | −45.20 |
| X | 502 | 502 | 505 | 598 | 639 | 681 | 723 | 675 | 850 |
| Y | 19 | 19 | 18 | 19 | 19 | 18 | 18 | 17 | 14 |
| Z | 40 | 40 | 39 | 44 | 46 | 48 | 50 | 47 | 72 |
| W | 373 | 373 | 373 | 430 | 454 | 478 | 502 | 463 | 633 |
| U | 7,670 | 7,707 | 7,452 | 7,850 | 7,802 | 7,755 | 7,707 | 7,775 | 7,835 |
| ρ (g/cm³) | 2.413 | 2.385 | 2.377 | 2.418 | 2.428 | 2.436 | 2.444 | 2.424 | 2.420 |
| Ts (° C.) | 840 | 896 | 877 | 884 | N.A. | N.A. | N.A. | N.A. | N.A. |
| α_{300-380° C.} | N.A. | N.A. | N.A. | N.A. | N.A. | N.A. | N.A. | N.A. | N.A. |
| (×10⁻⁷/° C.) | | | | | | | | | |
| 10^{2.5} dPa · s (° C.) | 1,596 | 1,614 | 1,604 | 1,546 | N.A. | N.A. | N.A. | N.A. | N.A. |
| E (GPa) | 78 | 75 | 73 | 80 | 80 | 80 | 81 | 79 | 81 |
| CS_{K} (MPa) | 926 | 1,000 | 864 | 1,264 | 1,297 | 1,336 | 1,347 | 1,240 | 1,139 |
| DOL_{K} (μm) | 27 | 27 | 30 | 21 | 20 | 19 | 19 | 16 | 12 |
| CS_{Na} (MPa) | 280 | 270 | 248 | 405 | 418 | 456 | 496 | 463 | 655 |
| CS30_{Na} (MPa) | 134 | 174 | 152 | 233 | 240 | 255 | 278 | 230 | 299 |
| DOC_{Na} (μm) | 77 | 108 | 99 | 92 | 92 | 90 | 90 | 79 | 75 |
| CTcv_{Na} (MPa) | 37 | 59 | 52 | 72 | 74 | 76 | 80 | 63 | 72 |
| DOC_{Na}/DOL_{K} | 2.9 | 4.0 | 3.3 | 4.3 | 4.5 | 4.7 | 4.9 | 5.1 | 6.3 |
| Acid resistance | N.A. | N.A. | N.A. | N.A. | N.A. | N.A. | N.A. | N.A. | N.A. |
| 5 wt % HCl 80° C. 24 h | | | | | | | | | |
| (mg/cm²) | | | | | | | | | |
| Alkali resistance | N.A. | N.A. | N.A. | N.A. | N.A. | N.A. | N.A. | N.A. | N.A. |
| 5 wt % NaOH 80° C. 6 h | | | | | | | | | |
| (mg/cm²) | | | | | | | | | |
| K1c (SEPB) | N.A. | N.A. | N.A. | N.A. | N.A. | N.A. | N.A. | N.A. | N.A. |
| (MPam^{0.5}) | | | | | | | | | |
| Fracture energy γ | N.A. | N.A. | N.A. | N.A. | N.A. | N.A. | N.A. | N.A. | N.A. |

TABLE 25

| | No. | No. | No. | No. | No. |
|---|---|---|---|---|---|
| Component (mol %) | 233 | 234 | 235 | 236 | 237 |
| SiO₂ | 68.515 | 68.515 | 68.515 | 68.515 | 68.515 |
| Al₂O₃ | 13.63 | 11.63 | 15.61 | 15.61 | 13.61 |
| B₂O₃ | 2.0 | 4.0 | 1.5 | 3.5 | 3.5 |
| Li₂O | 7.51 | 7.51 | 7.51 | 7.51 | 7.51 |
| Na₂O | 7.49 | 7.49 | 6.01 | 4.01 | 6.01 |
| K₂O | 0.3 | 0.3 | 0.3 | 0.3 | 0.3 |
| MgO | 0.4 | 0.4 | 0.4 | 0.4 | 0.4 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 2.4 | 4.4 | 1.9 | 3.9 | 3.9 |
| Al₂O₃ + Li₂O + Na₂O + K₂O | 28.9 | 26.9 | 29.4 | 27.4 | 27.4 |
| R₂O/Al₂O₃ | 1.12 | 1.32 | 0.89 | 0.76 | 1.02 |
| Al₂O₃/(R₂O + RO) | 0.87 | 0.74 | 1.10 | 1.28 | 0.96 |
| Na₂O/Li₂O | 1.00 | 1.00 | 0.80 | 0.53 | 0.80 |
| Li₂O/Al₂O₃ | 0.55 | 0.65 | 0.48 | 0.48 | 0.55 |
| Q | −0.93 | 3.07 | −4.15 | −3.15 | −0.15 |
| X | 442 | 381 | 533 | 575 | 472 |
| Y | 19 | 18 | 19 | 17 | 18 |
| Z | 35 | 30 | 48 | 59 | 43 |
| W | 336 | 291 | 417 | 467 | 372 |
| U | 7,778 | 7,605 | 8,193 | 8,523 | 8,020 |
| ρ (g/cm³) | 2.3907 | 2.3857 | 2.3873 | 2.3698 | 2.3662 |
| Ts (° C.) | N.A. | 746.5 | 948 | 923 | 871 |
| α_{300-380° C.} | N.A. | N.A. | N.A. | N.A. | N.A. |
| (×10⁻⁷/° C.) | | | | | |
| 10^{2.5} dPa · s (° C.) | 1,613 | 1,574 | 1,637 | 1,618 | 1,618.3 |
| E (GPa) | 77.4 | 77.1 | 78.6 | 77.7 | 75.1 |
| CS_{K} (MPa) | 888 | 739 | 1,163 | 982 | 942 |
| DOL_{K} (μm) | 18 | 13 | 20 | 13 | 19 |
| CS_{Na} (MPa) | 364 | 296 | 390 | 381 | 408 |
| CS30_{Na} (MPa) | 170 | 119 | 201 | 166 | 180 |
| DOC_{Na} (μm) | 81 | 73 | 93 | 73 | 84 |
| CTcv_{Na} (MPa) | 48 | 33 | 64 | 45 | 54 |
| DOC_{Na}/DOL_{K} | 4.5 | 5.6 | 4.6 | 5.6 | 4.4 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |
| | No. | No. | No. | No. | No. |
| Component (mol %) | 238 | 239 | 240 | 241 | 242 |
| SiO₂ | 68.515 | 66.515 | 66.515 | 65.815 | 65.815 |
| Al₂O₃ | 12.63 | 15.61 | 15.61 | 15.63 | 15.63 |
| B₂O₃ | 6.0 | 1.5 | 2.5 | 1.7 | 1.7 |
| Li₂O | 7.51 | 9.51 | 9.51 | 7.51 | 8.51 |
| Na₂O | 4.49 | 6.01 | 5.01 | 7.49 | 7.49 |
| K₂O | 0.3 | 0.3 | 0.3 | 1.3 | 0.3 |
| MgO | 0.4 | 0.4 | 0.4 | 0.4 | 0.4 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 6.4 | 1.9 | 2.9 | 2.1 | 2.1 |
| Al₂O₃ + Li₂O + Na₂O + K₂O | 24.9 | 31.4 | 30.4 | 31.9 | 31.9 |
| R₂O/Al₂O₃ | 0.97 | 1.01 | 0.95 | 1.04 | 1.04 |
| Al₂O₃/(R₂O + RO) | 0.99 | 0.96 | 1.03 | 0.94 | 0.94 |
| Na₂O/Li₂O | 0.60 | 0.63 | 0.53 | 1.00 | 0.88 |
| Li₂O/Al₂O₃ | 0.59 | 0.61 | 0.61 | 0.48 | 0.54 |
| Q | 2.57 | −10.15 | −9.65 | −10.33 | −11.33 |
| X | 475 | 633 | 654 | 501 | 549 |
| Y | 16 | 17 | 17 | 19 | 18 |
| Z | 49 | 58 | 63 | 40 | 45 |
| W | 388 | 500 | 525 | 373 | 415 |
| U | 8,186 | 7,926 | 8,091 | 7,816 | 7,828 |
| ρ (g/cm³) | 2.3369 | 2.3938 | 2.3817 | 2.4033 | 2.4011 |
| Ts (° C.) | 856 | N.A. | N.A. | 874 | N.A. |
| α_{300-380° C.} | N.A. | N.A. | N.A. | N.A. | N.A. |
| (×10⁻⁷/° C.) | | | | | |
| 10^{2.5} dPa · s (° C.) | 1,614 | 1,588.7 | 1,584.4 | 1,598 | 1,583 |
| E (GPa) | 72.5 | 79 | 78.3 | 77.8 | 78.6 |
| CS_{K} (MPa) | 825 | 1,104 | 1,105 | 1,035 | 1,051 |
| DOL_{K} (μm) | 16 | 19 | 17 | 25 | 20 |
| CS_{Na} (MPa) | 365 | 623 | 493 | 329 | 403 |
| CS30_{Na} (MPa) | 163 | 249 | 249 | 173 | 222 |
| DOC_{Na} (μm) | 75 | 80 | 87 | 86 | 89 |
| CTcv_{Na} (MPa) | 44 | 74 | 72 | −51 | −66 |
| DOC_{Na}/DOL_{K} | 4.7 | 4.2 | 5.1 | 3.4 | 4.5 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |

TABLE 26

| | No. | No. | No. | No. | No. |
|---|---|---|---|---|---|
| Component (mol %) | 243 | 244 | 245 | 246 | 247 |
| SiO₂ | 65.315 | 63.815 | 65.815 | 66.315 | 62.255 |
| Al₂O₃ | 15.63 | 15.63 | 15.63 | 15.63 | 15.63 |
| B₂O₃ | 1.7 | 1.7 | 1.7 | 1.7 | 1.7 |
| Li₂O | 8.51 | 7.51 | 9.01 | 9.01 | 8.01 |
| Na₂O | 7.49 | 7.49 | 7.49 | 7.49 | 7.49 |
| K₂O | 1.3 | 1.8 | 0.3 | 1.8 | 0.8 |
| MgO | 0.4 | 0.4 | 0.4 | 0.4 | 0.4 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 2.1 | 2.1 | 2.1 | 2.1 | 2.1 |
| Al₂O₃ + Li₂O + Na₂O + K₂O | 32.9 | 32.4 | 32.4 | 33.9 | 31.9 |
| R₂O/Al₂O₃ | 1.11 | 1.07 | 1.07 | 1.17 | 1.04 |
| Al₂O₃/(R₂O + RO) | 0.88 | 0.91 | 0.91 | 0.84 | 0.94 |
| Na₂O/Li₂O | 0.88 | 1.00 | 0.83 | 0.83 | 0.94 |
| Li₂O/Al₂O₃ | 0.54 | 0.48 | 0.58 | 0.58 | 0.51 |
| Q | −12.83 | −12.83 | −12.33 | −13.33 | −14.39 |
| X | 550 | 504 | 573 | 573 | 530 |
| Y | 18 | 19 | 18 | 18 | 18 |
| Z | 45 | 39 | 47 | 47 | 42 |
| W | 415 | 373 | 435 | 436 | 394 |
| U | 7,726 | 7,612 | 7,805 | 7,761 | 7,511 |
| ρ (g/cm³) | 2.4103 | 2.4086 | 2.4044 | 2.4176 | 2.402 |
| Ts (° C.) | 854.5 | N.A. | N.A. | N.A. | 875.5 |
| α_{300-380° C.} | N.A. | N.A. | N.A. | N.A. | 77.2 |
| (×10⁻⁷/° C.) | | | | | |
| 10^{2.5} dPa · s (° C.) | 1,573 | 1,596 | 1,569 | 1,553 | 1,597 |
| E (GPa) | 78.5 | 77.6 | 78.7 | N.A. | 78.1 |
| CS_{K} (MPa) | 938 | 959 | 1,002 | N.A. | 1,038 |
| DOL_{K} (μm) | 20 | 27 | 18 | N.A. | 23 |
| CS_{Na} (MPa) | 361 | 359 | 496 | N.A. | 376 |
| CS30_{Na} (MPa) | 175 | 142 | 217 | N.A. | 198 |
| DOC_{Na} (μm) | 79 | 81 | 78 | N.A. | 86 |
| CTcv_{Na} (MPa) | −48 | −42 | −61 | N.A. | −56 |
| DOC_{Na}/DOL_{K} | 4.0 | 3.0 | 4.3 | N.A. | 3.7 |
| Acid resistance | N.A. | N.A. | N.A. | N.A. | 1.1 |
| 5 wt % HCl 80° C. 24 h | | | | | |
| (mg/cm²) | | | | | |
| Alkali resistance | N.A. | N.A. | N.A. | N.A. | 0.6 |
| 5 wt % NaOH 80° C. 6 h | | | | | |
| (mg/cm²) | | | | | |
| K1c (SEPB) | N.A. | N.A. | N.A. | N.A. | 0.8 |
| (MPam^{0.5}) | | | | | |
| Fracture energy γ | N.A. | N.A. | N.A. | N.A. | 8.194622 |

| | No. | No. | No. | No. | No. |
|---|---|---|---|---|---|
| Component (mol %) | 248 | 249 | 250 | 251 | 252 |
| SiO₂ | 63.255 | 62.755 | 63.755 | 62.255 | 63.255 |
| Al₂O₃ | 15.63 | 18.51 | 18.51 | 18.01 | 18.01 |
| B₂O₃ | 1.7 | 0.0 | 0.0 | 0.0 | 0.0 |
| Li₂O | 7.51 | 8.65 | 7.65 | 8.65 | 7.65 |
| Na₂O | 7.49 | 8.63 | 8.63 | 8.63 | 8.63 |
| K₂O | 0.8 | 0.8 | 0.8 | 0.8 | 0.8 |
| MgO | 0.4 | 1.0 | 1.0 | 1.0 | 1.0 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 2.1 | 1.0 | 1.0 | 1.0 | 1.0 |
| Al₂O₃ + Li₂O + Na₂O + K₂O | 31.4 | 36.6 | 35.6 | 36.1 | 35.1 |
| R₂O/Al₂O₃ | 1.01 | 0.98 | 0.92 | 1.00 | 0.95 |
| Al₂O₃/(R₂O + RO) | 0.96 | 0.97 | 1.02 | 0.94 | 1.00 |
| Na₂O/Li₂O | 1.00 | 1.00 | 1.13 | 1.00 | 1.13 |
| Li₂O/Al₂O₃ | 0.48 | 0.47 | 0.41 | 0.48 | 0.42 |
| Q | −12.39 | −23.82 | −20.82 | −22.82 | −19.82 |
| X | 504 | 616 | 566 | 603 | 553 |
| Y | 18 | 19 | 20 | 19 | 19 |
| Z | 39 | 44 | 40 | 43 | 38 |
| W | 373 | 448 | 406 | 439 | 397 |
| U | 7,621 | 7,872 | 8,005 | 7,738 | 7,872 |
| ρ (g/cm³) | 2.3984 | 2.4372 | 2.4344 | 2.435 | 2.4313 |
| Ts (° C.) | 893.5 | N.A. | 932 | N.A. | N.A. |
| α_{300-380° C.} | N.A. | N.A. | N.A. | N.A. | N.A. |
| (×10⁻⁷/° C.) | | | | | |
| 10^{2.5} dPa · s (° C.) | 1,608 | 1,555 | 1,584 | 1,560 | 1,584 |
| E (GPa) | 77.4 | 81.6 | 81.2 | 81.5 | 81 |
| CS_{K} (MPa) | 1,101 | 1,354 | 1,354 | 1,312 | 1,349 |
| DOL_{K} (μm) | 25 | 23 | 24 | 23 | 25 |
| CS_{Na} (MPa) | 345 | 462 | 425 | 470 | 387 |
| CS30_{Na} (MPa) | 177 | 220 | 223 | 240 | 192 |
| DOC_{Na} (μm) | 94 | 81 | 89 | 86 | 87 |
| CTcv_{Na} (MPa) | −56 | 67 | 62 | 70 | 63 |
| DOC_{Na}/DOL_{K} | 3.8 | 3.5 | 3.7 | 3.7 | 3.5 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |

TABLE 27

| | No. | No. | No. | No. | No. |
|---|---|---|---|---|---|
| Component (mol %) | 253 | 254 | 255 | 256 | 257 |
| SiO₂ | 62.255 | 62.255 | 62.055 | 61.855 | 61.255 |
| Al₂O₃ | 18.51 | 18.51 | 19.01 | 19.01 | 18.51 |
| B₂O₃ | 0.0 | 0.0 | 0.0 | 0.0 | 0.0 |
| Li₂O | 8.65 | 7.65 | 9.15 | 8.15 | 8.65 |
| Na₂O | 7.63 | 7.63 | 8.63 | 8.63 | 8.63 |
| K₂O | 0.8 | 0.8 | 0.8 | 0.8 | 0.8 |
| MgO | 1.0 | 1.0 | 1.0 | 1.0 | 0.8 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 1.0 | 1.0 | 0.0 | 0.0 | 0.2 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 1.0 | 1.0 | 1.0 | 1.0 | 0.8 |
| Al₂O₃ + Li₂O + Na₂O + K₂O | 35.6 | 34.6 | 37.6 | 36.6 | 36.6 |
| R₂O/Al₂O₃ | 0.92 | 0.87 | 0.98 | 0.92 | 0.98 |
| Al₂O₃/(R₂O + RO) | 1.02 | 1.08 | 0.97 | 1.02 | 0.98 |
| Na₂O/Li₂O | 0.88 | 1.00 | 0.94 | 1.06 | 1.00 |
| Li₂O/Al₂O₃ | 0.47 | 0.41 | 0.48 | 0.43 | 0.47 |
| Q | −21.62 | −19.62 | −27.02 | −25.22 | −25.08 |
| X | 641 | 592 | 655 | 606 | 618 |
| Y | 18 | 19 | 19 | 19 | 19 |
| Z | 50 | 45 | 48 | 43 | 45 |
| W | 477 | 435 | 477 | 436 | 447 |
| U | 7,859 | 7,905 | 7,878 | 7,906 | 7,710 |
| ρ (g/cm³) | 2.4271 | 2.4241 | 2.4411 | 2.4384 | 2.4341 |
| Ts (° C.) | N.A. | 939 | N.A. | 923 | N.A. |
| α_{300-380° C.} | N.A. | N.A. | N.A. | N.A. | N.A. |
| (×10⁻⁷/° C.) | | | | | |
| 10^{2.5} dPa · s (° C.) | 1,559 | 1,582 | 1,539 | 1,558 | 1,559 |
| E (GPa) | 80.9 | 80.5 | 82.27 | 81.77 | 80.6 |
| CS_{K} (MPa) | 1,278 | 1,269 | 1,359 | 1,388 | 1,321 |
| DOL_{K} (μm) | 23 | 23 | 21 | 23 | 24 |
| CS_{Na} (MPa) | 478 | 409 | 471 | 409 | 347 |
| CS30_{Na} (MPa) | 230 | 204 | 238 | 219 | 211 |
| DOC_{Na} (μm) | 85 | 84 | 84 | 89 | 99 |
| CTcv_{Na} (MPa) | 66 | 59 | 69 | 65 | 67 |
| DOC_{Na}/DOL_{K} | 3.7 | 3.7 | 4.0 | 3.9 | 4.2 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |
| | No. | No. | No. | No. | No. |
| Component (mol %) | 258 | 259 | 260 | 261 | 262 |
| SiO₂ | 60.255 | 61.255 | 61.755 | 67.615 | 67.035 |
| Al₂O₃ | 18.51 | 18.51 | 18.51 | 18.51 | 18.51 |
| B₂O₃ | 0.0 | 0.0 | 0.0 | 0.0 | 0.0 |
| Li₂O | 8.65 | 8.65 | 8.65 | 8.65 | 8.65 |
| Na₂O | 8.63 | 8.63 | 8.63 | 8.63 | 8.63 |
| K₂O | 0.8 | 0.8 | 0.8 | 0.8 | 0.8 |
| MgO | 0.6 | 1.0 | 1.0 | 1.0 | 1.0 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 1.0 | 2.0 |
| SnO₂ | 0.05 | 0.05 | 0.05 | 0.05 | 0.05 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.4 | 0.2 | 0.4 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 0.6 | 1.0 | 1.0 | 1.0 | 1.0 |
| Al₂O₃ + Li₂O + Na₂O + K₂O | 36.6 | 36.6 | 36.6 | 36.6 | 36.6 |
| R₂O/Al₂O₃ | 0.98 | 0.98 | 0.98 | 0.98 | 0.98 |
| Al₂O₃/(R₂O + RO) | 0.99 | 0.97 | 0.97 | 0.97 | 0.97 |
| Na₂O/Li₂O | 1.00 | 1.00 | 1.00 | 1.00 | 1.00 |
| Li₂O/Al₂O₃ | 0.47 | 0.47 | 0.47 | 0.47 | 0.47 |
| Q | −25.84 | −25.08 | −24.34 | −18.96 | −19.54 |
| X | 620 | 618 | 617 | 609 | 609 |
| Y | 19 | 19 | 19 | 20 | 20 |
| Z | 45 | 44 | 44 | 45 | 45 |
| W | 447 | 448 | 448 | 448 | 448 |
| U | 7,592 | 7,733 | 7,768 | 8,297 | 8,246 |
| ρ (g/cm³) | 2.4313 | 2.4358 | 2.4345 | 2.4658 | 2.4942 |
| Ts (° C.) | N.A. | N.A. | N.A. | N.A. | N.A. |
| α_{300-380° C.} | N.A. | N.A. | N.A. | N.A. | N.A. |
| (×10⁻⁷/° C.) | | | | | |
| 10^{2.5} dPa · s (° C.) | 1,565 | 1,553 | 1,555 | 1,534 | 1,508 |
| E (GPa) | 80.6 | 81.2 | 81.0 | 82.2 | 83.0 |
| CS_{K} (MPa) | 1,309 | 1,320 | 1,311 | 1,436 | 1,509 |
| DOL_{K} (μm) | 25 | 23 | 23 | 20 | 18 |
| CS_{Na} (MPa) | 371 | 346 | 329 | 395 | 380 |
| CS30_{Na} (MPa) | 225 | 217 | 209 | 223 | 232 |
| DOC_{Na} (μm) | 99 | 104 | 105 | 90 | 100 |
| CTcv_{Na} (MPa) | 71 | 75 | 71 | 70 | 75 |
| DOC_{Na}/DOL_{K} | 3.9 | 4.5 | 4.5 | 4.4 | 5.5 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |

TABLE 28

| | No. | No. | No. | No. | No. |
|---|---|---|---|---|---|
| Component (mol %) | 263 | 264 | 265 | 266 | 267 |
| SiO₂ | 66.022 | 65.853 | 65.784 | 65.765 | 65.794 |
| Al₂O₃ | 18.51 | 18.51 | 10.97 | 12.50 | 14.05 |
| B₂O₃ | 0.0 | 0.0 | 0.5 | 0.9 | 1.3 |
| Li₂O | 8.65 | 8.65 | 7.95 | 7.97 | 7.99 |
| Na₂O | 8.63 | 8.63 | 7.99 | 7.82 | 7.66 |
| K₂O | 0.8 | 0.8 | 2.5 | 1.9 | 1.4 |
| MgO | 1.0 | 1.0 | 2.3 | 1.7 | 1.1 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.05 | 0.07 | 0.07 | 0.06 |
| Y₂O₃ | 0.0 | 0.0 | 0.0 | 0.0 | 0.0 |
| La₂O₃ | 1.0 | 0.5 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.1 |
| MoO₃ | 0.001 | 0.001 | 0.001 | 0.001 | 0.001 |
| B₂O₃ + MgO + CaO | 1.0 | 1.0 | 2.8 | 2.6 | 2.4 |
| Al₂O₃ + Li₂O + Na₂O + K₂O | 36.6 | 36.6 | 29.4 | 30.2 | 31.1 |
| R₂O/Al₂O₃ | 0.98 | 0.98 | 1.68 | 1.42 | 1.21 |
| Al₂O₃/(R₂O + RO) | 0.97 | 0.97 | 0.53 | 0.64 | 0.77 |
| Na₂O/Li₂O | 1.00 | 1.00 | 1.01 | 0.98 | 0.96 |
| Li₂O/Al₂O₃ | 0.47 | 0.47 | 0.72 | 0.64 | 0.57 |
| Q | −20.55 | −20.72 | 1.99 | −2.21 | −6.53 |
| X | 611 | 611 | 388 | 433 | 478 |
| Y | 20 | 20 | 16 | 17 | 18 |
| Z | 45 | 45 | 24 | 30 | 36 |
| W | 448 | 448 | 300 | 331 | 362 |
| U | 8,157 | 8,143 | 6,951 | 7,241 | 7,531 |
| ρ (g/cm³) | 2.5256 | 2.4793 | 2.4261 | 2.4213 | 2.4136 |
| Ts (° C.) | 871 | 887 | 729 | 757 | N.A. |
| α_{300-380° C.} | N.A. | N.A. | 88.3 | 84.5 | 80.9 |
| (×10⁻⁷/° C.) | | | | | |
| 10^{2.5} dPa · s (° C.) | 1,499 | 1,526 | 1,501 | 1,538 | 1,574 |
| E (GPa) | 83.9 | 82.4 | 78.2 | 78.4 | 78.6 |
| CS_{K} (MPa) | 1,454 | 1,394 | 657 | 751 | 870 |
| DOL_{K} (μm) | 17 | 19 | 18 | 18 | 19 |
| CS_{Na} (MPa) | 336 | 361 | 119 | 161 | 244 |
| CS30_{Na} (MPa) | 207 | 219 | 68 | 91 | 133 |
| DOC_{Na} (μm) | 102 | 98 | 93 | 90 | 88 |
| CTcv_{Na} (MPa) | 63 | 68 | 19 | 27 | 38 |
| DOC_{Na}/DOL_{K} | 6.1 | 5.2 | 5.1 | 5.0 | 4.7 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | 0.88 | N.A. | N.A. | N.A. | N.A. |
| (MPam^{0.5}) | | | | | |
| Fracture energy γ | 9.232567 | N.A. | N.A. | N.A. | N.A. |

| | No. | No. | No. | No. | No. |
|---|---|---|---|---|---|
| Component (mol %) | 268 | 269 | 270 | 271 | 272 |
| SiO₂ | 65.763 | 65.752 | 65.741 | 66.605 | 63.995 |
| Al₂O₃ | 15.31 | 13.65 | 14.31 | 14.97 | 15.50 |
| B₂O₃ | 1.6 | 0.4 | 0.9 | 1.3 | 1.6 |
| Li₂O | 8.01 | 2.03 | 4.03 | 6.02 | 7.61 |
| Na₂O | 7.52 | 14.56 | 12.20 | 9.84 | 7.96 |
| K₂O | 0.9 | 0.2 | 0.4 | 0.6 | 0.8 |
| MgO | 0.5 | 3.0 | 2.1 | 1.3 | 0.6 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.002 |
| ZrO₂ | 0.0 | 0.0 | 0.0 | 0.0 | 0.0 |
| SnO₂ | 0.05 | 0.13 | 0.10 | 0.08 | 0.06 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.002 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0 | 0.1 | 0.1 | 0.1 |
| MoO₃ | 0.001 | 0.001 | 0.001 | 0.001 | 0.001 |
| B₂O₃ + MgO + CaO | 2.1 | 3.4 | 3.0 | 2.6 | 2.2 |
| Al₂O₃ + Li₂O + Na₂O + K₂O | 31.7 | 30.4 | 30.9 | 31.4 | 31.9 |
| R₂O/Al₂O₃ | 1.07 | 1.23 | 1.16 | 1.10 | 1.06 |
| Al₂O₃/(R₂O + RO) | 0.90 | 0.69 | 0.76 | 0.84 | 0.91 |
| Na₂O/Li₂O | 0.94 | 7.17 | 3.03 | 1.63 | 1.05 |
| Li₂O/Al₂O₃ | 0.52 | 0.15 | 0.28 | 0.40 | 0.49 |
| Q | −9.97 | −1.70 | −4.85 | −7.00 | −12.07 |
| X | 516 | 13 | 184 | 353 | 494 |
| Y | 19 | 23 | 21 | 20 | 19 |
| Z | 41 | −36 | −10 | 16 | 37 |
| W | 388 | −87 | 73 | 234 | 362 |
| U | 7,754 | 7,443 | 7,569 | 7,774 | 7,638 |
| ρ (g/cm³) | 2.4047 | 2.4439 | 2.4333 | 2.419 | 2.4058 |
| Ts (° C.) | 863 | 869 | 852 | 852 | N.A. |
| α_{300-380° C.} | 77.2 | 87.2 | 84.4 | 80.7 | 78 |
| (×10⁻⁷/° C.) | | | | | |
| 10^{2.5} dPa · s (° C.) | 1,595 | 1,618 | 1,607 | 1,606 | 1,597 |
| E (GPa) | 78.0 | 74.4 | 77.4 | 76.8 | 77.8 |
| CS_{K} (MPa) | 1,011 | 1,147 | 1,110 | 1,071 | 1,055 |
| DOL_{K} (μm) | 20 | 28 | 24 | 22 | 22 |
| CS_{Na} (MPa) | 271 | 47 | 102 | 188 | 247 |
| CS30_{Na} (MPa) | 165 | 32 | 66 | 120 | 160 |
| DOC_{Na} (μm) | 100 | 117 | 108 | 107 | 108 |
| CTcv_{Na} (MPa) | 52 | 13 | 25 | 42 | 56 |
| DOC_{Na}/DOL_{K} | 4.9 | 4.2 | 4.6 | 4.9 | 5.0 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |

TABLE 29

| | No. | No. | No. | No. | No. |
|---|---|---|---|---|---|
| Component (mol %) | 273 | 274 | 275 | 276 | 277 |
| SiO₂ | 63.495 | 63.995 | 63.995 | 63.995 | 68.200 |
| Al₂O₃ | 15.63 | 15.63 | 15.63 | 15.63 | 9.50 |
| B₂O₃ | 1.7 | 1.7 | 1.7 | 1.7 | 0.1 |
| Li₂O | 8.01 | 8.01 | 8.01 | 8.01 | 8.00 |
| Na₂O | 7.49 | 7.49 | 7.49 | 7.49 | 8.16 |
| K₂O | 0.8 | 0.8 | 0.8 | 0.8 | 3.0 |
| MgO | 0.4 | 0.4 | 0.4 | 0.4 | 3.0 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.002 | 0.002 | 0.002 | 0.002 | 0.000 |
| ZrO₂ | 0.0 | 0.0 | 0.0 | 0.0 | 0.0 |
| SnO₂ | 0.07 | 0.10 | 0.11 | 0.12 | 0.04 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.002 | 0.002 | 0.002 | 0.002 | 0.01 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.01 |
| MoO₃ | 0.002 | 0.003 | 0.004 | 0.005 | 0 |
| B₂O₃ + MgO + CaO | 2.1 | 2.1 | 2.1 | 2.1 | 3.1 |
| Al₂O₃ + Li₂O + Na₂O + K₂O | 31.9 | 31.9 | 31.9 | 31.9 | 28.7 |
| R₂O/Al₂O₃ | 1.04 | 1.04 | 1.04 | 1.04 | 2.02 |
| Al₂O₃/(R₂O + RO) | 0.94 | 0.94 | 0.94 | 0.94 | 0.43 |
| Na₂O/Li₂O | 0.94 | 0.94 | 0.94 | 0.94 | 1.02 |
| Li₂O/Al₂O₃ | 0.51 | 0.51 | 0.51 | 0.51 | 0.84 |
| Q | −13.15 | −12.65 | −12.65 | −12.65 | 8.36 |
| X | 528 | 528 | 528 | 528 | 344 |
| Y | 18 | 18 | 18 | 18 | 16 |
| Z | 42 | 42 | 42 | 42 | 19 |
| W | 394 | 394 | 394 | 394 | 274 |
| U | 7,619 | 7,663 | 7,663 | 7,663 | 6,896 |
| ρ (g/cm³) | 2.403 | 2.4039 | 2.4047 | 2.4043 | 2.4264 |
| Ts (° C.) | 874 | 874 | 874 | 874 | 685 |
| α_{300-380° C.} | 77 | 77 | 77 | 77 | 95.9 |
| (×10⁻⁷/° C.) | | | | | |
| 10^{2.5} dPa · s (° C.) | 1,591 | 1,591 | 1,591 | 1,591 | 1,435 |
| E (GPa) | 78 | 78 | 78 | 78 | 77.4 |
| CS_{K} (MPa) | 1,057 | 1,055 | 1,072 | 1,059 | 473 |
| DOL_{K} (μm) | 22 | 22 | 22 | 22 | 20 |
| CS_{Na} (MPa) | 304 | 287 | 258 | 299 | 175 |
| CS30_{Na} (MPa) | 183 | 181 | 174 | 185 | 46 |
| DOC_{Na} (μm) | 98 | 104 | 115 | 101 | 62 |
| CTcv_{Na} (MPa) | 57 | 61 | 62 | 61 | 13 |
| DOC_{Na}/DOL_{K} | 4.4 | 4.7 | 5.2 | 4.6 | 3.1 |
| Acid resistance | N.A. | N.A. | N.A. | N.A. | 0.0 |
| 5 wt % HCl 80° C. 24 h | | | | | |
| (mg/cm²) | | | | | |
| Alkali resistance | N.A. | N.A. | N.A. | N.A. | 0.6 |
| 5 wt % NaOH 80° C. 6 h | | | | | |
| (mg/cm²) | | | | | |
| K1c (SEPB) | N.A. | N.A. | N.A. | N.A. | 0.79 |
| (MPam^{0.5}) | | | | | |
| Fracture energy γ | N.A. | N.A. | N.A. | N.A. | 8.06 |
| | No. | No. | No. | No. | No. |
| Component (mol %) | 278 | 279 | 280 | 281 | 282 |
| SiO₂ | 65.730 | 65.729 | 65.730 | 66.284 | 66.215 |
| Al₂O₃ | 15.63 | 15.63 | 15.63 | 12.49 | 13.54 |
| B₂O₃ | 1.7 | 1.7 | 1.7 | 0.8 | 1.1 |
| Li₂O | 8.01 | 8.01 | 8.01 | 2.02 | 4.02 |
| Na₂O | 7.57 | 7.57 | 7.57 | 13.24 | 11.33 |
| K₂O | 0.8 | 0.8 | 0.8 | 1.2 | 1.1 |
| MgO | 0.4 | 0.4 | 0.4 | 3.7 | 2.6 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZnO | 0.0 | 0.0 | 0.0 | 0.0 | 0.0 |
| TiO₂ | 0.003 | 0.003 | 0.001 | 0.002 | 0.000 |
| ZrO₂ | 0.0 | 0.0 | 0.0 | 0.0 | 0.0 |
| SnO₂ | 0.05 | 0.05 | 0.05 | 0.13 | 0.10 |
| Y₂O₃ | 0.0 | 0.0 | 0.0 | 0.0 | 0.0 |
| La₂O₃ | 0.0 | 0.0 | 0.0 | 0.0 | 0.0 |
| Fe₂O₃ | 0.001 | 0.001 | 0.001 | 0.002 | 0.01 |
| P₂O₅ | 0.0 | 0.0 | 0.0 | 0.0 | 0.0 |
| SO₃ | 0.0 | 0.0 | 0.0 | 0.0 | 0.0 |
| Cl | 0.1 | 0.1 | 0.1 | 0.1 | 0.01 |
| MoO₃ | 0.002 | 0.003 | 0.004 | 0.005 | 0.0 |
| B₂O₃ + MgO + CaO | 2.1 | 2.1 | 2.1 | 4.5 | 3.7 |
| Al₂O₃ + Li₂O + Na₂O + K₂O | 32.0 | 32.0 | 32.0 | 29.0 | 30.0 |
| R₂O/Al₂O₃ | 1.05 | 1.05 | 1.05 | 1.32 | 1.21 |
| Al₂O₃/(R₂O + RO) | 0.93 | 0.93 | 0.93 | 0.62 | 0.71 |
| Na₂O/Li₂O | 0.95 | 0.95 | 0.95 | 6.55 | 2.82 |
| Li₂O/Al₂O₃ | 0.51 | 0.51 | 0.51 | 0.16 | 0.30 |
| Q | −11.04 | −11.04 | −11.04 | 2.89 | −1.60 |
| X | 523 | 523 | 523 | 11 | 182 |
| Y | 19 | 19 | 19 | 21 | 20 |
| Z | 42 | 42 | 42 | −33 | −8 |
| W | 392 | 392 | 392 | −71 | 84 |
| U | 7,809 | 7,809 | 7,809 | 7,431 | 7,569 |
| ρ (g/cm³) | 2.402 | 2.4028 | 2.4046 | 2.4421 | 2.4316 |
| Ts (° C.) | 864 | 860.5 | 864 | 841.5 | 835 |
| α_{300-380° C.} | 77.4 | 77.2 | 77.3 | 88.9 | 84.9 |
| (×10⁻⁷/° C.) | | | | | |
| 10^{2.5} dPa · s (° C.) | 1,594.5 | 1,591.9 | 1,597.7 | 1,590 | 1,598 |
| E (GPa) | N.A. | N.A. | N.A. | 74.4 | 76.3 |
| CS_{K} (MPa) | 1,014 | 978 | 969 | 1,018 | 1,044 |
| DOL_{K} (μm) | 22 | 22 | 22 | 27 | 24 |
| CS_{Na} (MPa) | 278 | 251 | 270 | 25 | 102 |
| CS30_{Na} (MPa) | 176 | 161 | 171 | 21 | 61 |
| DOC_{Na} (μm) | 104 | 106 | 105 | 129 | 98 |
| CTcv_{Na} (MPa) | 62 | 57 | 57 | 10 | 20 |
| DOC_{Na}/DOL_{K} | 4.6 | 4.9 | 4.8 | 4.8 | 4.1 |
| Acid resistance | N.A. | N.A. | N.A. | N.A. | N.A. |
| 5 wt % HCl 80° C. 24 h | | | | | |
| (mg/cm²) | | | | | |
| Alkali resistance | N.A. | N.A. | N.A. | N.A. | N.A. |
| 5 wt % NaOH 80° C. 6 h | | | | | |
| (mg/cm²) | | | | | |
| K1c (SEPB) | N.A. | N.A. | N.A. | N.A. | N.A. |
| (MPam^{0.5}) | | | | | |
| Fracture energy γ | N.A. | N.A. | N.A. | N.A. | N.A. |

TABLE 30

| Component (mol %) | No. 283 | No. 284 | No. 285 |
|---|---|---|---|
| SiO₂ | 65.972 | 65.852 | 65.852 |
| Al₂O₃ | 14.58 | 15.42 | 15.63 |
| B₂O₃ | 1.4 | 1.6 | 1.7 |
| Li₂O | 6.02 | 7.61 | 8.01 |
| Na₂O | 9.41 | 7.87 | 7.49 |
| K₂O | 0.9 | 0.8 | 0.8 |
| MgO | 1.5 | 0.6 | 0.4 |
| CaO | 0.0 | 0.0 | 0.0 |
| SrO | 0.0 | 0.0 | 0.0 |
| BaO | 0.0 | 0.0 | 0.0 |
| ZnO | 0.0 | 0.0 | 0.0 |
| TiO₂ | 0.002 | 0.002 | 0.001 |
| Zro₂ | 0.0 | 0.0 | 0.0 |
| SnO₂ | 0.08 | 0.06 | 0.1 |
| Y₂O₃ | 0.0 | 0.0 | 0.0 |
| La₂O₃ | 0.0 | 0.0 | 0.0 |
| Fe₂O₃ | 0.002 | 0.002 | 0.001 |
| P₂O₅ | 0.0 | 0.0 | 0.0 |
| SO₃ | 0.0 | 0.0 | 0.0 |
| Cl | 0.1 | 0.1 | 0.1 |
| MoO₃ | 0.002 | 0.003 | 0.004 |
| B₂O₃ + MgO + CaO | 2.90 | 2.26 | 2.10 |
| Al₂O₃ + Li₂O + Na₂O + K₂O | 31.0 | 31.7 | 31.9 |
| R₂O/Al₂O₃ | 1.12 | 1.06 | 1.04 |
| Al₂O₃/(R₂O + RO) | 0.82 | 0.91 | 0.94 |
| Na₂O/Li₂O | 1.56 | 1.03 | 0.94 |
| Li₂O/Al₂O₃ | 0.41 | 0.49 | 0.51 |
| Q | −6.26 | −9.91 | −10.79 |
| X | 354 | 491 | 525 |
| Y | 20 | 19 | 19 |
| Z | 17 | 37 | 42 |
| W | 239 | 363 | 394 |
| U | 7,692 | 7,796 | 7,825 |
| ρ (g/cm³) | 2.4181 | 2.4055 | 2.4041 |
| Ts (° C.) | 841.5 | 866 | 867.5 |
| α_{300-380° C.} | 81.6 | 77.6 | 77.4 |
| (×10⁻⁷/° C.) | | | |
| 10^{2.5} dPa's (° C.) | 1,602 | 1,599 | 1,596 |
| E (GPa) | 77.1 | 77.5 | N.A. |
| CS_{K} (MPa) | 1,035 | 1,054 | 1,006 |
| DOL_{K} (μm) | 22 | 21 | 21 |
| CS_{Na} (MPa) | 182 | 264 | 246 |
| CS30_{Na} (MPa) | 115 | 164 | 159 |
| DOC_{Na} (μm) | 105 | 102 | 108 |
| CTcv_{Na} (MPa) | 39 | 55 | 58 |
| DOC_{Na}/DOL_{K} | 4.8 | 4.7 | 5.1 |
| Acid resistance | N.A. | N.A. | N.A. |
| 5 wt % HCl 80° C. 24 h | | | |
| (mg/cm²) | | | |
| Alkali resistance | N.A. | N.A. | N.A. |
| 5 wt % NaOH 80° C. 6 h | | | |
| (mg/cm²) | | | |
| K1c (SEPB) | N.A. | N.A. | N.A. |
| (MPam^{0.5}) | | | |
| Fracture energy γ | N.A. | N.A. | N.A. |

Samples in the tables were each produced as described below. First, glass raw materials were blended so as to give a glass composition shown in the table, and were melted at 1, 600° C. for 21 hours with a platinum pot. Subsequently, the resultant molten glass was poured out on a carbon sheet to be formed into a flat sheet shape, and was then cooled in a temperature region of from an annealing point to a strain point at a rate of 3° C./min. Thus, a glass sheet (glass sheet to be tempered) was obtained. The surface of the resultant glass sheet was optically polished so as to give a sheet thickness of 1.5 mm, and was then evaluated for various characteristics.

The density (ρ) is a value measured by a well-known Archimedes method.

The softening point (Ts) is a value measured based on a method of ASTM C338.

The thermal expansion coefficient (@30-380° C.) at from 30° C. to 380° C. is a value measured for an average thermal expansion coefficient with a dilatometer.

The temperature (10^{2.5} dPa·s) at a viscosity at high temperature of 10^{2.5} dPa·s is a value measured by a platinum sphere pull up method.

The Young's modulus (E) is a value calculated by a method in conformity with JIS R 1602-1995 “Testing methods for elastic modulus of fine ceramics.”

Subsequently, each of the untempered glass sheets (glass sheets to be tempered) was subjected to ion exchange treatment by being immersed in a KNO₃ molten salt at 430° C. for 4 hours. Thus, a tempered glass sheet having a compressive stress layer in a surface thereof was obtained. After that, the glass surface was washed, and the compressive stress value (CSK) of the compressive stress layer on the outermost surface and the depth of layer (DOL_{K}) thereof were calculated based on the number of interference fringes observed with a surface stress meter FSM-6000 (manufactured by Orihara Industrial Co., Ltd.) and intervals therebetween. Herein, the DOL_{K} is the depth of the compressive stress layer obtained through ion exchange with the KNO₃ molten salt.

In addition, each of the untempered glass sheets (glass sheets to be tempered) was subjected to ion exchange treatment by being immersed in a NaNO₃ molten salt at 380° C. for 1 hour. Thus, a tempered glass sheet was obtained. After that, the glass surface was washed, and the compressive stress value (CS_{Na}) of a compressive stress layer on the outermost surface, the compressive stress value (CS30Na) thereof at a depth of 30 μm, the depth of compression (DOC_{Na}) thereof, and the internal tensile stress value (CTcv_{Na}) thereof were calculated from a retardation distribution curve observed with a scattered light photoelastic stress meter SLP-2000 (manufactured by Orihara Industrial Co., Ltd.). Herein, the DOC_{Na} is the depth of the compressive stress layer obtained through ion exchange with the NaNO₃ molten salt, and is a depth at which the stress value becomes zero.

In an acid resistance test, acid resistance was evaluated as described below. A glass sample having been subjected to mirror polishing treatment on both sides so as to give dimensions of 50 mm×10 mm×1.0 mm was used as a measurement sample. The sample was sufficiently washed with a neutral detergent and pure water, and was then immersed in a 5 mass % HCl aqueous solution warmed to 80° C. for 24 hours. A mass loss (mg/cm²) per unit surface area before and after the immersion was calculated.

In an alkali resistance test, alkali resistance was evaluated as described below. A glass sample having been subjected to mirror polishing treatment on both sides so as to give dimensions of 50 mm×10 mm×1.0 mm was used as a measurement sample. The sample was sufficiently washed with a neutral detergent and pure water, and was then immersed in a 5 mass % NaOH aqueous solution warmed to 80° C. for 6 hours. A mass loss (mg/cm²) per unit surface area before and after the immersion was calculated.

The fracture toughness (K1c) is a value measured by a SEPB method based on JIS R 1607 “Testing methods for fracture toughness of fine ceramics.” The fracture toughness value of each of the samples was determined as an average for 3 points.

As apparent from Tables 1 to 30, each of the tempered glass sheets of Samples Nos. 001 to 102 and Nos. 104 to 285 had a proper content of [B₂O₃]+[MgO]+[CaO] and a proper molar ratio ([Li₂O]+[Na₂O]+[K₂O])/[Al₂O₃], and hence had a compressive stress value (CS_{Na}) of the compressive stress layer on the outermost surface and a compressive stress value (CS30_{Na}) thereof at a depth of 30 μm from the outermost surface as high as 202 MPa or more and 41 MPa or more, respectively, when having been subjected to ion exchange treatment with NaNO₃. Accordingly, it is conceived that a stress profile having an inflection point as shown in FIG. 3 is easily made, and each of the tempered glass sheets is less liable to be broken than that of Sample No. 103 serving as Comparative Example at the time of dropping.

Further, when the glass sheet (glass sheet to be tempered) according to No. 071 was immersed in a NaNO₃ molten salt at 380° C. for 4.5 hours, and was then immersed in a KNO₃ molten salt at 430° C. for 30 minutes, it was recognized that the compressive stress value CS of the compressive stress layer on the outermost surface and the compressive stress value CS30 thereof at a depth of 30 μm from the outermost surface were 768 MPa and 148 MPa, respectively, and were further improved.

In addition, when the glass sheet (glass sheet to be tempered) according to No. 106 was immersed in a NaNO₃ molten salt at 380° C. for 2 hours, and was then immersed in a 92.5 mass % KNO₃ and 7.5 mass % NaNO₃ mixed molten salt at 410° C. for 24 minutes, it was recognized that the compressive stress value CS of the compressive stress layer on the outermost surface and the compressive stress value CS30 thereof at a depth of 30 μm from the outermost surface were 873 MPa and 154 MPa, respectively, and were further improved.

In addition, when the glass sheet (glass sheet to be tempered) according to No. 247 was immersed in a NaNO₃ molten salt at 380° C. for 77 minutes, and was then immersed in a 92.5 mass % KNO₃ and 7.5 mass % NaNO₃ mixed molten salt at 410° C. for 25 minutes, it was recognized that the compressive stress value CS of the compressive stress layer on the outermost surface and the compressive stress value CS30 thereof at a depth of 30 μm from the outermost surface were 878 MPa and 167 MPa, respectively, and were further improved.

### EXAMPLE 2

An untempered glass sheet (glass sheet to be tempered) having the same composition as that of Sample No. 071 of Example 1 and having a thickness of 0.7 mm was immersed in a NaNO₃ molten salt at 380° C. for 540 minutes, and was then immersed in a KNO₃ molten salt at 430° C. for a time period shown in Table 31. Thus, a tempered glass sheet was obtained.

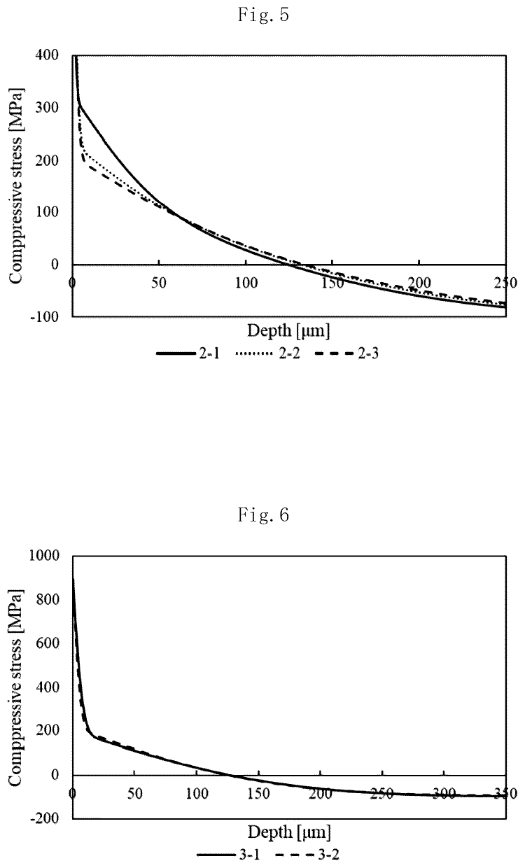

Further, the resultant tempered glass sheet was measured for its stress profile with a scattered light photoelastic stress meter SLP-2000 (manufactured by Orihara Industrial Co., Ltd.) and a surface stress meter FSM-6000 (manufactured by Orihara Industrial Co., Ltd.). FIG. 4 is a graph showing the general view of stress profiles of Examples 2-1 to 2-3, and FIG. 5 is a graph showing low compressive stress regions in the stress profiles of FIG. 4 in an enlarged manner. The stress profile of the tempered glass sheet on one of main surfaces thereof is shown in each of FIG. 4 and FIG. 5, but a similar stress profile was observed also on the other surface thereof.

The tempering conditions and glass characteristics of Examples 2-1 to 2-3 are shown in Table 31. In the table, the term “SPP-4PB” means abraded four-point bending strength.

TABLE 31

| Example number | | 2-1 | 2-2 | 2-3 |
|---|---|---|---|---|
| Thickness (mm) | | 0.7 | 0.7 | 0.7 |
| First ion | Molten salt for | NaNO₃ | NaNO₃ | NaNO₃ |
| exchange | tempering | | | |
| | Temperature of | 380 | 380 | 380 |
| | molten salt (° C.) | | | |
| | Tempering time | 540 | 540 | 540 |
| | period (min) | | | |
| Second ion | Molten salt for | KNO₃ | KNO₃ | KNO₃ |
| exchange | tempering | | | |
| | Temperature of | 430 | 430 | 430 |
| | molten salt (C) | | | |
| | Tempering time | 15 | 30 | 45 |
| | period (min) | | | |

| | | | |
|---|---|---|---|
| CS (MPa) | 853 | 815 | 772 |
| De (μm) | 3.4 | 5.1 | 5.9 |
| DOC (μm) | 125 | 132 | 134 |
| CT (MPa) | 94 | 91 | 89 |
| CS30 (MPa) | 189 | 158 | 148 |
| CS50 (MPa) | 121 | 114 | 111 |
| SPP-4PB (MPa) | 227 | 206 | 199 |

For each of the samples (Examples 2-1 to 2-3), the glass surface was washed, and the compressive stress value (CS) of a compressive stress layer on the outermost surface and the depth De of an inflection point were calculated with a surface stress meter FSM-6000 (manufactured by Orihara Industrial Co., Ltd.). In the table, the value of the depth (De) of the inflection point represents the value of the diffusion depth DOL of a K ion obtained with FSM-6000 (De=DOL). In such a tempered glass sheet as those of Examples 2-1 to 2-3 of the present invention, that is, a tempered glass sheet in which a Li ion in the glass and a Na ion in the molten salt have been exchanged (K ion has not been exchanged) through first ion exchange, and a Na ion in the glass and a K ion in the molten salt have been exchanged through second ion exchange, the depth De of the inflection point “e” roughly coincides with the diffusion depth DOL of a K ion.

In addition, the compressive stress values (CS30 and CS50) of the compressive stress layer at depths of 30 μm and 50 μm, the depth of compression (DOC) thereof, and the internal tensile stress value (CT) thereof were calculated from a retardation distribution curve observed with a scattered light photoelastic stress meter SLP-2000 (manufactured by Orihara Industrial Co., Ltd.).

The abraded four-point bending strength was measured by the following procedure. First, the glass was abraded by the following procedure. The tempered glass sheet having been processed into a size of 50 mm×50 mm and a thickness shown in Table 31 was fixed to a SUS plate having a thickness of 1.5 mm under the state in which the tempered glass sheet was turned vertically, and the tip of a pendular arm was caused to collide with the glass sheet through P180 grid sandpaper to abrade the glass sheet. The tip of the arm is an iron-made cylinder of ¢5 mm, and the arm has a weight of 550 g. The height from which the arm was swung down was set to 5 mm from a collision point. Next, the abraded sample was measured for strength by being subjected to a four-point bending test according to JIS R 1601 (1995).

As apparent from Table 31 and FIG. 4 and FIG. 5, in each of the tempered glass sheets of Examples 2-1 to 2-3 had a compressive stress value (CS) of the compressive stress layer on the outermost surface and a compressive stress value (CS30) thereof at a depth of 30 μm from the outermost surface as high as 815 MPa or more and 148 MPa or more, respectively. In addition, the abraded four-point bending strength is as high as 199 MPa or more, and hence it is conceived that each of the tempered glass sheets is less liable to be broken at the time of dropping.

### EXAMPLE 3

An untempered glass sheet (glass sheet to be tempered) having the same composition as that of each of Samples No. 106 and No. 247 of Example 1 and having a thickness of 0.7 mm was immersed in a NaNO₃ molten salt at 380° C. for a time period shown in Table 32, and was then immersed in a KNO₃ molten salt at 430° C. for a time period shown in Table 32. Thus, a tempered glass sheet was obtained.

Further, the resultant tempered glass sheet was measured for its stress profile by the same method as in Example 2. FIG. 6 is a graph showing the general view of stress profiles of Examples 3-1 and 3-2, and FIG. 7 is a graph showing low compressive stress regions in the stress profiles of FIG. 6 in an enlarged manner.

The tempering conditions and glass characteristics of Examples 3-1 and 3-2 are shown in Table 32.

TABLE 32

| | | |
|---|---|---|
| Example number | 3-1 | 3-2 |

| Sample No. | | | No. 106 | No. 247 |
|---|---|---|---|---|
| Thickness (mm) | | | 0.7 | 0.7 |
| | First ion | Molten salt for | NaNO₃ | NaNO₃ |
| | exchange | tempering | | |
| | | Temperature of | 380 | 380 |
| | | molten salt (° C.) | | |
| | | Tempering time | 120 | 210 |
| | | period (min) | | |
| | Second ion | Molten salt for | KNO₃ | KNO₃ |
| | exchange | tempering | | |
| | | Temperature of | 410 | 410 |
| | | molten salt (° C.) | | |
| | | Tempering time | 24 | 25 |
| | | period (min) | | |

| | | |
|---|---|---|
| CS (MPa) | 892 | 898 |
| De (μm) | 5.5 | 5.8 |
| DOC (μm) | 127 | 126 |
| CT (MPa) | 95 | 93 |
| CS30 (MPa) | 146 | 156 |
| CS50 (MPa) | 111 | 118 |
| SPP-4PB (MPa) | 206 | 199 |

Each of the samples (Examples 3-1 and 3-2) was measured for the stress values and the depth of compression, and was then measured for the abraded four-point bending strength by the same methods as in Example 2.

As apparent from Table 32 and FIG. 6 and FIG. 7, each of the tempered glass sheets of Examples 3-1 and 3-2 had a compressive stress value (CS) of the compressive stress layer on the outermost surface and a compressive stress value (CS30) thereof at a depth of 30 μm from the outermost surface as high as 892 MPa or more and 146 MPa or more, respectively. In addition, the abraded four-point bending strength is as high as 199 MPa or more, and hence it is conceived that each of the tempered glass sheets is less liable to be broken at the time of dropping.

### EXAMPLE 4

An untempered glass sheet (glass sheet to be tempered) having the same composition as that of Sample No. 277 of Example 1 and having a thickness of 0.7 mm was immersed in a NaNO₃ molten salt at 380° C. for a time period shown in Table 33, and was then immersed in a KNO₃ molten salt at 430° C. for a time period shown in Table 33. Thus, a tempered glass sheet was obtained.

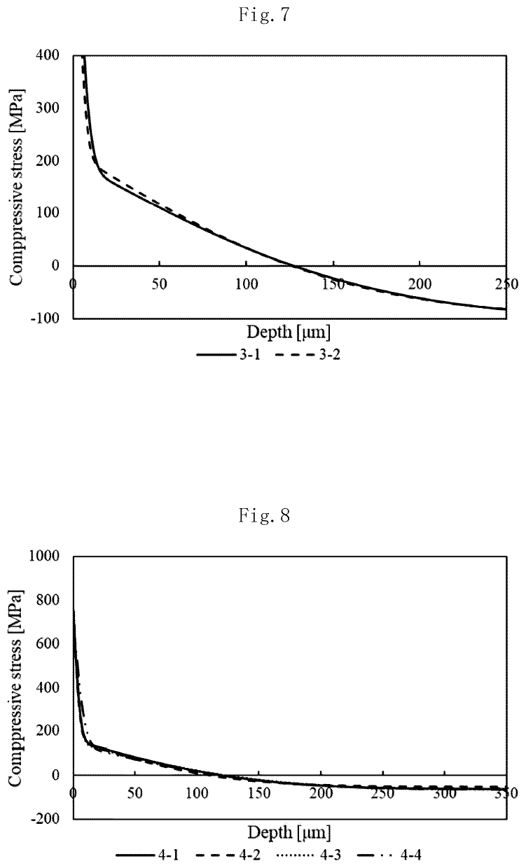

Further, the resultant tempered glass sheet was measured for its stress profile by the same method as in Example 2. FIG. 8 is a graph showing the general view of stress profiles of Examples 4-1 to 4-4, and FIG. 9 is a graph showing low compressive stress regions in the stress profiles of FIG. 8 in an enlarged manner.

The tempering conditions and glass characteristics of Examples 4-1 to 4-4 are shown in Table 33.

TABLE 33

| Example number | | 4-1 | 4-2 | 4-3 | 4-4 |
|---|---|---|---|---|---|
| Sample No. | | No. 277 | | | |
| Thickness (mm) | | 0.7 | 0.7 | 0.7 | 0.7 |
| First ion | Molten salt for | NaNO₃ | NaNO₃ | NaNO₃ | NaNO₃ |
| exchange | tempering | | | | |
| | Temperature of | 380 | 380 | 380 | 380 |
| | molten salt (° C.) | | | | |
| | Tempering time | 2,780 | 600 | 4,320 | 2,780 |
| | period (min) | | | | |
| Second ion | Molten salt for | KNO₃ | KNO₃ | KNO₃ | KNO₃ |
| exchange | tempering | | | | |
| | Temperature of | 380 | 380 | 380 | 380 |
| | molten salt (° C.) | | | | |
| | Tempering time | 105 | 150 | 105 | 210 |
| | period (min) | | | | |

| | | | | |
|---|---|---|---|---|
| CS (MPa) | 739 | 735 | 766 | 713 |
| De (μm) | 6.6 | 7.0 | 6.6 | 8.8 |
| DOC (μm) | 120 | 98 | 124 | 120 |
| CT (MPa) | 62 | 42 | 64 | 64 |
| CS30 (MPa) | 113 | 91 | 107 | 99 |
| CS50 (MPa) | 83 | 58 | 80 | 74 |
| SPP-4PB (MPa) | 167 | 152 | 163 | 158 |

Each of the samples (Examples 4-1 to 4-4) was measured for the stress values and the depth of compression, and was then measured for the abraded four-point bending strength by the same methods as in Example 2.

As apparent from Table 33 and FIG. 8 and FIG. 9, the tempered glass sheet of Example 4-1 had a compressive stress value (CS) of the compressive stress layer on the outermost surface and a compressive stress value (CS30) thereof at a depth of 30 μm from the outermost surface as high as 739 MPa and 113 MPa, respectively. In addition, the abraded four-point bending strength is as high as 167 MPa, and hence it is conceived that the tempered glass sheet is less liable to be broken at the time of dropping.

### EXAMPLE 5

An Untempered glass sheet (glass sheet to be tempered) having the same composition as that of the sample described in Example 1 (the number of the sample is shown in each of Tables 34 to 41) and having a thickness of 0.7 mm was immersed in a molten salt shown in each of Tables 34 to 41 for a time period shown therein. Thus, a tempered glass sheet having been subjected to two-step ion exchange was obtained.

The tempering conditions and glass characteristics of Examples 5-1 to 5-86 are shown in Tables 34 to 41.

TABLE 34

| | | Example number | | | | | | | | | |
|---|---|---|---|---|---|---|---|---|---|---|---|
| | | 5-1 | 5-2 | 5-3 | 5-4 | 5-5 | 5-6 | 5-7 | 5-8 | 5-9 | 5-10 |
| Sample No. | | No. 001 | No. 008 | No. 036 | No. 038 | No. 044 | No. 051 | No. 053 | No. 055 | No. 065 | No. 067 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 240 | 300 | 180 | 180 | 90 | 150 | 210 | 300 | 270 | 270 |
| | period (min) | | | | | | | | | | |
| Second | Molten salt | 100/0 | 100/0 | 100/0 | 100/0 | 100/0 | 100/0 | 100/0 | 100/0 | 100/0 | 100/0 |
| ion | for tempering | | | | | | | | | | |
| exchange | (KNO₃/NaNO₃) | | | | | | | | | | |
| | Temperature of | 430 | 430 | 430 | 430 | 430 | 430 | 430 | 430 | 430 | 430 |
| | molten salt | | | | | | | | | | |
| | (° C.) | | | | | | | | | | |
| | Tempering time | 30 | 30 | 60 | 75 | 30 | 45 | 75 | 75 | 30 | 30 |
| | period (min) | | | | | | | | | | |

| | | | | | | | | | | |
|---|---|---|---|---|---|---|---|---|---|---|
| CS30₁ₛₜ (MPa) | 163 | 163 | 155 | 159 | 153 | 217 | 212 | 231 | 167 | 181 |
| CS30_{2nd} (MPa) | 116 | 95 | 68 | 74 | 77 | 92 | 80 | 125 | 106 | 107 |
| CS30_{Drop} (MPa) | 47 | 68 | 86 | 85 | 76 | 124 | 132 | 106 | 61 | 75 |
| CS30_{Drop rate} | 0.29 | 0.42 | 0.56 | 0.53 | 0.50 | 0.57 | 0.62 | 0.46 | 0.36 | 0.41 |
| DOC_{Na}/DOL_{K} | 4.8 | 5.1 | 7.1 | 8.0 | 6.1 | 6.6 | 8.7 | 9.0 | 5.7 | 5.9 |

TABLE 35

| | | Example number | | | | | | | | | |
|---|---|---|---|---|---|---|---|---|---|---|---|
| | | 5-11 | 5-12 | 5-13 | 5-14 | 5-15 | 5-16 | 5-17 | 5-18 | 5-19 | 5-20 |
| Sample No. | | No. 068 | No. 069 | No. 071 | No. 072 | No. 073 | No. 074 | No. 075 | No. 076 | No. 077 | No. 078 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 180 | 180 | 210 | 150 | 180 | 300 | 450 | 180 | 210 | 180 |
| | period (min) | | | | | | | | | | |
| Second | Molten salt | 100/0 | 100/0 | 100/0 | 100/0 | 100/0 | 97.5/2.5 | 100/0 | 100/0 | 100/0 | 100/0 |
| ion | for tempering | | | | | | | | | | |
| exchange | (KNO₃/NaNO₃) | | | | | | | | | | |
| | Temperature of | 430 | 430 | 430 | 430 | 430 | 380 | 430 | 430 | 430 | 430 |
| | molten salt | | | | | | | | | | |
| | (° C.) | | | | | | | | | | |
| | Tempering time | 45 | 60 | 45 | 45 | 45 | 180 | 45 | 60 | 60 | 45 |
| | period (min) | | | | | | | | | | |

| | | | | | | | | | | |
|---|---|---|---|---|---|---|---|---|---|---|
| CS30₁ₛₜ (MPa) | 195 | 207 | 187 | 213 | 230 | 177 | 207 | 180 | 192 | 195 |
| CS30_{2nd} (MPa) | 107 | 92 | 118 | 84 | 109 | 106 | 137 | 81 | 96 | 98 |
| CS30_{Drop} (MPa) | 89 | 115 | 69 | 129 | 121 | 71 | 70 | 98 | 96 | 97 |
| CS30_{Drop rate} | 0.45 | 0.56 | 0.37 | 0.61 | 0.53 | 0.40 | 0.34 | 0.55 | 0.50 | 0.50 |
| DOC_{Na}/DOL_{K} | 6.9 | 7.1 | 6.9 | 6.8 | 7.1 | 6.3 | 6.5 | 8.7 | 7.7 | 7.5 |

TABLE 36

| | | Example number | | | | | | | | | |
|---|---|---|---|---|---|---|---|---|---|---|---|
| | | 5-21 | 5-22 | 5-23 | 5-24 | 5-25 | 5-26 | 5-27 | 5-28 | 5-29 | 5-30 |
| Sample No. | | No. 079 | No. 080 | No. 081 | No. 084 | No. 085 | No. 086 | No. 087 | No. 088 | No. 089 | No. 090 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 210 | 120 | 150 | 240 | 300 | 240 | 360 | 240 | 240 | 180 |
| | period (min) | | | | | | | | | | |
| Second | Molten salt | 100/0 | 100/0 | 100/0 | 95/5 | 95/5 | 95/5 | 95/5 | 95/5 | 95/5 | 95/5 |
| ion | for tempering | | | | | | | | | | |
| exchange | (KNO₃/NaNO₃) | | | | | | | | | | |
| | Temperature of | 430 | 430 | 430 | 410 | 410 | 410 | 410 | 410 | 410 | 410 |
| | molten salt | | | | | | | | | | |
| | (° C.) | | | | | | | | | | |
| | Tempering time | 45 | 30 | 45 | 60 | 90 | 120 | 105 | 60 | 75 | 60 |
| | period (min) | | | | | | | | | | |

| | | | | | | | | | | |
|---|---|---|---|---|---|---|---|---|---|---|
| CS30₁ₛₜ (MPa) | 201 | 140 | 188 | 171 | 199 | 214 | 205 | 203 | 227 | 221 |
| CS30_{2nd} (MPa) | 107 | 78 | 79 | 108 | 108 | 122 | 111 | 137 | 133 | 137 |
| CS30_{Drop} (MPa) | 94 | 62 | 109 | 63 | 92 | 93 | 94 | 65 | 94 | 85 |
| CS30_{Drop rate} | 0.47 | 0.44 | 0.58 | 0.37 | 0.46 | 0.43 | 0.46 | 0.32 | 0.41 | 0.38 |
| DOC_{Na}/DOL_{K} | 7.0 | 6.9 | 7.5 | 7.1 | 7.0 | 8.1 | 7.6 | 7.1 | 6.7 | 8.0 |

TABLE 37

| | | Example number | | | | | | | | | |
|---|---|---|---|---|---|---|---|---|---|---|---|
| | | 5-31 | 5-32 | 5-33 | 5-34 | 5-35 | 5-36 | 5-37 | 5-38 | 5-39 | 5-40 |
| Sample No. | | No. 091 | No. 092 | No. 093 | No. 093 | No. 098 | No. 208 | No. 208 | No. 213 | No. 214 | No. 215 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 240 | 240 | 240 | 240 | 180 | 120 | 120 | 240 | 240 | 120 |
| | period (min) | | | | | | | | | | |
| Second | Molten salt | 95/5 | 95/5 | 95/5 | 100/0 | 92.5/7.5 | 92.5/7.5 | 92.5/7.5 | 97.5/2.5 | 97.5/2.5 | 97.5/2.5 |
| ion | for tempering | | | | | | | | | | |
| exchange | (KNO₃/NaNO₃) | | | | | | | | | | |
| | Temperature of | 410 | 410 | 410 | 380 | 380 | 410 | 410 | 410 | 410 | 410 |
| | molten salt | | | | | | | | | | |
| | (° C.) | | | | | | | | | | |
| | Tempering time | 90 | 75 | 60 | 120 | 55 | 24 | 24 | 30 | 30 | 30 |
| | period (min) | | | | | | | | | | |

| | | | | | | | | | | |
|---|---|---|---|---|---|---|---|---|---|---|
| CS30₁ₛₜ (MPa) | 191 | 205 | 190 | 267 | 205 | 196 | 196 | 176 | 218 | 200 |
| CS30_{2nd} (MPa) | 103 | 124 | 120 | 164 | 158 | 143 | 146 | 138 | 152 | 125 |
| CS30_{Drop} (MPa) | 88 | 81 | 70 | 102 | 48 | 54 | 51 | 38 | 66 | 75 |
| CS30_{Drop rate} | 0.46 | 0.40 | 0.37 | 0.38 | 0.23 | 0.27 | 0.26 | 0.22 | 0.30 | 0.38 |
| DOC_{Na}/DOL_{K} | 8.8 | 7.5 | 7.5 | 6.0 | 4.5 | 4.5 | 4.2 | 4.5 | 4.8 | 4.0 |

TABLE 38

| | | Example number | | | | | | | | | |
|---|---|---|---|---|---|---|---|---|---|---|---|
| | | 5-41 | 5-42 | 5-43 | 5-44 | 5-45 | 5-46 | 5-47 | 5-48 | 5-49 | 5-50 |
| Sample No. | | No. 216 | No. 217 | No. 218 | No. 219 | No. 221 | No. 222 | No. 223 | No. 224 | No. 225 | No. 226 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 180 | 120 | 240 | 180 | 180 | 240 | 120 | 180 | 240 | 120 |
| | period (min) | | | | | | | | | | |
| Second | Molten salt | 97.5/2.5 | 97.5/2.5 | 97.5/2.5 | 97.5/2.5 | 97.5/2.5 | 97.5/2.5 | 97.5/2.5 | 92.5/7.5 | 97.5/2.5 | 97.5/2.5 |
| ion | for tempering | | | | | | | | | | |
| exchange | (KNO₃/NaNO₃) | | | | | | | | | | |
| | Temperature of | 410 | 410 | 410 | 410 | 410 | 410 | 410 | 410 | 410 | 410 |
| | molten salt | | | | | | | | | | |
| | (° C.) | | | | | | | | | | |
| | Tempering time | 30 | 15 | 45 | 30 | 45 | 30 | 30 | 25 | 30 | 15 |
| | period (min) | | | | | | | | | | |

| | | | | | | | | | | |
|---|---|---|---|---|---|---|---|---|---|---|
| CS30₁ₛₜ (MPa) | 192 | 200 | 207 | 148 | 202 | 176 | 196 | 168 | 182 | 159 |
| CS30_{2nd} (MPa) | 144 | 151 | 141 | 90 | 131 | 133 | 128 | 147 | 99 | 125 |
| CS30_{Drop} (MPa) | 47 | 50 | 66 | 57 | 71 | 43 | 68 | 21 | 83 | 34 |
| CS30_{Drop rate} | 0.25 | 0.25 | 0.32 | 0.39 | 0.35 | 0.24 | 0.35 | 0.13 | 0.46 | 0.21 |
| DOC_{Na}/DOL_{K} | 4.8 | 4.3 | 5.4 | 4.2 | 4.6 | 4.2 | 4.4 | 2.9 | 4.0 | 3.3 |

TABLE 39

| | | Example number | | | | | | | | | |
|---|---|---|---|---|---|---|---|---|---|---|---|
| | | 5-51 | 5-52 | 5-53 | 5-54 | 5-55 | 5-56 | 5-57 | 5-58 | 5-59 | 5-60 |
| Sample No. | | No. 227 | No. 228 | No. 229 | No. 230 | No. 231 | No. 232 | No. 233 | No. 235 | No. 236 | No. 237 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 180 | 180 | 240 | 180 | 240 | 360 | 180 | 120 | 180 | 180 |
| | period (min) | | | | | | | | | | |
| Second | Molten salt | 97.5/2.5 | 97.5/2.5 | 97.5/2.5 | 97.5/2.5 | 97.5/2.5 | 97.5/2.5 | 97.5/2.5 | 97.5/2.5 | 97.5/2.5 | 97.5/2.5 |
| ion | for tempering | | | | | | | | | | |
| exchange | (KNO₃/NaNO₃) | | | | | | | | | | |
| | Temperature of | 410 | 410 | 410 | 410 | 410 | 410 | 410 | 410 | 410 | 410 |
| | molten salt | | | | | | | | | | |
| | (° C.) | | | | | | | | | | |
| | Tempering time | 30 | 30 | 30 | 45 | 45 | 75 | 25 | 25 | 60 | 25 |
| | period (min) | | | | | | | | | | |

| | | | | | | | | | | |
|---|---|---|---|---|---|---|---|---|---|---|
| CS30₁ₛₜ (MPa) | 245 | 264 | 277 | 295 | 268 | 337 | 173 | 197 | 192 | 187 |
| CS30_{2nd} (MPa) | 175 | 175 | 210 | 211 | 211 | 246 | 126 | 127 | 118 | 130 |
| CS30_{Drop} (MPa) | 70 | 89 | 67 | 84 | 57 | 91 | 46 | 70 | 74 | 57 |
| CS30_{Drop rate} | 0.29 | 0.34 | 0.24 | 0.28 | 0.21 | 0.27 | 0.27 | 0.36 | 0.39 | 0.31 |
| DOC_{Na}/DOL_{K} | 4.3 | 4.5 | 4.7 | 4.9 | 5.1 | 6.3 | 4.6 | 4.5 | 5.7 | 4.4 |

TABLE 40

| | | Example number | | | | | | | | | |
|---|---|---|---|---|---|---|---|---|---|---|---|
| | | 5-61 | 5-62 | 5-63 | 5-64 | 5-65 | 5-66 | 5-67 | 5-68 | 5-69 | 5-70 |
| Sample No. | | No. 238 | No. 239 | No. 240 | No. 241 | No. 242 | No. 243 | No. 244 | No. 245 | No. 247 | No. 248 |
| Thickness (mm) | | 0.7 | 0.7 | 0.7 | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 | 0/100 | 0/100 | 0/100 |
| ion | for tempering | | | | | | | | | | |
| exchange | (KNO₃/NaNO₃) | | | | | | | | | | |
| | Temperature of | 380 | 380 | 380 | 380 | 380 | 380 | 380 | 380 | 380 | 380 |
| | molten salt | | | | | | | | | | |
| | (° C.) | | | | | | | | | | |
| | Tempering time | 180 | 180 | 180 | 180 | 180 | 180 | 240 | 180 | 90 | 180 |
| | period (min) | | | | | | | | | | |
| Second | Molten salt | 97.5/2.5 | 97.5/2.5 | 97.5/2.5 | 97.5/2.5 | 97.5/2.5 | 97.5/2.5 | 97.5/2.5 | 97.5/2.5 | 92.5/7.5 | 97.5/2.5 |
| ion | for tempering | | | | | | | | | | |
| exchange | (KNO₃/NaNO₃) | | | | | | | | | | |
| | Temperature of | 410 | 410 | 410 | 410 | 410 | 410 | 410 | 410 | 410 | 410 |
| | molten salt | | | | | | | | | | |
| | (° C.) | | | | | | | | | | |
| | Tempering time | 30 | 30 | 45 | 15 | 25 | 25 | 20 | 30 | 25 | 15 |
| | period (min) | | | | | | | | | | |

| | | | | | | | | | | |
|---|---|---|---|---|---|---|---|---|---|---|
| CS30₁ₛₜ (MPa) | 176 | 241 | 250 | 189 | 222 | 194 | 184 | 215 | 187 | 185 |
| CS30_{2nd} (MPa) | 122 | 168 | 157 | 140 | 156 | 154 | 136 | 134 | 151 | 139 |
| CS30_{Drop} (MPa) | 54 | 73 | 93 | 49 | 66 | 40 | 48 | 81 | 36 | 46 |
| CS30_{Drop rate} | 0.31 | 0.30 | 0.37 | 0.26 | 0.30 | 0.21 | 0.26 | 0.38 | 0.19 | 0.25 |
| DOC_{Na}/DOL_{K} | 4.6 | 4.3 | 5.0 | 3.4 | 4.4 | 3.9 | 3.0 | 4.3 | 3.7 | 3.8 |

TABLE 41

| | | Example number | | | | | | |
|---|---|---|---|---|---|---|---|---|
| | | 5-71 | 5-72 | 5-73 | 5-74 | 5-75 | 5-76 | 5-77 |
| Sample No. | | No. 249 | No. 250 | No. 252 | No. 253 | No. 254 | No. 255 | No. 256 |
| Thickness (mm) | | 0.7 | 0.7 | 0.7 | 0.7 | 0.7 | 0.7 | 0.7 |
| First | Molten salt | 0/100 | 0/100 | 0/100 | 0/100 | 0/100 | 0/100 | 0/100 |
| ion | for tempering | | | | | | | |
| exchange | (KNO₃/NaNO₃) | | | | | | | |
| | Temperature of | 380 | 380 | 380 | 380 | 380 | 380 | 380 |
| | molten salt | | | | | | | |
| | (° C.) | | | | | | | |
| | Tempering time | 90 | 90 | 90 | 90 | 90 | 90 | 90 |
| | period (min) | | | | | | | |
| Second | Molten salt | 92.5/7.5 | 92.5/7.5 | 92.5/7.5 | 92.5/7.5 | 92.5/7.5 | 92.5/7.5 | 92.5/7.5 |
| ion | for tempering | | | | | | | |
| exchange | (KNO₃/NaNO₃) | | | | | | | |
| | Temperature of | 410 | 410 | 410 | 410 | 410 | 410 | 410 |
| | molten salt | | | | | | | |
| | (° C.) | | | | | | | |
| | Tempering time | 30 | 30 | 30 | 30 | 30 | 35 | 35 |
| | period (min) | | | | | | | |

| | | | | | | | |
|---|---|---|---|---|---|---|---|
| CS30₁ₛₜ (MPa) | 246 | 215 | 206 | 226 | 210 | 251 | 225 |
| CS30_{2nd} (MPa) | 199 | 168 | 157 | 173 | 162 | 200 | 191 |
| CS30_{Drop} (MPa) | 47 | 47 | 49 | 53 | 48 | 51 | 34 |
| CS30_{Drop rate} | 0.19 | 0.22 | 0.24 | 0.24 | 0.23 | 0.20 | 0.15 |
| DOC_{Na}/DOL_{K} | 3.6 | 3.7 | 3.5 | 3.7 | 3.6 | 3.9 | 3.9 |

For each of the resultant samples (Examples 5-1 to 5-86), the tempered glass sheet after first ion exchange was measured for its compressive stress value (CS30₁ₛₜ) at a depth of 30 μm, and the tempered glass sheet after second ion exchange was measured for its compressive stress value (CS30_{2nd}) at a depth of 30 μm with a scattered light photoelastic stress meter SLP-2000 (manufactured by Orihara Industrial Co., Ltd.), and a compressive stress drop rate (CS30_{Droprate}) at a depth of 30 μm was calculated.

As apparent from Tables 34 to 41, each of the tempered glass sheets of Examples 5-1 to 5-86 had a compressive stress drop rate (CS30_{Droprate}) as low as 0.61 or less. It is conceived that a stress profile having an inflection point as illustrated in FIG. 3 is easily made, and each of the tempered glass sheets is less liable to be broken at the time of dropping.

### EXAMPLE 6

Each of Samples No. 055, No. 072, No. 106, No. 116, and No. 247 of Example 1 was measured for a Na ion mutual diffusion coefficient D_{Na} and a K ion mutual diffusion coefficient D_{K}.

First, a glass sheet to be tempered having the same composition as that of each of the above-mentioned samples was prepared, and was ion exchanged with 100% NaNO₃ at 380° C. for a time period “t” shown in Table 42. Thus, a tempered glass sheet was obtained. After that, a Na ion concentration distribution on a cut surface thereof was measured through EPMA line scan. The EPMA measurement was performed by using JXA-8100 manufactured by JEOL Ltd. and by setting an acceleration voltage to 15 kV, a current to 500 nA, a measurement pitch to 0.82 μm, and an electron beam diameter to 2 μm.

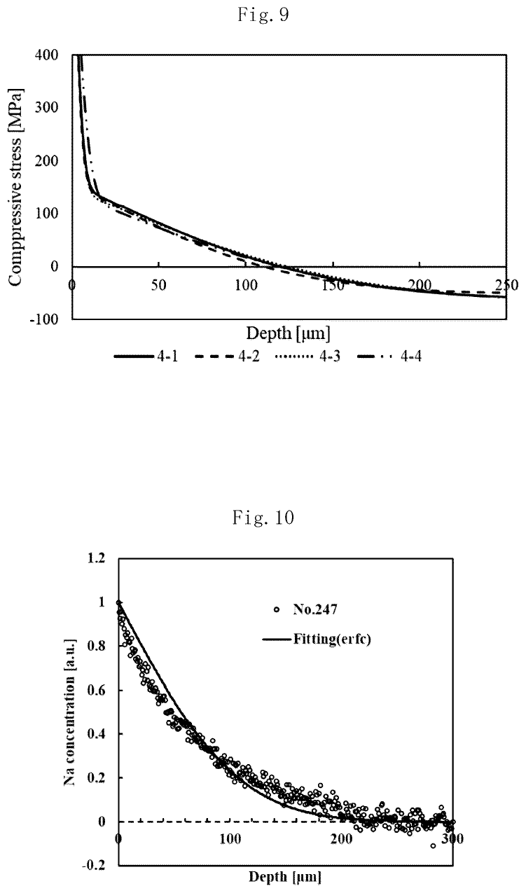

The resultant ion concentration distribution was approximated to a curve through use of an analytical solution of Fick's laws of diffusion. Specifically, the concentration distribution at a tempering time period “t” obtained with an EPMA was normalized through use of a Na ion concentration Cₘₐₓ on the outermost surface (x=0) and a Na ion concentration Cₘᵢₙ in a deep region (x=+), and the respective values were then input into the above-mentioned equation of [Math. 1] so as to achieve fitting to the complementary error function erfc(x/√4Dt), and the value of D was derived through use of a least squares method and used as a mutual diffusion coefficient D_{Na}. The Na ion concentration Cₘᵢₙ in the deep region (x=+∞) was set to an average of Na ion concentrations at depths of from 300 μm to 400 μm. Plots of the measurement values of Na ion concentrations, which had been measured with an EPMA for a tempered glass sheet obtained by subjecting Sample No. 247 to ion exchange under the conditions shown in Table 42, and the result obtained by approximating the measurement values to the complementary error function are shown in FIG. 10.

The K ion mutual diffusion coefficient D_{K} was derived by the same method as the above-mentioned calculation method for the mutual diffusion coefficient D_{Na} except that the molten salt to be used was changed to 100 KNO₃ and the target of the EPMA measurement was changed to a K ion.

TABLE 42

| | | Example number | | | | |
|---|---|---|---|---|---|---|
| | | 6-1 | 6-2 | 6-3 | 6-4 | 6-5 |
| Sample No. | | No. 055 | No. 072 | No. 116 | No. 106 | No. 247 |
| Measurement | Thickness (mm) | 0.7 | 0.7 | 0.7 | 0.7 | 0.7 |
| of Na ion | Molten salt for | 100% | 100% | 100% | 100% | 100% |
| mutual | tempering | NaNO₃ | NaNO₃ | NaNO₃ | NaNO₃ | NaNO₃ |
| diffusion | Temperature of | 380 | 380 | 380 | 380 | 380 |
| coefficient | molten salt (° C.) | | | | | |
| | Tempering time | 80 | 240 | 390 | 70 | 60 |
| | period “t” (min) | | | | | |
| | DOC (μm) | 75 | 108 | 121 | 120 | 98 |
| | C_Na, max (mol %) | 498 | 587 | 624 | 613 | 726 |
| | C_Na, min (mol %) | 129 | 172 | 234 | 378 | 423 |
| | D_{Na} (×10⁻¹³ m²/sec) | 1.52 | 1.96 | 1.79 | 8.59 | 9.83 |
| Measurement | Thickness (mm) | 0.7 | 0.7 | 0.7 | 0.7 | 0.7 |
| of K ion | Molten salt for | 100% | 100% | 100% | 100% | 100% |
| mutual | tempering | KNO₃ | KNO₃ | KNO₃ | KNO₃ | KNO₃ |
| diffusion | Temperature of | 380 | 380 | 380 | 380 | 380 |
| coefficient | molten salt (° C.) | | | | | |
| | Tempering time | 390 | 180 | 120 | 57 | 57 |
| | period (min) | | | | | |
| | DOL (μm) | 4.8 | 5.2 | 4.5 | 6.7 | 6.6 |
| | C_K, max (mol %) | 1,763 | 1,276 | 1,558 | 1,594 | 1,859 |
| | C_K, min (mol %) | 15 | 16 | 16 | 73 | 179 |
| | D_{K} (×10⁻¹⁶ m²/sec) | 1.19 | 3.02 | 2.95 | 15.1 | 14.9 |

| | | | | | |
|---|---|---|---|---|---|
| Mutual diffusion coefficient | 0.0008 | 0.0015 | 0.0017 | 0.0018 | 0.0015 |
| ratio D_{K}/D_{Na} | | | | | |

Further, an untempered glass sheet (glass sheet to be tempered) having the same composition as that of each of Samples No. 055, No. 072, No. 106, No. 116, and No. 247 of Example 1 and having a thickness of 0.7 mm was subjected to first ion exchange under the conditions shown in Table 43, and was then subjected to second ion exchange under the conditions shown in the same table. Thus, a tempered glass sheet was obtained.

TABLE 43

| | | Example number | | | | |
|---|---|---|---|---|---|---|
| | | 6-1 | 6-2 | 6-3 | 6-4 | 6-5 |
| Sample No. | | No. 055 | No. 072 | No. 116 | No. 106 | No. 247 |
| Thickness (mm) | | 0.7 | 0.7 | 0.7 | 0.7 | 0.7 |
| First ion | Molten salt for | 0/100 | 0/100 | 0/100 | 0/100 | 0/100 |
| exchange | tempering (KNO₃/NaNO₃) | | | | | |
| | Temperature of | 380 | 380 | 380 | 380 | 380 |
| | molten salt (° C.) | | | | | |
| | Tempering time | 300 | 300 | 240 | 120 | 105 |
| | period (min) | | | | | |
| | CS (MPa) | 350 | 334 | 402 | 306 | 349 |
| | CS30₁ₛₜ (MPa) | 231 | 224 | 267 | 196 | 225 |
| | DOC (μm) | 110 | 119 | 106 | 115 | 112 |
| Second ion | Molten salt for | 100/0 | 97.5/2.5 | 100/0 | 92.5/7.5 | 92.5/7.5 |
| exchange | tempering (KNO₃/NaNO₃) | | | | | |
| | Temperature of | 430 | 380 | 380 | 410 | 410 |
| | molten salt (° C.) | | | | | |
| | Tempering time | 75 | 180 | 120 | 24 | 25 |
| | period (min) | | | | | |
| | CS (MPa) | 1,031 | 725 | 950 | 892 | 908 |
| | De (μm) | 5.0 | 5.0 | 5.0 | 5.5 | 5.8 |
| | DOC (μm) | 142 | 136 | 127 | 127 | 120 |
| | CT(MPa) | 90.0 | 88 | 84.0 | 95.0 | 88.0 |
| | CS30_{2nd} (MPa) | 125 | 143 | 164 | 146 | 164 |

| | | | | | |
|---|---|---|---|---|---|
| CS30_{Droprate} | 0.46 | 0.36 | 0.39 | 0.26 | 0.27 |
| SPP-4PB (MPa) | 176 | 189 | 204 | 206 | 199 |

Each of the resultant samples (Examples 6-1 to 6-5) was measured for the compressive stress values and the value of the depth of compression, and was then measured for the abraded four-point bending strength by the same methods as in Examples 2 to 5.

As apparent from Table 42 and Table 43, each of the tempered glass sheets of Examples 6-1 to 6-5 had a mutual diffusion coefficient ratio D_{K}/D_{Na} of 0.0008 or more and a compressive stress drop rate (CS30_{Droprate}) of 0.46 or less, and after the two-step ion exchange, had a compressive stress value (CS) of the compressive stress layer on the outermost surface and a compressive stress value (CS30) thereof at a depth of 30 μm from the outermost surface as high as 725 MPa or more and 125 MPa or more, respectively. In addition, the abraded four-point bending strength is as high as 176 MPa or more, and hence it is conceived that each of the tempered glass sheets is less liable to be broken at the time of dropping.

### INDUSTRIAL APPLICABILITY

The tempered glass sheet of the present invention is suitable as a cover glass for a touch panel display of a cellular phone, a digital camera, a personal digital assistant (PDA), or the like. In addition, the tempered glass sheet of the present invention is expected to find applications for which high mechanical strength is required, for example, a window glass, a substrate for a magnetic disk, a substrate for a flat panel display, a substrate for a flexible display, a cover glass for a solar cell, a cover glass for a solid state image sensor, and a cover glass for an automobile, in addition to the above-mentioned applications.

### REFERENCE SIGNS LIST

a first peak
b first bottom
c second peak
d second bottom
e inflection point

1. A tempered glass sheet having a compressive stress layer in a surface thereof,
the tempered glass sheet comprising as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of SrO, 0% to 10% of BaO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

2. The tempered glass sheet according to claim 1, wherein the tempered glass sheet has a Z value calculated by the following equation of 18.0 or more.
$$Z = 0.13 \times [ S i {O}_{2} ] + 2.36 \times [ A {l}_{2} {O}_{3} ] - 0.14 \times [ {B}_{2} {O}_{3} ] + 4.9 \times [ L {i}_{2} O ] - 5.53 \times [ N {a}_{2} O ] - 2.14 \times [ M g O ] - 2.34 \times [ C a O ]$$

3. The tempered glass sheet according to claim 2, wherein the tempered glass sheet has a Z value calculated by the following equation of 20.0 or more.
$$Z = 0.13 \times [ S i {O}_{2} ] + 2.36 \times [ A {l}_{2} {O}_{3} ] - 0.14 \times [ {B}_{2} {O}_{3} ] + 4.9 \times [ L {i}_{2} O ] - 5.53 \times [ N {a}_{2} O ] - 2.14 \times [ M g O ] - 2.34 \times [ C a O ]$$

4. The tempered glass sheet according to claim 1, wherein the tempered glass sheet has a molar ratio [Na₂O]/[Li₂O] of 1.0 or less.

5. The tempered glass sheet according to claim 1, wherein the tempered glass sheet has a Y value calculated by the following equation of 5.0 or more.
$$Y = 3 + 0.21 \times [ S i {O}_{2} ] + 0.25 \times [ A {l}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ M g O ] - 1.46 \times [ C a O ]$$

6. The tempered glass sheet according to claim 5, wherein the tempered glass sheet has a Y value calculated by the following equation of from 6.0 to 30.
$$Y = 3 + 0.21 \times [ S i {O}_{2} ] + 0.25 \times [ A {l}_{2} {O}_{3} ] - 0.33 \times [ {B}_{2} {O}_{3} ] - 0.55 \times [ L {i}_{2} O ] + 0.45 \times [ N {a}_{2} O ] - 0.97 \times [ M g O ] - 1.46 \times [ C a O ]$$

7. The tempered glass sheet according to claim 1, wherein the tempered glass sheet has an X value calculated by the following equation of 300 or more.
$$X = - 1.49 \times [ S i {O}_{2} ] + 26.98 \times [ A {l}_{2} {O}_{3} ] - 3.23 \times [ {B}_{2} {O}_{3} ] + 48.56 \times [ L {i}_{2} O ] - 24.31 \times [ N {a}_{2} O ] - 0.28 \times [ M g O ] + 2.74 \times [ C a O ]$$

8. The tempered glass sheet according to claim 1, wherein the tempered glass sheet has a W value calculated by the following equation of 340 or more.
$$W = 0.07 \times [ S i {O}_{2} ] + 18.17 \times [ A {l}_{2} {O}_{3} ] - 4.42 \times [ {B}_{2} {O}_{3} ] + 41.43 \times [ L {i}_{2} O ] - 29.3 \times [ N {a}_{2} O ] + 1.43 \times [ M g O ] - 10.43 \times [ C a O ]$$

9. The tempered glass sheet according to claim 1, wherein the tempered glass sheet has a value of [Al₂O₃]+[Li₂O]+[Na₂O]+[K₂O] of 10.5% or more.

10. The tempered glass sheet according to claim 1, wherein the tempered glass sheet has a molar ratio [Li₂O]/[Al₂O₃] of 0.1 or more.

11. The tempered glass sheet according to claim 1, wherein the tempered glass sheet has a U value calculated by the following equation of 7,000 or more.
$$U = 87.39 \times [ S i {O}_{2} ] + 180.12 \times [ A {l}_{2} {O}_{3} ] + 93.63 \times [ {B}_{2} {O}_{3} ] + 113.78 \times ( [ M g O ] + [ C a O ] + [ B a O ] + [ S r O ] ) - 46.2 \times [ L {i}_{2} O ] - 71 \text{.1} \times [ N {a}_{2} O ] - 58.6 \times [ {K}_{2} O ] - 40.0 \times [ {P}_{2} {O}_{5} ]$$

12. The tempered glass sheet according to claim 1, wherein the tempered glass sheet has a Q value calculated by the following equation of −30 or more.
$$Q = [ S i {O}_{2} ] + 1.2 \times [ {P}_{2} {O}_{5} ] - 3 \times [ A {l}_{2} {O}_{3} ] - [ {B}_{2} {O}_{3} ] - 2 \times [ L {i}_{2} O ] - 1.5 \times [ N {a}_{2} O ] - [ {K}_{2} O ]$$

13. The tempered glass sheet according to claim 1, wherein the tempered glass sheet comprises Cl as the glass composition and has a content of Cl of 0.02 mol % or more.

14. The tempered glass sheet according to claim 1, wherein the tempered glass sheet comprises MoO₃ as the glass composition and has a content of MoO₃ of 0.0001 mol % or more.

15. The tempered glass sheet according to claim 1, wherein the tempered glass sheet has a softening point (Ts) of 920° C. or less.

16. The tempered glass sheet according to claim 1,
wherein a compressive stress value CS of the compressive stress layer on an outermost surface is from 200 MPa to 1,400 MPa, and
wherein a depth of compression DOC of the compressive stress layer is from 3 μm to 200 μm.

17. The tempered glass sheet according to claim 1,
wherein a depth of compression DOC of the compressive stress layer is from 50 μm to 200 μm, and
wherein a compressive stress value CS30 of the compressive stress layer at a depth of 30 μm from an outermost surface is from 35 MPa to 400 MPa.

18. The tempered glass sheet according to claim 1, wherein the tempered glass sheet has a temperature at a viscosity at high temperature of 10^{2.5} dPa·s of 1,680° C. or less.

19. The tempered glass sheet according to claim 1, wherein the tempered glass sheet has an overflow-merged surface in an inside thereof.

20. The tempered glass sheet according to claim 1, wherein a stress profile of the tempered glass sheet in a thickness direction has an inflection point.

21. A tempered glass sheet, comprising as a glass composition, in terms of mol %, 50% to 80% of SiO₂, 7% to 25% of Al₂O₃, 1% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 4% of P₂O₅, 0.001% to 0.1% of TiO₂, 0% to 10% of ZrO₂, 0.001% to 0.1% of Fe₂O₃, and 0.001% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

22. A method of manufacturing a tempered glass sheet, comprising:
a preparation step of preparing a glass sheet to be tempered including as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0; and
an ion exchange step of subjecting the glass sheet to be tempered to ion exchange treatment a plurality of times to provide a tempered glass sheet having a compressive stress layer in a surface thereof.

23. A glass sheet to be tempered, comprising as a glass composition, in terms of mol %, 50% to 80% of SiO₂, 7% to 25% of Al₂O₃, 0% to 15% of B₂O₃, 0% to 15% of Li₂O, 0% to 25% of Na₂O, 0% to 10% of K₂O, 0% to 15% of MgO, 0% to 10% of CaO, 0% to 10% of BaO, 0% to 10% of SrO, 0% to 10% of ZnO, 0% to 15% of P₂O₅, 0% to 10% of TiO₂, 0% to 10% of ZrO₂, and 0% to 0.30% of SnO₂, having a value of [B₂O₃]+[MgO]+[CaO] of from 0.1% to 30%, and having a value of ([Li₂O]+[Na₂O]+[K₂O])/[Al₂O₃] of from 0.5 to 2.0.

24. The glass sheet to be tempered according to claim 23,
wherein the glass sheet to be tempered has a Na ion mutual diffusion coefficient D_{Na} at 380° C. of from 1×10⁻¹⁴ m² sec⁻¹ to 1×10⁻¹¹ m² sec⁻¹,
wherein the glass sheet to be tempered has a K ion mutual diffusion coefficient D_{K} at 380° C. of from 1×10⁻¹⁷ m² sec⁻¹ to 1×10⁻¹⁴ m² sec⁻¹, and
wherein the glass sheet to be tempered has a ratio D_{K}/D_{Na} of 0.0001 or more.
